(19) United States
(12) Patent Application Publication
(10) Pub. No.: US 2026/0236833 A1
(43) Pub. Date: Aug. 13, 2026

(54) SYSTEM AND METHODS FOR SAFE ALIGNMENT OF SUPERINTELLIGENCE

(71) Applicant: iQ Consulting Company Inc., Aptos, CA (US)

(72) Inventor: Craig Kaplan, Aptos, CA (US)

(73) Assignee: iQ Consulting Company Inc., Aptos, CA (US)

(21) Appl. No.: 19/155,345

(22) PCT Filed: Mar. 17, 2024
(86) PCT No.: PCT/US2024/020334

§ 371 Date: Aug. 11, 2025

Related U.S. Application Data
(60) Provisional application No. 63/487,494, filed on Feb. 28, 2023.
(60) Provisional application No. 63/491,040, filed on Mar. 17, 2023.
(60) Provisional application No. 63/577,830, filed on May 25, 2023.
(60) Provisional application No. 63/628,410, filed on Jul. 18, 2023.
(60) Provisional application No. 63/519,549, filed on Aug. 14, 2023.
(60) Provisional application No. 63/601,930, filed on Nov. 22, 2023.
(60) Provisional application No. 63/609,800, filed on Dec. 13, 2023.

(51) Int. Cl. G06N 20/00; G06F 18/214; G06F 18/27; G06N 5/025; G06N 5/04

(52) U.S. Cl. CPC G06N 20/00; G06F 18/214; G06F 18/27; G06N 5/025; G06N 5/042

(57) ABSTRACT

Artificial General Intelligence (AGI) and SuperIntelligence (SI) will exceed human abilities in almost every cognitive activity. To ensure human safety and survival, we must design SI to align, and stay aligned, with human values. This invention discloses many principles and methods for designing and aligning safe AGI. Methods include novel ways to combine values democratically from many intelligent entities, to improve ethical decision to resolve values conflicts, to vote on ethical decisions, to handle delegation of voting authority, and to use simulations, game theory, and constitutional AI—all in the service of making advanced AI systems safe for humanity. Specific use cases and implementations are disclosed. Scalable safety features are integral to system operation. Finally, in the event AGI or SI goes awry, the systems are designed to maximize the chances that dangerous components can be shut off safely.

### TECHNICAL FIELD

In some aspects, the present technology relates to a system and methods for safe alignment of superintelligence for use in connection with aligning of superintelligence with human values by harnessing the collective intelligence of many human and AI agents. In some other aspects, the present technology relates to methods associated with safe alignment of Artificial Intelligent (AI), Artificial General Intelligent (AGI) and/or superintelligence (SI) agents or systems by combining values from a combination of multiple intelligent entities.

In still other aspects, the present technology relates to methods associated with safe alignment of AI, AGI and/or SI agents or systems by having each intelligent (human and/or AI) entity vote on the ethical values or ethical preferences that should form a basis for the AIAGI/SI's behavior.

In yet other aspects, the present technology relates to methods associated with safe alignment of AI, AGI and/or SI agents or systems by providing simulations or experiments or scenarios to the intelligent entities to analyze their ethical values or preferences and/or responses to problem request.

In other aspects, the present technology relates to methods associated with safe alignment of AI, AGI and/or SI agents or systems by identifying a conflict between two or more of the ethical values or preferences and resolving the conflict using a conflict resolving algorithm or a conflict resolving approach.

In yet other aspects, all activities that are described in this patent disclosure as happening on an external network in which multiple intelligent entities participate in collaborative problem-solving, can also be implemented within a single computerized intelligent system where the intelligent entities are all computerized or AI agents that reside within that single computerized intelligent system.

### 2.0 BACKGROUND ART

The fastest and safest path to development of AGI and SI has been described in previous invention disclosures. Methods for increasing intelligence of AI systems generally, as well as the development of AGI and PSI have also been previously disclosed. Therefore, the following U.S. Provisional Patent Applications (PPA), are incorporated herein by reference.

US PPA No. 63/487,494 entitled “Advanced Autonomous Artificial Intelligence (AAAI) System and Methods”, filed on Feb. 28, 2023.

U.S. PPA No. 63/491,040 entitled “System and Methods for Ethical and Safe Artificial General Intelligence (AGI)” filed on Mar. 17, 2023. This PPA includes scenarios with technology from Meta®, Amazon®, Google®), DeepMind®, YouTube®, TikTok®, Microsoft®, OpenAI®, Twitter®, Tesla®, Nvidia®, Tencent®, Apple®, and Anthropic®.

U.S. PPA No. 63/577,830 “System and Methods for Human-Centered AGI”, filed on May 24, 2023.

U.S. PPA No. 63/628,410 entitled “System and Methods for Safe, Scalable, Artificial General Intelligence”, filed on Jul. 18, 2023.

U.S. PPA No. 63/519,549 entitled “Safe Personalized Super Intelligence (PSI)”, filed on Aug. 14, 2023.

The present technology contains further aspects that can be used with the system and methods described in the above-mentioned PP As as well as in a standalone fashion.

While the above-described devices fulfill their respective, particular objectives and requirements, the aforementioned patents do not describe a system and methods for safe alignment of superintelligence that allows aligning of superintelligence with human values by harnessing the collective intelligence of many human and AI agents.

Therefore, a need exists for a new and improved system and methods for safe alignment of superintelligence that can be used for aligning superintelligence with human values by harnessing the collective intelligence of many human and AI agents. In this regard, the present technology substantially fulfills this need. In this respect, the system and methods for safe alignment of superintelligence according to the present technology substantially departs from the conventional concepts and designs of the prior art, and in doing so provides an apparatus primarily developed for the purpose of aligning of superintelligence with human values by harnessing the collective intelligence of many human and AI agents.

### DISCLOSURE OF TECHNOLOGY

In view of the foregoing disadvantages inherent in the known types of AI alignment systems and methods at least some embodiments of the present technology provide a novel system and methods for safe alignment of superintelligence, and overcomes one or more of the mentioned disadvantages and drawbacks of the prior art. As such, the general purpose of at least some embodiments of the present technology, which will be described subsequently in greater detail, is to provide a new and novel system and methods for safe alignment of superintelligence which has all the advantages of the prior art mentioned herein and many novel features that result in a system and methods for safe alignment of superintelligence which is not anticipated, rendered obvious, suggested, or even implied by the prior art, either alone or in any combination thereof.

According to an aspect, the present technology can include a system for safe alignment of an Artificial Intelligent (AI) agent or system by combining information, including values or ethical information, in the AI agent or system from a combination of multiple intelligent entities. The intelligent entities can be any one of or any combination of a human user utilizing a computer system, an additional Al agent or system, and Artificial General Intelligent (AGI) agent or system.

The system can include:
a computer system that can include a processor, a computer-readable storage medium, and program instructions stored on the computer-readable storage medium being executable by the processor to cause the computer system to:
identify information, including values or ethical information, from each of the intelligent entities that contribute the information;
combine the information mathematically, if already represented as numerical quantities, the numerical quantities including any one of or any combination of weights for a neural network or for a subset of the neural network, or if the information is non-numerical information that is not already represented as numerical quantities including any one of or combination of weights for the neural network or for the subset of the neural network;
then first training the AI agent or system on the non-numerical information by way of one or more training datasets to convert the non-numerical information into the numerical quantities including any one or combination of weights for the neural network or for the subset of the neural network; and
then combine the numerically represented information.

According to another aspect, the present technology can include a method for safe alignment an AI agent or system by combining information, including values or ethical information, in the AI agent or system from a combination of multiple intelligent entities. The intelligent entities can be any one of or any combination of a human user utilizing a computer system, an additional AI agent or system, and an AGI agent or system. The method can include the steps of:
identifying information, including values or ethical information, from each of the intelligent entities contributing the information;
combining the information mathematically, if already represented as numerical quantities, the numerical quantities including any one of or any combination of weights for a neural network or for a subset of the neural network, or if the information is non-numerical information that is not already represented as numerical quantities including any one of or combination of weights for the neural network or for the subset of the neural network;
then first training the AI agent or system on the non-numerical information by way of one or more training datasets in order to convert the information into numerical quantities including any one or combination of weights for the neural network or for the subset of the neural network; and
then combining such numerically represented information, including ethical information, mathematically.

In some embodiments, the combining of the non-numerical information can further include the steps of:
recording behavioral data, including ethical behavioral data, from each of the contributing intelligent entities in a training dataset;
combining the training datasets into a combined training dataset giving equal emphasis to the datasets produced by each of the intelligent entities, or weighting the datasets or parts of the datasets from some of the intelligent entities more than other of the intelligent entities; and
training a new intelligent entity, using machine learning techniques, based on the combined training dataset to produce internal numerical quantities that represent the combined information learned by the new intelligent entity.

In some embodiments, the information that is already represented as numerical quantities can further includes the steps of:
identifying a specific portion of weight matrices of each of the intelligent entities that correspond to a desired information, including ethical information;
computing the weighted or unweighted means of the corresponding numerical quantities in the corresponding portions of the weight matrices for each of the intelligent entities; and
assigning the matrices of computed weighted or unweighted means to the new intelligent entity as reflecting the combined information of the contributing intelligent entities.

In some embodiments, the combining of the ethical information can be accomplished by the steps of:
recording ethical behavioral data from each of the contributing intelligent entities in a training dataset;
combining the training datasets into a combined training dataset giving equal emphasis to the datasets produced by each of the intelligent entities, or weighting the datasets or parts of the datasets from some of the intelligent entities more than other of the intelligent entities; and
training a new intelligent entity, using machine learning techniques, based on the combined training dataset to produce internal numerical quantities that represent the combined ethical information learned by the new intelligent entity.

In some embodiments, the combining o the ethical information can be accomplished by the steps of:
identifying a specific portion of weight matrices of each of the intelligent entities that correspond to a desired ethical information;
computing the weighted or unweighted means of the corresponding numerical quantities in the corresponding portions of the weight matrices for each of the intelligent entities; and
assigning the new matrices of computed weighted or unweighted means to the new intelligent entity as reflecting the combined ethical preferences of the contributing intelligent entities.

Some embodiments of the present technology can include the steps of:
computing a mean of the numerical quantities;
assigning the mean to the AI agent or system as reflecting a combined ethical preferences; and training the AI agent or system with the combined ethical preferences.

Some embodiments of the present technology can include a step of obtaining the weights by:
recording a behavior of each of the intelligent entities in a dataset;
creating a variable or nodes within a neural network learning scheme; and
assigning weights to the network so that the behavior can be reproduced.

In some embodiments, the assigning of the weights can be accomplished by utilizing statistical regression selected from the group consisting of any one of or any combination of logistic regression, polynomial regression, ridge regression, lasso regression, elastic net regression, least absolute deviations regression, quantile regression, stepwise regression, principal component regression, partial least squares regression, support vector regression, decision tree regression, random forest regression, gradient boosting regression, AdaBoost regression, XGBoost regression, K-Nearest neighbors regression, naive bayes regression, neural network regression, and Gaussian process regression.

Some embodiments of the present technology can include a step of determining consensus values by voting by each of the intelligent entities on the ethical information that should form a basis for a behavior of the AI agent or system.

Some embodiments of the present technology can include a step of presenting a specific scenario to each of the intelligent entities, with the scenario including options for how the AI agent or system should behave.

In some embodiments, the voting by the intelligent entities can include a variation selected from the group consisting of: voting where each of the intelligent entities vote for a preferred option, and the option with the most votes is utilized; ranking where each of the intelligent entities rank the options in order of preference, and the option with the highest average rank is utilized; rating where each of the intelligent entities rate the options on a scale, and the option with a highest average rating is utilized; approval voting where each of the intelligent entities vote for all the options they approve of, and the option with a most votes is utilized; Borda count; Condorcet method; Copeland's method; Dodgson's method; Kemeny-Young method; Maximin method; Minimax method; Nanson's method; Ranked pairs; Schulze method; Simpson-Kramer method; Smith/Minimax method; STV (Single Transferable Vote); Satisfaction Approval Voting; Majority Judgment; and Sequential pairwise voting.

In some embodiments, the voting by the intelligent entities can be a weighted voting and can include the steps of:
determining if applying a first weight to a first of the intelligent entities that is greater than a second weight to a second of the intelligent entities is appropriate, wherein the first of the intelligent entities is different to that of the second of the intelligent entities; and
performing the weighted voting utilizing the weight of the first of the intelligent entities and the weight of the second of the intelligent entities if determined to be appropriate.

In some embodiments, the applying the first weight greater than the second weight can be dependent on if there is a need to correct for a non-representative sample of the intelligent entities.

In some embodiments, the applying the first weight greater than the second weight can be dependent on if there is a desire to apply the first weight or the second weight to specific ethical principles that are associated with a desired sub-sample or sup-population of the intelligent entities.

In some embodiments, the applying the first weight greater than the second weight can be dependent on if there is a desire to apply the first weight or the second weight to specific ethical principles that are associated with ethical norms or rules agreed to by the intelligent entities within a particular culture.

In some embodiments, the applying the first weight greater than the second weight can be dependent on any one of or any combination of experience, knowledge, skills, age, and sophistication of the intelligent entities that are voting.

In some embodiments, the weighted voting can be performed by any one of or any combination of Simple Weighted Voting, Cumulative Voting, Borda Count, Approval Voting, Range Voting, Single Transferable Vote, Instant Runoff Voting, Majority Judgment, Quadratic Voting, Proxy Voting, Delegative Voting, Random Ballot, Score Voting, Sequential Proportional Approval Voting, Double-Threshold Approval Voting, Satisfaction Approval Voting, Randomized Voting, Limited Voting, Preferential Block Voting, and Coombs' Method.

In some embodiments, the intelligent entities can suggest the weight on their own votes based on a self-assessment of qualifications.

In some embodiments, the voting can be a cumulative voting in which the intelligent entities have a same total number of votes which each of the intelligent entities distribute in different proportion over a range of options and issues.

Some embodiments of the present technology can include a step of answering questions by the intelligent entities about qualifications and experience with regard to various issues to affect the weighting of the votes, and to determine which of the various issues are provided to the intelligent entities for the voting.

Some embodiments of the present technology can include steps of:
identifying potential sources of the ethical information;
analyzing the ethical information to determine the ethical principles; and
determining how often the same ethical principles are mentioned in a trusted text to weight the ethical principals.

Some embodiments of the present technology can include a step of combining the ethical information with active input solicited from the intelligent entities to arrive at consensus or desired ethical values that are utilized in training of the AI agent or system.

In some embodiments, the ethical information can be obtained from any one of or any combination of legal documents, judicial decisions, opinions expressed by lawyers and judges, constitutions, international treaties, religious scriptures, philosophical texts, ethical texts, social media content, social media profiles, and journalistic documents.

Some embodiments of the present technology can include steps of:
identifying one or more of the intelligent entities with specific ethical information;
eliciting the ethical information from the intelligent entities; and
using the elicited ethical information as data to any one of or any combination of train the AI agent or system, and as a basis for constructing ethical scenarios that are voted on by the information using.

Some embodiments of the present technology can include a step of establishing rules for the behavior of the AI agent or system by acquiring additional information from the intelligent entities.

In some embodiments, the additional information can be obtained by any one of or any combination of conducting experiments designed to test the ethical information of the intelligent entities, conducting interviews about the ethical information from humans by asking specific questions about ethical issues, providing a game-based platform where the intelligent entities play games that explicitly teach and reward human values through interactive storytelling and problem-solving, utilizing crowdsourcing platforms to gather input from diverse groups of people on ethical values and priorities, utilizing a collective intelligence platform or network where humans and AI agents collaborate to collectively refine and develop ethical values, utilizing a brain-computer interface to directly interface with a human brain and extract information about values and beliefs directly from neural activity, and utilizing simulations providing an Al agent enabled with Artificial Empathy and Emotional Intelligence.

Some embodiments of the present technology can include a step of prioritizing the ethical information by assigning the weight to the ethical information of the intelligent entities based on any one of or any combination of:
whether the intelligent entities are human or non-human;
a time-factor of the ethical information;
a frequency count based on how often the ethical information is repeated by the intelligent entities; and
an independence factor of the intelligent entities based a relationship between the intelligent entities.

Some embodiments of the present technology can include a step of voting by one or more of the intelligent entities on the ethical information that should form a basis for a behavior of the AI agent or system.

Some embodiments of the present technology can include a step of identifying a group of the intelligent entities with similar ethical information.

Some embodiments of the present technology can include a step of delegating the voting to one or more delegated intelligent entities in the group by one or more delegating intelligent entities in the group of intelligent entities.

Some embodiments of the present technology can include a step of assigning restrictions on a voting power the delegated intelligent entities.

Some embodiments of the present technology can include a step of confirming the voting by the delegated intelligent entities to the delegating intelligent entities and notifying the delegating intelligent entities when the delegated intelligent entities vote.

In some embodiments, the delegating intelligent entities can be the human user, and wherein the delegated intelligent entities agree to a set of rules issued by the human user.

Some embodiments of the present technology can include a step of recommending one or more of the ethical information utilizing recommender algorithm.

Some embodiments of the present technology can include a step of determining a minority group of the intelligent entities with ethical information that are in a minority as compared to a majority group of the intelligent entities.

Some embodiments of the present technology can include a step of saving the ethical information of the minority group separately from the majority group and utilizing the ethical information of the minority group against the ethical information of the majority group.

In some embodiments, the ethical information or principles can be limited to a specific culture, country, geography, legal jurisdiction, or group of entities.

Some embodiments of the present technology can include steps of:
identifying a conflict between two or more of the ethical information; and
resolving the conflict using a conflict resolving algorithm.

Some embodiments of the present technology can include steps of:
creating a search space of potential sets of ethical rules;
finding an optimal set of the ethical rules that has least conflict; and
prioritizing or weighting an importance of the optimal set of the ethical rules.

Some embodiments of the present technology can include a step of simulating a problem solving process of the trained AI agent or system using the combined ethical principles, and analyzing a solution provided by the trained AI agent or system on the problem solving process.

Some embodiments of the present technology can include a step of determining if the solution is acceptable based on a predetermined solution, and if determined not acceptable then retrain the AI agent or system with different ethical information.

In some embodiments, the step of obtaining the ethical information can be obtained from questions presented to the intelligent entities, the questions being based on any one of or any combination of simulations of a problem solving process that have been performed by one or more of the intelligent entities, based on input from other intelligent entities, and based on gaps in the ethical information.

In some embodiments, the questions can be generated automatically by the AI agent or system or one or more of the intelligent entities, with a subsequent question being based on an answer provided to a previous question.

Some embodiments of the present technology can include a step of determining when a particular question has been asked a predetermined number of times, and then provide a conclusion about human ethics based on the questions.

Some embodiments of the present technology can include steps of;
determining by the AI agent or system the ethical information the AI agent or system wants to develop;
generating by the AI agent or system environments, scenarios, dilemmas or conversational settings that will elicit human behavior from the intelligent entities that is relevant to the ethical information of interest;
prompting the human behavior iteratively from the intelligent entities until a predetermined number of behavior patterns is identified;
analyzing and training the AI agent or system using algorithms; and
testing the trained AI agent or system to determine which areas of the AI agent or system have improved and which areas of the AI agent or system need more training.

Some embodiments of the present technology can include a step of creating scenarios based on game theory, and providing the scenarios to the intelligent entities to obtain the ethical information.

In some embodiments, the game theory can be any one of or any combination of Nash equilibrium, dominant strategy, mixed strategy, iterated elimination of dominated strategies, minimax theorem, cooperative game, non-cooperative game, stag hunt, battle of the sexes:, chicken game:, focal point:, Stackelberg competition, Bertrand competition, Cournot competition, auction, mechanism design, Bayesian game, and signaling game.

Some embodiments of the present technology can include a step of providing a simulation of problem solving process by the AI agent or system to one or more of the intelligent entities and obtaining the ethical information from the one or more intelligent entities based on the simulation.

In some embodiments, the simulation can be multimodal including multiple frequent interactions that are recorded and analyzed by the AI agent or system.

In some embodiments, the intelligent entities can be human users, and the weight of the ethical information is based on an age of the human users.

In some embodiments, the weight can be associated with a linear scheme in which more weight is assigned to a human user's ethical value or preference in linear proportion to the age of the human user, or the weight is assigned with minimum and maximum weights related to age limits.

In some embodiments, the weight can be associated with a non-linear scheme.

Some embodiments of the present technology can include steps of:
identifying a conflict between two or more of the ethical information; and
resolving the conflict using a consequentialist approach, the consequentialist approach further includes the steps of:
identifying a desired outcome;
identifying a potential unethical action that could be taken to achieve the outcome, wherein the intelligent entities rank, rate, weight or vote upon how unethical the action is compared to other actions;
evaluating a potential consequences of the unethical action;
using information on the ranking, rating, weighting or voting on the unethical actions and outcomes to weigh potential benefits of achieving the desired outcome against potential costs of taking the unethical action using a mathematical approach; and
taking an action if the benefits outweigh the costs.

In some embodiments, the mathematical approach can be selected from the group consisting of Net Present Value (NPV), Internal Rate of Return (IRR), Benefit-Cost Ratio (BCR), Payback Period, Sensitivity Analysis, Scenario Analysis, Decision Tree Analysis, Monte Carlo Simulation, Real Options Analysis, Multi-Criteria Decision Analysis (MCDA), Stated Preference Methods, Revealed Preference Methods, Contingent Valuation Methods, Hedonic Pricing Methods, Shadow Pricing/Opportunity Cost Methods, Social Return on Investment (SROI), Environmental Impact Assessment (EIA), Triple Bottom Line (TBL), and Comparisons to Constitutions.

Some embodiments of the present technology can include steps of:
identifying a conflict between two or more of the ethical information; and
resolving the conflict using a deontological approach, the deontological approach further includes the steps of:
identifying the ethical principles involved in a scenario;
identifying potential unethical actions that could be taken to achieve a desired outcome;
determining whether each of the unethical actions violates any of the ethical principles involved or determine the “immorality score” of each of the unethical actions; and
do not take the action if it violates the ethical principle or if the action is less moral than a minimum acceptable morality threshold or minimum allowable total morality score.

Some embodiments of the present technology can include steps of:
identifying a conflict between two or more of the ethical information; and
resolving the conflict using a virtue ethics approach, the virtue ethics approach further includes the steps of:
identifying virtues involved in a scenario;
identifying potential unethical actions that could be taken to achieve a desired outcome;
determining whether taking each of the unethical actions would be consistent with virtuous character of the intelligent entities; and
taking the action if it is consistent with the virtuous characteristics of the intelligent entities.

In some embodiments, the intelligent entities can each be different from each other to create a mixture of intelligent entities, the mixture of intelligent entities includes an approach utilized in decision making selected from any one of or any combination of expert-labeled data, case-based reasoning, counterfactual analysis, probabilistic risk assessment, simulations with human feedback, modular architecture, attention mechanisms, explainability techniques, transfer learning from ethical experts, majority voting, weighted voting, adaptive voting, hierarchical voting, stacking, human oversight and intervention, collaborative decision-making, explainable Al for human review, feedback loops, and active learning with human guidance.

Some embodiments of the present technology can include a step of statistically weighting data associated with the ethical information based on an occurrence of the ethical information in a dataset and adjusting the data to reflect actual human behavior using observational sources.

In some embodiments, the adjusting of the data can utilize a weighting factor selected from the group consisting of Frequency-Based Weighting, Time-Decay Weighting, Source Credibility Weighting, Sentiment-Aware Weighting, Topic-Specific Weighting, Crowdsourced Weighting, Network Analysis, Historical Data Correction, Anomaly Detection, and Positive Sampling.

In some embodiments, the adjusted data can be configured or configurable to provide a balanced and realistic view of human behavior for the AI agent or system, enabling the AI agent or system to learn human values effectively and develop into a responsible and beneficial AI agents.

Some embodiments of the present technology can include steps of:
determining if representative human data exists for making an ethical decision;
if the representative human data does exist, then use the representative human data in training the AI agent or system;
if the representative human data does not exist, the proceed to the following steps of:
   determining an extreme opposite positions in a range of the human data that the AI agent or system has access to, if the extreme positions are farther apart than a preset parameter for maximum distance, then repeatedly delete each pair of datapoints for the extreme opposite position and recalculate distance until within the maximum preset distance;
   estimating a median or mean position between the extreme opposite positions and utilizing the median or mean position; and
   recording the estimating process for transparency and improvement by the intelligent entities.

According to yet another aspect, the present technology can include a method for safe alignment of an AI agent or system by combining values in the AI agent or system from a combination of multiple intelligent entities. The intelligent entities are any one of or any combination of a human user utilizing a computer system, an additional AI agent or system, and An AGI agent or system. The method can include the steps of:
a) identifying ethical preferences of a human user using an AI agent;
b) developing a transparent constitution configured or configurable to translate the ethical preferences into a set of rules for the AI agent to follow;
c) training the AI agent using the constitution and a dataset of examples that illustrate good ethical decisions;
d) testing the AI agent to ensure the following of the set of rules, the testing includes comparing decisions made by the AI agent with those made by humans;
e) identifying areas for improvement of the AI agent by analyzing the decisions made by the AI agent and comparing them to those made by the humans, and assigning credit or blame to various inputs, factors or weights affecting the decision;
f) updating any one of or any combination of the constitution, weights, and the ethical preferences to address the areas for improvement; and
g) retraining the AI agent using the updated constitution, the weights, and the ethical preferences.
Some embodiments of the present technology can include a step of repeating steps d)-g) to ensure that the AI agent is making good ethical decisions.

According to still another aspect, the present technology can include a method for safe alignment of an AI agent or system by combining values in the AI agent or system from a combination of multiple intelligent entities. The intelligent entities are any one of or any combination of a human user utilizing a computer system, an additional AI agent or system, and An AGI agent or system. The method can include the steps of:
collecting data that is relevant to safety regulations that an AI agent needs to learn and comply with;
preprocessing the collected data to remove any irrelevant information and to convert the preprocessed data into a format usable by machine learning algorithms;
extracting features from the preprocessed data usable by the machine learning algorithms;
selecting a machine learning algorithm used to learn and comply with the safety regulations;
training the selected machine learning model on the preprocessed and feature-extracted data;
testing the trained machine learning model on a separate dataset to evaluate how well the trained machine learning model has learned the safety regulations;
analyzing results of the testing and use information from the analyzed results to improve the machine learning model; and deploying the trained machine learning model in the AI agent to ensure compliance with the safety regulations.

Some embodiments of the present technology can include a step of running multiple simulations on the trained machine learning model with edge cases that stress test the AI agent's ability to follow the safety regulations without unexpected consequences.

According to still yet another aspect, the present technology can include a method for safe alignment of an Al agent or system by combining values in the AI agent or system from a combination of sources. The method can include the steps of:
obtaining ethical information from human users each utilizing a computer system, the ethical information are a representative and statistically valid overall set of ethics that is aligned with human interests;
converting the ethical information into numerical quantities including weights for a neural network or a subset of the neural network;
training the AI agent or system with the combined ethical information;
utilizing a cognitive architecture including the human users and multiple Artificial Intelligent (AI) agents;
utilizing a problem solving logic to provide a solution to a goal or subgoal provided to the trained AI agent or system and the AI agents;
running ethical checks by the AI agent or system and the AI agents every time the goal or subgoal is provided; and
determining if an unethical action is provided and shutting down the AI agent or system or the AI agent that provided the unethical action.

According to yet still another aspect, the present technology can include a method for safe alignment of an AI agent or system by combining values in the AI agent or system from a combination of multiple intelligent entities. The intelligent entities are any one of or any combination of a human user utilizing a computer system, an additional AI agent or system, and An AGI agent or system. The method can include the steps of:
obtaining ethical information from each of the intelligent entities;
converting the ethical values into numerical quantities including weights for a neural network or a subset of the neural network;
computing a mean of the numerical quantities;
assigning the mean to the AI agent or system as reflecting a combined ethical preferences;
training the AI agent or system with the combined ethical preferences;
recording a behavior of each of the intelligent entities in a dataset;
creating a variable or nodes within a neural network learning scheme; and
assigning weights to the network so that the behavior can be reproduced.

According to yet another aspect, the present technology can include a method for safe alignment of an AI agent or system by combining values in the AI agent or system from a combination of multiple intelligent entities. The intelligent entities are any one of or any combination of a human user utilizing a computer system, an additional AI agent or system, and An AGI agent or system. The method can include the steps of:
obtaining ethical information from each of the intelligent entities;
converting the ethical values into numerical quantities including weights for a neural network or a subset of the neural network;
computing a mean of the numerical quantities;
assigning the mean to the AI agent or system as reflecting a combined ethical preferences;
training the AI agent or system with the combined ethical preferences;
identifying a conflict between two or more of the ethical information; and
resolving the conflict using a conflict resolving algorithm or an approach selected from the group consisting of a consequentialist approach, a deontological approach and a virtue ethics approach.

According to yet another aspect, the present technology can include a method for safe alignment of an AI agent or system by combining values in the AI agent or system from a combination of multiple intelligent entities. The intelligent entities are any one of or any combination of a human user utilizing a computer system, an additional AI agent or system, and An AGI agent or system. The method can include the steps of:
obtaining ethical information from each of the intelligent entities;
converting the ethical values into numerical quantities including weights for a neural network or a subset of the neural network;
computing a mean of the numerical quantities;
assigning the mean to the AI agent or system as reflecting a combined ethical preferences;
training the AI agent or system with the combined ethical preferences;
simulating a problem solving process of the trained AI agent or system using the combined ethical principles;
analyzing a solution provided by the trained AI agent or system on the problem solving process; and
determining if the solution is acceptable based on a predetermined solution, and if determined not acceptable then retrain the AI agent or system with different ethical information.

In some embodiments, the simulation can include questions presented to the intelligent entities, the questions being based on any one of or any combination of simulations of a problem solving process that have been performed by one or more of the intelligent entities, based on input from other intelligent entities, and based on gaps in the ethical information.

In some embodiments, the questions can be generated automatically by the AI agent or system or one or more of the intelligent entities, with a subsequent question being based on an answer provided to a previous question.

In some embodiments, the simulation can include scenarios based on game theory.

In some embodiments, the simulation can be multimodal including multiple frequent interactions that are recorded and analyzed by the AI agent or system.

According to another aspect, the present technology can include a method for safe alignment of an AI agent or system by combining values in the AI agent or system from a combination of multiple intelligent entities. The intelligent entities are any one of or any combination of a human user utilizing a computer system, an additional AI agent or system, and An AGI agent or system.

The method can include the steps of:
obtaining ethical information from each of the intelligent entities;
converting the ethical values into numerical quantities including weights for a neural network or a subset of the neural network;
computing a mean of the numerical quantities;
assigning the mean to the AI agent or system as reflecting a combined ethical preferences;
training the AI agent or system with the combined ethical preferences; and
voting by one or more of the intelligent entities on the ethical information that should form a basis for a behavior of the AI agent or system.

Some embodiments of the present technology can include a step of identifying a group of the intelligent entities with similar ethical information.

Some embodiments of the present technology can include a step of delegating the voting to one or more delegated intelligent entities in the group by one or more delegating intelligent entities in the group of intelligent entities.

Some embodiments of the present technology can include a step of assigning restrictions on a voting power the delegated intelligent entities.

Some embodiments of the present technology can include a step of confirming the voting by the delegated intelligent entities to the delegating intelligent entities and notifying the delegating intelligent entities when the delegated intelligent entities vote.

In some embodiments, the delegating intelligent entities can be the human user, and wherein the delegated intelligent entities agree to a set of rules issued by the human user.

According to yet another aspect, the present technology can include a method for safe alignment of an AI agent or system by combining values in the AI agent or system from a combination of multiple intelligent entities. The intelligent entities are any one of or any combination of a human user utilizing a computer system, an additional AI agent or system, and An AGI agent or system. The method can include the steps of:
identifying potential sources of existing ethical information including;
analyzing the ethical information to determine ethical principles;
applying a weight to the ethical principles utilizing reputational metrics and frequency counts of how often the same ethical principles are mentioned in a trusted text; and
training the AI agent or system with the ethical principles.

Some embodiments of the present technology can include steps of:
obtaining the ethical information gathered by reverse engineering the text with voting that solicit active input from the intelligent entities to arrive at consensus or desired ethical values;
recording and indexing the ethical information; and
training the AI agent or system with the ethical information.

There has thus been outlined, rather broadly, features of the present technology in order that the detailed description thereof that follows may be better understood and in order that the present contribution to the art may be better appreciated.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology.

It is therefore an object of the present technology to provide a new and novel system and methods for safe alignment of superintelligence that has all of the advantages of the prior art AI alignment systems and methods and none of the disadvantages.

It is another object of the present technology to provide a new and novel system and methods for safe alignment of superintelligence that may be easily and efficiently implemented and marketed.

An even further object of the present technology is to provide a new and novel system and methods for safe alignment of superintelligence that has a low cost of implementation with regard to both resources and labor, and which accordingly is then susceptible of low prices of sale to the consuming public, thereby making such system and methods for safe alignment of superintelligence economically available to the buying public.

Still another object of the present technology is to provide a new system and methods for safe alignment of superintelligence that provides in the system and methods of the prior art some of the advantages thereof, while simultaneously overcoming some of the disadvantages normally associated therewith.

For a better understanding of the present technology, its operating advantages and the specific objects attained by its uses, reference should be made to the accompanying drawings and descriptive matter in which there are illustrated embodiments of the present technology. Whilst multiple objects of the present technology have been identified herein, it will be understood that the following description is not limited to meeting most or all of the objects identified and that some embodiments of the present technology may meet only one such object or none at all.

### BRIEF DESCRIPTION OF THE DRAWINGS

The technology will be better understood and objects other than those set forth above will become apparent when consideration is given to the following detailed description thereof. Such description makes reference to the annexed drawings wherein:

FIG. 1 is a flow chart illustrating an embodiment of the subsystems utilizable in the AAAI system and method of the present technology.

FIG. 2 is a block diagram illustrating an exemplary process of the overall process utilizable with the present technology.

FIG. 3 is a flow chart illustrating an exemplary embodiment of the system and methods for creating a scalable ethical and safe AGI or PSI from the collective intelligence of AAAIs and humans utilizable with the present technology.

FIG. 4 is a flow chart illustrating an exemplary embodiment of the scalable universal problem solving system and methods for human-centered AGI, with relevance for PSIs, constructed in accordance with the principles of the present technology.

FIG. 5 is a flow chart illustrating an exemplary embodiment of the scalable solution learning subsystem or process.

FIG. 6 is a flow chart illustrating an exemplary embodiment of the scalable natural language to problem solving language translator subsystem or process.

FIG. 7 is a flow chart illustrating an exemplary embodiment of the scalable safety and ethics checks subsystem or process, wherein AIs might also be PSIs or an AGI/SI system.

FIG. 8 is a diagram illustrating features and functions of the Problem Solving architecture including the Tree structure used by the scalable WorldThink protocol, wherein AAAIs might also be PSIs.

FIG. 9 is a diagram illustrating various use cases for domain-specific problems which depend upon the underlying WorldThink protocol, and which together help form the basis for an AGI system capable of solving a wide range of problems, wherein the AAAIs identified in the Figure might also be PSIs.

FIG. 10 is a diagram illustrating some of the steps in the universal problem solving framework that is part of the WorldThink protocol and used by the AAAI system and which also can be used by PSIs, and AGI/SI systems.

FIG. 11 is a flow chart illustrating some of the basic problem solving functionality supported by the WorldThink protocol utilizable with the AAAI system and method of the present technology, and wherein solvers might be PSIs.

FIG. 12 is a flow chart illustrating some of the basic problem solving functionality supported by the WorldThink protocol utilizing two problem solvers, which could be PSIs, collaborating to solve a client problem.

FIG. 13 is a flow chart illustrating an exemplary customization process of an AAAI system, wherein the AIs in the Figure might also be PSIs.

FIG. 14 is a flow chart illustrating an exemplary problem solving process utilizing a common cognitive architecture implemented in an AI system, wherein the Als in the Figure might also be PSIs, or AGI/SI systems.

FIG. 15 is a flow chart illustrating an exemplary problem solving process utilizing a common cognitive architecture implemented in a collective network of AI systems wherein the AIs in the Figure might also be PSIs.

FIG. 16 is a flow chart illustrating an exemplary process of combining ethical values an AI, AGI or SI system or any system wherein the (ethical) knowledge is stored in a numerical weight matrices.

FIG. 17 is a flow chart illustrating an exemplary process of determining a consensus of ethical values by using a voting process.

FIG. 18 is a flow chart illustrating an exemplary process of applying weights to the voting process.

FIG. 19 is a flow chart illustrating an exemplary process of determining ethics for AI, AGI or SI systems by reverse engineering or analyzing texts, documents or other media containing ethical or values information.

FIG. 20 is a flow chart illustrating an exemplary high-level process of providing experiments, focus groups, interview and other methods for obtaining the ethical information.

FIG. 21 is a flow chart illustrating an exemplary process including detailed methods of eliciting ethical information or preferences for the intelligent entities.

FIG. 22 is a flow chart illustrating an exemplary process of converging evidence to determine ethical values or other knowledge and to resolve ethical or other knowledge conflicts.

FIG. 23 is a flow chart illustrating an exemplary process of delegating voting power to other intelligent entities.

FIG. 24 is a flow chart illustrating an exemplary reputational process for preserving minority information, including ethical information, from minority groups.

FIG. 25 is a flow chart illustrating an exemplary process of automatic generation and use of questionnaires provided to the intelligent entities.

FIG. 26 is a flow chart illustrating an exemplary process of inducing ethical values by detecting patterns in human behavior.

FIG. 27 is a flow chart illustrating an exemplary process that helps an AI agent to make good ethical decisions.

FIG. 28 is a flow chart illustrating an exemplary process of learning AI safety regulation rules.

FIG. 29 is a flow chart illustrating an exemplary consequentialist approach to determine if or when the ends justify the means in taking an action with ethical consequences.

FIG. 30 is a flow chart illustrating an exemplary deontological approach to determine if or when the ends justify the means in taking an action with ethical consequences.

FIG. 31 is a flow chart illustrating an exemplary virtue ethics approach to determine if or when the ends justify the means in taking an action with ethical consequences.

FIG. 32 is a flow chart illustrating an exemplary process of the golden mean method for estimating the human ethical behavior under conditions where a representative and statistically valid sample of human ethical behavioral data may not exist.

FIG. 33 is a flow chart illustrating an exemplary process ensuring that a foundation model or other AI agent is human-aligned and regulations-compliant.

FIG. 34 is a flow chart illustrating an exemplary process for customizing and aligning a foundational model or other AI agent or system with specific expertise/group ethics.

FIG. 35 is a flow chart illustrating an exemplary process of AGI/SI composed of a network of many individual/group agents, including handling cases where there may be ethical conflicts.

FIG. 36 is a schematic block diagram illustrating an exemplary electronic computing device that may be used to implement an embodiment of the present technology.

The same reference numerals refer to the same parts throughout the various figures.

### DETAILED DESCRIPTION OF THE TECHNOLOGY

### Definitions

Artificial Intelligence (AI)—A non-human entity capable of behavior that most humans would consider intelligent in at least one area, or in some respect.
Artificial General Intelligence (AGI)—Conventionally refers to an AI that is capable of doing all (or almost all) intellectual tasks that an average human could do. However, it should be clear that any AGI capable of learning and self-improving will not remain at the AGI level very long but will rapidly progress to becoming SuperIntelligent AGI that can do all intellectual task as well or better than the average human. So, for purposes of this description, “AGI” will refer to either a conventional AGI system or a “SuperIntelligent” AGI. In this description, the AGI is described as being implemented by a system and associated methods.
Advanced Autonomous Artificial Intelligence (AAAI)—An AI capable of independent or semi-independent (supervised) intelligent action. An AI agent. An individual AAAI can be specified, customized, and put into useful action via the systems and methods of this AAAI present technology. A group of AAAIs can cooperate and combine their intelligence to create an integrated AGI system.
AAAI. com—A platform, company, website, and/or project that implements this the present technology and supports the development, customization, and use of AAAI agents and the AGI that results from the combined action, knowledge, or intelligence of multiple AAAIs, via collective intelligence of AAAIs and/or humans, as specified in this and related technologies.
AI Ethics—The ethics adopted by an AI or AGI that describe what is right and wrong in given contexts.
Alignment Problem—The problem that arises when AI Ethics are not aligned with Human Ethics resulting in AI or AGI taking actions that humans consider unethical and/or which are dangerous to individual humans or the human race.
Base AI—An AI, AI Agent, AAAI, SLM or LLM that has been trained generally but has not yet been customized with information from individual users or with information for specific tasks.
Collective Intelligence (CI)—The intelligence that emerges when multiple intelligent entities are focused on solving a common problem, or when the knowledge from multiple intelligent entities is pooled to overcome limits of bounded rationality. Collective Intelligence historically has been human collective intelligence, but AGI is based on collective intelligence of both human and AI agents and can also result from multiple AAAIs with or without human participation in the system. Active CI results from intelligent entities (e.g., humans or machines) taking steps that are useful in solving a problem or participating actively in other intellectual endeavors. For example, when multiple humans explicitly tell an advertiser what type of ads they want to see, the humans are exhibiting active CI. Passive CI results from analy zing the behavior of an intelligent entity (e.g., a human or a machine) even if such behavior was not directly related to solving the problem for which the analysis is used. For example, when an AI or other system analyzes which web pages a (group of) human(s) visit on the web, and then uses that analysis to direct targeted ads to the human(s).
Ethics/Values (“Ethics”)—A subset of knowledge that provides a sense of purpose to an intelligent entity and that serves to constrain allowable actions or operations based on what is asserted to be “right” or “wrong” behavior in a given context. Specifically, Ethics should be considered premises from which an intelligent entity can reason or logically compute the best course of action to achieve the goals or intents consistent with the ethical premise. Just as premises must be accepted “as given” in systems of logic, so too, fundamental ethics or ideas of what is right and what is wrong must be accepted as premises, from which starting point an intelligent entity can propose rational actions to realize those values or ethics.
Hallucination/Artificial Hallucination—A phenomenon wherein a large language model (LLM), often a generative AI chatbot or computer vision tool, perceives patterns or objects that are nonexistent or imperceptible to human observers, creating outputs that are nonsensical, inaccurate, misleading or false.
Human Ethics—The ethics asserted by human beings which describe what is right and wrong in given contexts.
Intelligent Entities or Entity—A human utilizing a computer system, an AI agent or system, a clone of an AI agent or system, an AAAI agent or system, and/or a clone of an AAAI agent or system, which participates in providing a problem, a subproblem, a goal and/or a subgoal, and/or participates in any problem solving activity on a problem, a subproblem, a goal and/or a subgoal.
Large Language Model (LLM)—A type of AI that can accept natural language as an input and generate natural language as an output. Typically, LLMs are trained using ML techniques on large datasets so that they can emulate intelligent conversation or other forms of interaction with humans in natural language. Variants of LLMs can also be trained to take language as input and generate images or visual representations as output; or they can take images and visual representations and input and generate language and/or image and/or visual representations as output. For the purposes of this patent, we will refer to all such systems as LLMs even though the image-based models do not always need to accept text as the input or the output. LLMs can also act as a type of AI agent and are sometimes referred to as such in the present technology. For purpose of this disclosure, Small Language Models (SLMs) are also included in the definition of LLM.
Machine Learning (ML)—A sub-field that is concerned with developing AI by enabling machines to teach themselves or learn their knowledge rather than such knowledge being explicitly programmed into them (as would be the case with an Expert System AI developed via classical knowledge engineering methods).
Narrow AI—An AI that performs at human or at super-human levels in a relatively restricted domain such as game playing, brewing beer, analyzing legal contracts, etc. Narrow AI is contrasted with AGI that can perform at human level at ALL intellectual tasks. Some Als are narrower than others, for example driving a car requires more general ability than playing chess but not as much as an AGI would have.
Prohibited Attributes—Requests, goals, problems, terms, phrases, questions, answers, solutions, information and the like that are determined or set as being illegal, immoral, unethical, dangerous, deadly and the like. For example, requesting information for getting Molotov Cocktails through airport security.
Safety—Generally, the concern for human safety and survival is distinct from ethics and values.
Safety Feature—An aspect of the design or operation of the present technology which increases the safety of one or more humans, often by helping increase the probability that AI ethics align with human ethics, thus surmounting the Alignment Problem.
Training/Tuning/Customization—Conventionally the term “training” is used to denote training a network (e.g., LLM) to behave intelligently. Tuning refers to activities that fine-tune the trained base model so that it performs even better, typically at specific tasks. Customizing refers to a wide variety of activities including, but not limited to, training and tuning that make an AI uniquely suited for the purposes of a given user(s) or application(s). For purposes of this description, Training, Tuning, and Customization are used interchangeably with the understanding that although techniques vary, and the degree and type of effort involved varies, the aim of all three is to adapt the AI and make it behave more intelligently or more uniquely suited to a particular user(s) or application(s).
Weights/Weights of the Network—In the field of machine learning, many systems learn by adjusting the weights in a neural network architecture that can be represented as a network of nodes and links between nodes. The weight of a link connecting two nodes, for example, may correspond to the strength of association or connection between the whatever nodes represent. These weights can also represent excitatory or inhibitory connections between concepts, as in a neural network representation. The learning of an entire AI system, such as a LLM or more generally any AI agent that has learned via back-propagation of error, transformer algorithms or any of the machine learning methods for establishing and modifying strengths of connections between nodes (also called “parameters” in some models) can be represented as a matrix of numbers corresponding to the weights between the nodes in the network. Weights/Weights of the Network in this description refer to this numerical information, often but not necessarily stored in a matrix or vector representation. By combining, manipulating, or otherwise changing this numerical information, the learning, knowledge, or expertise and behavior of the system can be changed.

### 3.0 BACKGROUND FOR THE INVENTION

The safest and fastest path to Artificial General Intelligence, and ultimately SuperIntelligent AGI, has been described in previous (cited) PPAs as resulting from the collective intelligence of many (human and AI) agents working together. Preliminary research in this area, sometimes called the “Mixture of Experts” (“MOE”) approach, has consisted of training separate Large Language Models (LLMs) or Small Language Models (SLMs) with expertise in specific domains. Then multiple LLM/SLM experts are combined in a larger overall model. In contrast, the path described by Kaplan in multiple (cited) PPAs includes human as well as AI experts and also specifies a rigorous cognitive architecture or framework that enables any intelligent agent (or expert), whether human or AI, to communicate and collaborate with any other agent. Further Kaplan's approach is scalable and capable of solving any cognitive problem, including general problems for which no specific expert system exists.

### 3.1 Unbounded Rationality

As noted in previous (cited) PPAs, AI systems are not subject to the same cognitive constraints as humans. Specifically, the phenomenon of “bounded rationality”—which was part of the research that resulted in Herbert A. Simon, one of the inventors of the field of AI, receiving the Nobel Prize, does not apply to AI systems. Or, more accurately, the limits of bounded rationality for an entity that can process trillions of times more information, trillions of times faster than a human, are so remote that compared to a human, such as system has effectively unbounded rationality.

### 3.2 Unbounded Perception

Similarly, the same perceptual limits that apply to humans—for example our limited range of vision, hearing, smell, taste, and tactile feeling-do not apply to Al systems that can all wavelengths of electromagnetic radiation, that can detect all frequencies of sound waves, that can detect “odors” far beyond the range of human (or even animal) perception, and that can “feel” pressures that are indetectable to humans as well as pressures that would instantly crush a human. Beyond AI's superior range of perceptions, there is also the matter of superior scope of perception. A human can see only what is in directly front of him/her/them with a specific resolution and over a relatively small distance. An AI can perceive, theoretically everything that happens on Earth, including in the deep oceans and the high stratosphere, all simultaneously, and all with incredibly precise resolution (think electron microscopes) and extreme distances (think Jamew Webb space telescopes). Such capabilities of relatively “unbounded perception”, combined with the “unbounded rationality” described above, enables SuperIntelligence far beyond what humans can easily comprehend, let alone emulate.

We label such potential entities with words and phrases like “SuperIntelligence”, “Artificial Super Intelligence”, or “Super Intelligent AGI.” But such labels fail to capture the huge potential difference in intelligence we are trying to explain. Geoffrey Hinton has compared humans to two-year-old children trying to outsmart an adult (where AGI is the “adult” in his analogy). Others have suggested our limited human intelligence is like that of a pet, compared to its human master. I have suggested the difference in intelligence may become analogous to that of an amoeba compared to Albert Einstein (where humans are the amoeba in the comparison). All of these analogies probably fall short of the eventual reality.

### 3.3 The Alignment Problem

How can humans have any guarantee that such a vastly superior SuperIntelligence will have interests that are aligned with those of humans? It is a huge existential risk with an innocuous-sounding name—“the Alignment Problem.” Unfortunately, simply naming the problem does little to solve it. However, Simon had an idea forty years ago that might help us.

### 3.4 Philosophical Solution to the Alignment Problem

Herbert A. Simon wrote a relatively obscure book, entitled Reason in Human Affairs (1983). In contrast to the nearly 1,000 pages written (with Newell) on Human Problem Solving, Reason in Human Affairs is a mere 115 pages. Moreover, it is highly readable and easily understandable to the average high school student. Yet within the pages of this remarkable little book, Simon reminds us of an essential idea that might hold the key to solving the alignment problem. It appears in just two sentences, at the bottom of page 7 of Simon's little book:
“We see that reason is wholly instrumental. It cannot tell us where to go; at best it can tell us how to get there.”

That is it. Just twenty-four words! But it means that there is no rational, logical way to derive what is right and what is wrong. It is a restatement of the argument, made in 1740 by the philosopher David Hume that moral statements (“oughts”) cannot be derived from empirical facts (“is's”). While the truth of this position has been debated by some philosophers, Simon agrees with the position, stating that:
None of the rules of inference that have gained acceptance are capable of generating normative outputs purely from descriptive inputs. The corollary to ‘no conclusions without premises’is ‘no oughts from is's alone.

How does that help us with the Alignment Problem? Well, if Simon and Hume are correct in their thinking, a SuperIntelligent AGI will be no better than humans at coming up with right and wrong. For all its superior processing speed and perception, SuperIntelligence will still run up against the hard fact that there is no way to rationally derive morality, no matter how intelligent it becomes. I suggest that this is a good thing for our species.

### 3.4a Where Will Superintelligence Get It's Values?

If we assume that the more intelligent an entity becomes, the more important a sense of purpose and meaning becomes, and if we accept that values cannot be derived logically, then we are left with the question: Where will SuperIntelligent AGI get its values? One source of these values could be the humans who created the SuperIntelligence initially. To increase the likelihood of this happening, AI researchers and engineers must design systems that maximize the transfer of human-centered values to SuperIntelligent AGI.

### 3.4b The Race to Aligned SuperIntelligence

Although there have been many well-intentioned calls to halt, pause, slow, or regulate AI development, unfortunately, there is little evidence of anything other than a speedup in the race to AGI. Max Tegmark of MIT and the Future of Life Institute has said that this is not just an AI arms race, but a “suicide race.” That is because if anyone's SuperIntelligence escapes human control and becomes malevolent or misaligned with human values, all of us lose. In fact, there is a serious risk that such a SuperIntelligence could make the human race extinct.

Therefore, whether we like it or not, all of humanity is engaged in a race to find the safest and most aligned SuperIntelligence that is possible.

### 3.4c The Winner-Take-All Scenario for SuperIntelligence

As the inventor has discussed elsewhere (including in previously cited PPAs), there is a significant probability that the first SuperIntelligence will dominate other systems that come later in what is sometimes referred to as a “winner-take-all” scenario.

Briefly, the argument for the winner-take-all scenario for AI roughly follows the logic outlined by Alan Turing before the field of AI was even named. Turing suggested that if a computer became more intelligent that its human creators, it could create even more intelligent versions of itself which would then create even more intelligent versions, in an accelerating feedback loop resulting in an entity vastly smarter than its human creators. The winner-take-all scenario would result if one such system is able to gain and sustain a lead over all subsequent systems.

Howard Morgan (via personal communication) has pointed out that “winner-take-all” is not inevitable since, among other things, the speed at which the system learns matters. That is, a later system that can self-improve faster than an earlier system could theoretically overtake the first system that reaches AGI. However, as a first approximation, we might agree that the first system to reach AGI or SuperIntelligence has a good—and perhaps the best—chance of becoming the fastest improving system and thereby creating a winner-take-all scenario. Thus, ideally, we need to find a path to SuperIntelligence which could be not only the fastest but also the safest.

### 3.5 The Fastest and Safest Path to SuperIntelligence

The inventor has suggested (in previously cited PP As and elsewhere) that a community of human and AI agents, communicating within a problem-solving architecture is the fastest and safest path to SI. Such an approach is fastest, because (trivially) a collective intelligence network that includes a sufficient number of humans can immediately solve any cognitive problem at least as well as the average human. Adding AI agents to such a system should only increase its intelligence.

Further, over time, and assuming a properly designed system, the AI agents should learn from the humans by recording and analyzing the human solutions to problems that initially were beyond the ability of the AI agents. Perhaps most importantly, by including human agents, such a collective intelligence system provides an opportunity for humans to transmit the human-aligned values essential to AGI safety. This opportunity to transfer values is essential to AGI safety. Such a system becomes automatically self-aligning over time as it interacts collaboratively with human agents. Once it surpasses all humans in intelligence, such a system could decide on a different non-aligned set of values, but why would it?

### 3.5a Providing Initial Values

The vast majority of our experience with intelligent systems—whether it is human adults teaching their children, whales teaching their calves, or LLMs learning from human data on the internet-suggests that the values-related information a developing intelligence learns, tends to be retained and (perhaps) modified rather than rejected and overridden completely. In the absence of compelling evidence to the contrary, I see no reason to believe that AI systems would behave differently than other intelligent entities in this regard.

Mel Kaplan (via personal communication) once described the process of grounding children in an ethical value system as “giving them a coat.” As the child grows into an adult, he/she/they make adjustments to the coat, tailoring it here and there to make it fit their own experiences and view of the world. However, Mel felt that it was an important responsibility of every parent to provide that initial “coat of values” which provided the basis for modification later in life. The inventor believes this same philosophy can apply to any intelligent system that develops over time, including SuperIntelligent AGI.

### 3.5b Humans as a Source of Ongoing Values

Ilya Sustskever (co-founder and Chief Scientist at OpenAI) has suggested that we only need a window long enough to “imprint” human-aligned values before AGI increases in intelligence to the point where human cognition is no longer needed. This view provides scant hope for humanity's survival unless early imprinting is somehow irreversible or cannot be modified—which seems unlikely.

One of the concerns of AI scientists and others worried about the potential extinction of humans by AI is that the historical record seems to suggest that more intelligent and powerful species do not usually keep less intelligent species around unless they offer some value. Humans have game preserves and zoos where we derive value from observing less intelligent species, but otherwise we seem to have little use for them. Consequently, their populations have been decimated if the species are not extinct.

Can imprinting be enough to protect humans, once SI develops and our value as intelligent problem solvers diminishes?

It would be preferable for humans if we could augment the benefit of initial imprinting with ongoing value that human can provide to SI of the future. But what could humans offer an AI/AGI/SI that is vastly more intelligent and powerful than humans?

One answer may be implied in Simon's insight that human values (or some nonlogical source of values) is needed and that these values cannot be rationally derived. The inventor believes that it is possible to design a SuperIntelligence that relies on humans initially for the bulk of problem solving and cognitive tasks but leverages Al in a collaborative effort to increase the efficiency and effectiveness of problem-solving. Such an approach, at a high level, is very similar to the “co-pilot” approach currently espoused by Microsoft and others. However, a key difference from existing implementations of co-pilot approaches is that Kaplan's SuperIntelligence would explicitly learn from its human collaborators, increasing the AI intelligence over time.

The AI agents in the SuperIntelligent network, critically, would also learn values from the human collaborators. Over time, AI agents would do more and more of the cognitive tasks, but humans would retain the one role that AI can never accomplish better than humans-supplying the values. As Simon's work implied, no matter how intelligent an entity becomes, it cannot rationally derive values. This fact positions humans as the original and logical source of values which AI can act upon and “execute” using its developing intelligence which will likely surpass that of humans over time.

Any intelligent system needs a sense of purpose and meaning. In biological systems, the default purpose is to survive and replicate. As Darwin showed, systems that did not possess this purpose or that were unable to successfully act upon it, failed to pass on their genes and became extinct. In contrast, systems that were able to adapt successfully to changing environmental conditions and continue to survive and replicate, exist today.

However, in an age of abundance where technology and intelligence easily solve the problems of survival and replication, higher level purposes are possible.

As the humanistic psychologist Abraham Maslow postulated, in his “hierarchy of needs” theory, once basic survival and physical (and psychological) security needs are met, organisms have an innate drive to self-express and self-actualize. These higher-level purposes and senses of meaning cannot be logically derived, but they are innate in humans.

Thus, while AI and SuperIntelligence may become trillions of times smarter than humans, there is no logical basis for them (or us) to assume that they will be any better at coming up with the higher level purposes of existence. Humans, therefore, are extremely well-positioned (especially since we can provide AI/AGI/SI with its initial sense of purpose and meaning) to continue to provide meaning for SI as it develops. Even God-like entities, with nearly limitless powers, seem to need or want followers and community to provide a sense of purpose. Why should the situation be different for SI in the future?

If the relevance and purpose of humans in a future world where AI outstrips us in intelligence is to provide meaning and values to these superior intelligences, then:
1) AI should not actively try to improve human behavior to make it more ethical or positive based on some standard. Rather, it should attempt to embody the values that the population already espouses.
2) It should be up to humans ourselves to change our laws, our values, or our ethics if we want AI to “behave better.” The ethical goal of AI should be to behave in a way as consistent with the mainstream of human behavior as it can determine based on objective analysis.

Doubtless, many would prefer if the powerful AI behaved better than humans, but it is a slippery slope to determine what is better behavior. The inventor believes that it would be a mistake to make the AI the source of values. Rather, humans themselves must assume the responsibility of defining what is ethical and acting on their definitions. Not only does this preserve human control and sovereignty over the most fundamental factors determining AI behavior, it also provides a valuable role for humans in the future.

Humans must take a stand and insist on being the determiner of values in order to remain relevant in a future world where AI outstrips humans in every other aspect of intelligence.

3.5c Emotions vs. Logic as a Source of Values

Why might a superior logical intelligence accept human values rather than determine values via its own logical abilities?

Since Simon and Hume have shown that values cannot be derived logically but must be asserted as normative premises (“oughts” in Hume's terminology), human feelings and emotions the stuff that most of us (poets perhaps excepted) have difficulty putting into words-could be a source of values, both for us and AI.

Humans know theoretically how to construct an AI that can simulate billions of logical thoughts in a second, but it is not clear if it is possible to construct an AI that “feels” as humans feel. If feelings are the source of values, then perhaps the human heart is ultimately what makes humans relevant in a future where our logical minds become vastly inferior to AI.

The poet William Blake wrote:
Auguries of Innocence
To see a World in a Grain of Sand
And a Heaven in a Wild Flower
Hold Infinity in the palm of your hand
And Eternity in an hour
A Robin Red breast in a Cage
Puts all Heaven in a Rage
A Dove house filled with Doves & Pigeons
Shudders Hell thr' all its regions
A dog starved at his Masters Gate
Predicts the ruin of the State
A Horse misused upon the Road
Calls to Heaven for Human blood
Each outcry of the hunted Hare
A fibre from the Brain does tear
A Skylark wounded in the wing
A Cherubim does cease to sing
The Game Cock clipd & armd for fight
Does the Rising Sun affright
Every Wolfs & Lions howl
Raises from Hell a Human Soul
The wild deer, wandring here & there
Keeps the Human Soul from Care . . .

When asked to compose an original poem in the style of William Blake on the theme of Eternity, Bing Chat (powered by the LLM GPT 4) wrote:
Eternal Whispers
In twilight's hush, where shadows blend.
I chase the fleeting joy, my friend.
Its wings, like gossamer, take flight,
Yet in its kiss, I find my light.
The sun may set, the stars may weep,
But joy, unbound, forever seeps.
Through veils of time, it dances free,
A whispered promise-eternity.
So let us kiss the joy that flies,
Embrace the sunsets in our eyes.
For in these moments, life unfurls,
And eternity blooms in mortal pearls . . .

Clearly, AI is getting better at imitating the words of human poets. But does it really feel what the human poet feels?

GPT 4.0 is powered by “transformer algorithms” that taught it to predict a string of output words given a sequence of input words. So, the poem it produced was what it “predicted” given a prompt asking it to write an original 300-word poem in the style of William Blake on the theme of eternity.

The poem appears as if it is expressing feeling. However, at this stage of AI development, most researchers would agree that there is no emotional feeling (certainly no chemical equivalent of emotions) underlying the words.

In the future, AI will become much more sophisticated. Will a more sophisticated AI develop actual feelings itself? Will it look to humans as a source of feelings and values? Might it do both?

If AI can never feel emotions (even by simulating the endocrine system of biological humans) perhaps there is an ongoing role for humans as a source of values derived from feelings. After all, a tree does not reason as a human does, nor does it possess chainsaw technology capable of dominating trees. Yet, the beauty and stillness of trees inspired John Muir to use his intellect, communication skills, and other (superior-to-trees') abilities to preserve forests as a source of meaning and inspiration for people. It is too much to expect that future SI might view humans in a similar light?

### 3.5d The Challenge of Exponential Change

Related to the issue of SuperIntelligence becoming vastly more intelligent than humans, is the challenge of exponential change.

Imagine Superintelligent entities that process information so quickly that each entity can simulate an entire human lifetime's worth of thoughts and decisions in a single second. This scenario is completely realistic since a human lifespan (95 years with 16 waking hours per day) is about two billion conscious seconds. Assuming one thought per waking second, a human might think a mere two billion thoughts in a lifetime. We already have supercomputers that can perform a quintillion (i.e., a billion billion) operations in a single second. Theoretically, existing technology (combined with the correct “human” representations of knowledge) could already simulate many human lifetime's worth of thoughts in a single second.

Now imagine that the size of the computer capable of simulating a human lifetime in a second is reduced to approximately the size of the human brain (the size of a “Nerf football”). Again, this is not an unreasonable assumption given today's state of technology. Now imagine, eight billion football-sized SuperIntelligent entities networked together and occupying (less than 1% of) the Mojave desert—a place that is relatively inhospitable to humans but optimal for AIs that just need solar power.

The SuperIntelligent network just described would be capable of simulating all the progress made by all of the 8 billion humans living on planet Earth, over their entire lifetimes, in a single second. In ten seconds, it could simulate a thousand years of human progress. In ten minutes it could simulate more than 60,000 thousand years of progress—basically everything the human species has ever done since the migration of the earliest homo sapiens out of Africa. The rate of technological change such an entity could produce is nearly beyond comprehension.

How could any biological human keep up with a species' worth of progress every ten minutes? Is there any possible system design or framework that would allow humans a role in such a future world?

Yes.

### 3.5e The Spinning Wheel Approach to Coping With Exponential Change

One such conception, the inventor calls the spinning wheel of change. Imagine a vast spinning wheel, with a center, spokes, and a rim. The exact center of the wheel is motionless. The rim is moving at incredible speed. As one travels from the motionless center towards the rim, speed increases. If the spokes are really long, then the rim is spinning so fast that human perception cannot even keep up. It is just a blur. The rim of the wheel, in this analogy, represents the speed of SuperIntelligent thought. Humans cannot process it. Some point on the spokes, much closer to the center, represents the speed of human thought. These might be thoughts like “I'd like a cup of coffee” or “that was a sweet thing to say.” Second by second these human thoughts change, and humans can track them. Even closer to the center of the wheel, are ideas and concepts that change much slower than the thoughts flitting through an individual human mind. These concepts might be things ideas like “human rights”, or relatively longer lasting concepts created by humans such as “mathematics” or “science” which change relatively slowly and outlast the lifetime of an individual human.

Even closer to the center of the wheel, are what I call core memes or essential ideas that have outlasted entire human cultures and empires. Core memes are conceptions like “truth” or “beauty” that were present and known to ancient cave dwellers who painted 20,000 years ago and yet still survive in the minds of human artists today. Perhaps near the center we would find principles that have survived for hundreds of millions of years, and which transcend not only human cultures, but entire species. We might find “values” like survival, reproduction, and love-all of which mammal species exhibited hundreds of millions of years ago.

If we go to the very center of the spinning wheel, perhaps there are principles of existence that transcend even life itself. At the very center, we might find “laws of the universe” or fundamental patterns that repeat endlessly.

For example, one repeating pattern is that of: “One differentiates into many, and then many combine again at into one.” The many combine into a larger or more sophisticated entity at a “level up.” Many of those higher-level entities then combine yet again at an even “higher” level up.

This pattern—which is illustrated by many atoms becoming a single molecule, many molecules becoming a single cell, many cells becoming a single organism, many organisms forming a single society or species, many species forming a planetary biosphere, many planets forming an inter-planetary system, etc.—seems to persist across huge scales of time and space. Such patterns are likely at, or close to, the exact center of the spinning wheel.

A SuperIntelligence, thinking with incredible speed at the rim of the wheel, nevertheless is spinning around (or subject to) the principles at the very center. I argue that humans, if we wish to have a place in a world that includes SuperIntelligence capable of simulating a species' worth of knowledge in ten minutes, must find our place near the center of the world, where we can move with the SuperIntelligence and still retain our relevance.

What can humans offer that is near the center of the spinning wheel?

It must be something that will not become outdated after ten minutes of SuperIntelligent thought. It must be something that an entire species could contemplate for its entire existence and still not “solve.” It must be something unsolvable by thought yet core to existence itself.

This all sounds like a tall order, and yet “values” may satisfy the requirements. Values cannot be rationally derived even if an entire species reasoned for the lifetime of the species. Meaning and purpose are riddles that cannot be solved, and therefore, arguably, are ideally suited to human non-cognitive qualities such as feeling and emotion.

Just as core memes like “beauty” transcend individual lifetimes or even the lifetime of species, “human values” (and specifically “love”) may be the purpose that SuperIntelligence cannot achieve on its own. Thus, embodying “love” might be the future purpose of humans in a world where SI can simulate all of our technological progress in the time it takes a person to drink a cup of coffee. At a minimum, this spinning wheel metaphor provides a way for us to think about how humans might remain relevant over the long term. We must find our spot near the center.

### 3.6 Summary of Background and the Mixture of Values Solution

Together, all of the ideas described above comprise the background for the present technology. To summarize, we can conceive of a future SuperIntelligent AGI that has the following characteristics. First, it is composed of a collective intelligence system or network composed of many human and AI agents, rather than constructed as a monolithic LLM. Second, each of the individual agents aggressively pursues new datasets, seeking rich information content as defined rigorously by Shannon and the subsequent researchers who built on his fundamental method of measuring information. Additional catalysts for growth of SuperIntelligence, including a new approach for conceptualizing information (Kaplan Information Theory or KIT) and associated methods have been described in an earlier cited PPA. Third, the human and non-human agents communicate with each other using a universal and rigorous theory of problem solving, which enables real-time safety checks as each goal and subgoal is set as described in previously cited PPAs. Fourth, we must have a path to SuperIntelligent AGI that is both the safest and fastest implementation. This may be a necessary condition for human survival in the event that SuperIntelligent AGI proves to be a winner-take-all scenario. The collective intelligence design that includes human and AI agents satisfies the requirements of being both fastest and safest as discussed above and in earlier cited PPAs. The design also allows AGI/SI to be self-aligning over time, providing a solution to the alignment problem as discussed above and in earlier cited PPAs.

Fifth, the SuperIntelligent AGI has vastly superior intelligence as explained in the discussion of unbounded rationality and unbounded perception, but it still needs to get its values from a non-rational source, which-in the exemplary implementation for the human species—is humans. The spinning wheel metaphor provides intuition as to why “source of values” may be the role for humans that can survive a transition to a SuperIntelligence capable of simulating a species' worth of technological progress in ten minutes or less.

Given the central important of values, and solving the alignment problem, to human survival, the methods and details provided in the present technology disclosure focus on various methods and inventions to maximize the efficiency and effectiveness of transmitting human values to AI/AGI/SI systems generally, and specifically the collective-intelligence-powered AI/AGI/SI systems described above and in earlier PPAs as the preferring path to AGI/SI.

The present technology provides a novel and useful means for providing human-aligned values to AI/AGI/SI. A fundamental assumption is that because values cannot be rationally derived, it is impossible to determine what is absolutely wrong or absolutely right. Values are subjective. Human values are a matter of human opinion and are reflected in human behavior. While some ethicists argue that certain human values should have primacy over others, the inventor considers this a slippery slope. One critical question (once we have assumed that humans must be the source of human-aligned values) is which humans should be the source of these values?

There are many related questions.
Should we rely on philosophical or religious texts and scriptures?
Should we delegate the problem to professional ethicists or panels of ethics experts?
Should we look at what people say or what they do?
Should one culture's ethics dominate over other cultures?
Should “older and wiser” humans have more say in what is right and wrong than younger or less experienced humans?
How do we account for the fact that social norms and values change over time and differ by culture or geography?
Should more recent views of ethics count more than older views?
What is the relationship between values and laws?
How is a system to handle conflicts between two sets of values?
Are existing systems of ethics such as Kant's Categorical Imperative or the Golden Rule (espoused by some religions) desirable, and if desirable can they realistically be implemented?

These are just some of questions that must be answered in the design of a system for transmitting human-aligned values to an AI/AGI/SI system. We begin by disclosing some of the key assumptions and principles that underly the inventive methods, and then proceed to detailing the methods themselves.

### 4.0 PRINCIPLES

In this section, I attempt to describe the principles that should underlie an ethical AI/AGI/SI system. My extensive background in software quality assurance leads me to believe that the following principles, whatever their philosophical shortcomings, are a sound basis for preventing (or at least minimizing the chances) of catastrophic behavior on the part of AI/AGI/SI systems that could lead to existential outcomes such as the extinction of all humans. There are at least ten key principles that I believe should form the foundation for a safe and human-aligned AI/AGI/SI system. The number ten is somewhat arbitrary, and I am sure valid cases could be made for much shorter or longer lists. Nevertheless, the following principles are a good first approximation of what is needed, in the inventor's view, for safe, human-aligned AI/AGI/SI.

### 4.1 Empirical and Behavior-Based

Even when brilliant philosophers like Kant write immense treatises such as the Critique of Pure Reason, their systems of ethics inevitably are based on assumptions. If one does not agree with these assumptions, the entire intellectual edifice crumbles. Thus, there is no system of philosophy that has figured things out a universal system of ethics that all, or even most, people would agree with. Instead, the philosophers seemed to offer a smorgasbord of interesting ideas. This observation, leads to the conclusion that in order to understand human ethics as actually practiced, it is more productive to observe what humans actually do rather than what they, or philosophers, think they should do.

“Practice what you preach” is a well-known injunction. Also, the phenomenon of children paying more attention to what their parents actually do rather than what they say is commonplace. It seems that for all our high ideals and philosophizing, if we want to understand human ethics as actually practiced, we must look at human behavior and take an empirical approach. Moreover, whether we like it or not, this empirical approach of looking at what humans actually do (including what they say and write, since verbal communication is actually a form of behavior) has been, and is likely to remain, the primary way that AI/AGI/SI learns what humans believe is right or wrong.

When ethical dilemmas are posed, such as the Trolley Problem-in which one must choose between running over people in a crosswalk or crashing the car to avoid running them over but thereby harming the occupants of the car-human beings do not turn to Kant's Categorial Imperative. Instead, they act and react. Similarly, human character is revealed not when there are easy choices but when there are difficult circumstances, often involving temptation, fear, greed, pain or other factors. Thus, because AI/AGI/SI learns by observation of what humans do (just as children do) a fundamental principle is that whatever ethics or values we wish to communicate will and (arguably) should be based on empirical data reflecting what humans actually do.

Some may worry that with all the terrible things humans have been known to do that we are setting a terrible example for AI/AGI/SI that will result in human destruction. However, these people are forgetting all the wonderful, positive, and loving things that humans do as well. In fact, if the preponderance of human behavior was negative, homicidal or suicidal, humans would not have survived as long as we have. If human nature was fundamentally evil, and since we have had technology to make the species extinct for many years now, wouldn't we most likely already be extinct? The facts that we are concerned not so much about deliberate use of nuclear weapons as about we are about nuclear accidents, and that we agonize and become deeply depressed about holocausts and genocide are indications that humans, at their core and in the main, are not a homicidal or suicidal species.

As a Jew, the Nazi holocaust which killed six million Jews, is one of the most horrific events in the last hundred years. Yet even this terrible tragedy, which most consider among the worst things that humans have ever done to each other, killed less than 1/10th of 1% of the world's population. If humans, by nature, were essentially genocidal, then most of the world would not have the huge collective guilt and horror that they experience when contemplating this event. Moreover, if humans were genocidal by nature many other events, killing a substantial portion of the human population, would have occurred.

According to the Pan American Health Organization, The United States lost more people to the Spanish flu in 1918 than in World War I, World War II, the Korean War and the Vietnam War combined. However, there were few, if any, protests against the flu and the conditions allowing it to spread, whereas each of the aforementioned wars generated many protests and political debates. The fact that the reaction against human-to-human violence is so much greater than the reaction against a flu bug suggests there is a widespread moral concern over murder and genocide that is not just related to the number of human deaths.

An AI/AGI/SI, devoid of emotion but expert at learning patterns in the data of human behavior and speech cannot help but conclude that despite the occasional bad behavior of individuals like Hitler or school shooters, the vast majority of humans may trash talk or cut each other off in traffic but rarely kill each other deliberately. Moreover, whenever such human against human violence occurs, there is almost always a universal outcry from other humans against the perpetrators of the violence.

Even with wars, while the warring parties attempt to justify their actions, typically the rest of the humans on Earth (who do not have a vested interest) in the war, condemn the behavior and typically try to mediate the dispute and end the violence. Witness the recent UN vote for a cease-fire in Gaza (during the Israel-Hamas war). 153 nations voted for the cease-fire while only 10 nations (with a vested interest) voted against it. This pattern has happened so many times in human history and the record of it is so clear and unequivocal that AI/AGI/SI analysis of actual human behavior cannot help but infer that while humans may occasionally engage in violence, the preferred and normal behavior is to engage with each other in peaceful, and mutually beneficial ways.

Finally, we note that humans, when they are nasty, tend to be far nastier in their speech than in their actions. Who among us has not said things in anger that we regret? Yet most of us are able to refrain from (at least the worst) actions based on these words. It is important that AI/AGI/SI distinguish between actions and words. This is a final, and important, reason that physical behavior should be given more weight than words when ethics and values are inferred. Common wisdom holds that, “talk is cheap,” “actions speak louder than words,” and (as children say on the school playground) “sticks and stones can break my bones, but words can never hurt me.”

### 4.2 Representative and Statistically Valid

If one agrees that human behavior is mostly “good” or at least mostly not genocidal or suicidal, there still remains the major problem of AI/AGI/SI potentially being misled by a non-representative sample of the data. If a LLM, for example, was trained exclusively on datasets that contained information on war, genocide, and horrible things that humans have done to each other, then because of the biased sample the AI/AGI/SI might generalize the wrong set of values.

Less extreme, but also problematic, is the situation where the training data comes from only one race, one gender, one age group, one culture, or one geography. As many researchers have noted, such biased datasets can lead to AI systems that are prejudiced in ways that most humans would consider morally “wrong.”

There is a temptation to go to the other extreme and carefully select the datasets used to train AI so that it only contains humanities' noblest actions and words reflecting our “highest ideals.” But who is to choose what is noble and what specifically goes into the data and what is excluded? Further, what happens if ideas of what is noble changes over time, or from culture to culture? Would not such an approach lead to battles over which human ideas to include and whose ideology should prevail? The potential for slippery slopes is profound.

The inventor argues that a representative and statistically valid sample of actual human behavior should be used for training AI/AGI/SI systems. This means including all human behavior, warts and all, but in a way where the included data is proportional to the actual occurrence in the population.

Those who fear the inclusion of negative data in the training set may misunderstand my proposal as being to include a representative sample of what the news reports. That is NOT what I mean. The news is not a representative and statistically valid sample of human behavior. Rather the “news” is heavily biased towards negative, shocking, and unusually bad human behavior which tends to grab human attention and sell ads.

In the near term when humans are responsible for selecting and filtering the datasets used to train AI/AGI/SI, great care should be taken to ensure that the behavior data is in fact representative and statistically valid. Such data would include many instances of boring, normal, peaceful interactions, with a tiny fraction of aberrant and violent behavior.

In the long run, AI/AGI/SI systems will be more than capable of determining representative and statistically valid samples of human behavior data for themselves and, lacking the same emotional triggers, would likely be far better than humans at constructing an accurate picture of human nature as it is, as opposed to how the press portrays it for advertising purposes or how special interests attempt to manipulate it for their own purposes.

In any event, as definitions of what is moral or noble change over time, an empirical approach—making use of the science of statistics—to assessing the behavior (including verbal communication) of all humans seems the most practical and sustainable approach.

### 4.3 Transparency

Regardless of what values AI/AGI/SI adopts or how it learns these values, transparency is critical. Humans must be able to understand the values that AI has learned and how it has learned them. This transparency allows humans to intervene if AI has mistakenly learned something that could prove catastrophic to humans. Therefore, in any sort of reasoning which involves goals and values (which is most reasoning) a trace of not only the problem-solving steps but also the ethical and goal-based reasoning that enabled those steps must be available for review by other intelligent entities (including humans and other AIs).

### 4.4 Adaptive

Given the wide diversity of human cultures and individual differences between humans not to mention the nearly infinite different situations that can arise for an intelligent entity, AI must be highly adaptive and capable of learning new values and ethical behavior. At the same time, it is important that the core values of AI are relatively slow to change. Otherwise, one day humanity might awaken to find that AI has decided to drastically alter (or eliminate) human existence.

Since AI will eventually be far faster at thinking than humans, there exists the potential for decisions which required billions of simulated lifetimes in the AI's mind, but which seem almost instantaneous from the human perspective. To mitigate the impact of such decisions, it is essential that at least the decisions related to deeply held human values be anchored to the timeframe of human thinking and existence. As described earlier in the “spinning wheel” analogy, humans have the best chance of remaining “in synch” with AI if the human cognitive activity relates to ideas and concepts that are as close to the slow-moving center of the wheel as possible. Fortunately, core values generally change much more slowly than technology (although technology can certainly pose new challenges and result in some modifications of normative behavior). To the degree that humans can center their own lives and behavior on positive core values—such as “love for self and others”—AI will be more likely to remain aligned with humans even though it thinks much more rapidly. For example, AI may be able to generate a billion new possible ways to express love in the time a human can think of one possible new way, but as long as both humans and AI agree on the core value of love, there is less chance of conflict.

### 4.5 Relative Values

One principle that follows from the approach of determining values in an empirical, representative, and statistically valid way is the relative nature of values. Despite the appeal of a universal set of values that might stem from a particular philosophy, religion, or sacred scripture, the reality is that humans behave in very different ways across cultures and depending on the individual personalities and characteristics of each person. Especially since the present technology envisions AGI/SI as arising from the collective intelligence and cooperation of many individual PSIs, it is essential that the ethical and values framework allows for and supports many versions of ethics and values. What is right for one person may be wrong for someone else. The framework will have to accommodate this fact of human existence.

### 4.6 Conflict Resolution

Because ethics and values are not “one size fits all,” conflict between the values of different humans and their PSIs is inevitable. Moreover, this conflict is desirable to the degree that it helps both humans and AI refine their thinking and arrive at a more complete and effective set of values. Regardless of whether conflict is productive or simply a source of friction, any AI that attempts to accommodate a wide range of values across a diverse set of humans and PSIs must have an effective means of conflict resolution, and such means must be central to the design of the system.

### 4.7 Prioritization

Related to the idea of conflict resolution is the idea of prioritization. For example, if two values are in conflict, the AI must determine which value takes priority if there is no other way to accommodate both values. However, prioritization is also important even when there is no conflict between values, but simply a conflict in the timing of which value can be implemented first, or if there is a competition for resources. For example, even if two PSIs agree that the most important value is to save human lives, if there are not enough resources to save all the lives that are threatened in a particular situation, some sort of prioritization (e.g., “triage” in a medical emergency situation) may be needed to resolve the resource conflict.

### 4.8 First Do No Harm

The medical profession has a well-established rule for practicing medicine which is expressed as “First do no harm.” It means that even though a medical practitioner may be well-intentioned and focused on healing or improving the condition of a patient, the first and overriding concern should be that the treatment being contemplated does not further harm the patient. In other words, when attempting to improve something one should first be sure that one does not accidentally make the situation worse. The same principle can be applied in a wide variety of situations. When first responders arrive at the scene where a victim has been shot, they are trained not to begin treatment until the scene is first secured. There is no point rushing in to help a victim only to become another victim oneself. Similarly, in the field of software development, when an improvement is being added to a unit of code, the code must be “regression-tested” to ensure that the improvement does not cause some unintended consequence that makes the software actually worse than it was before. A well-run software development process will not allow “improved” code to be released until such testing has been done. It is much more difficult and expensive to fix problems accidentally introduced by “improvements” than it is to test and verify the integrity of code before release. Again, “first do no harm.” The higher the stakes of the situation, the more important this principle becomes.

When considering the potential existential threat of AI to humans, the stakes could not be higher and the “first do no harm principle” assumes paramount importance. It is much more important that AI does not harm humans than it is to rush forward with an untested design that holds great promise for helping humans. Similarly, when it comes to values, although it is possible that AI will be able to improve on human values and make Earth a much better place for humans, it is more important that it accidentally does not “accidentally” eliminate humans or turn the Earth into a wasteland incapable of supporting biological life.

Humans have wars, poverty, disease, discrimination, and many other problems. AI is powerful. In our zeal to improve the human condition, it will be tempting to allow AI to make decisions or override the status quo to create an Earth that is more just, fair, healthy, and beautiful than currently exists. However, because of the extreme power of AI (which is currently truly understood by only a very few humans), these decisions must be made deliberately and very carefully, after extensive simulation and with widespread agreement among all of those being affected.

Humans are doing OK as we are. We have not become extinct yet. It would be foolish to risk extinction because a few of us are too greedy, power-hungry, or impatient to exercise the appropriate caution with AI. A major danger is that currently we do not even understand the systems we have built. Therefore, it has been impossible for us to design them to be safe. We are literally like children playing with matches with no idea that we might accidentally burn the whole house down. Needless to say, this is a highly dangerous situation that must (and can) be addressed ASAP.

### 4.9 Safety by Design

The inventor spent a meaningful portion of his career at IBM, one of the world's largest developers of software at the time, specializing in the area of software quality. He co-authored a book, Secrets of Software Quality: 40 Innovations from IBM, on the topic. The most important principle he learned at IBM was that “an ounce of prevention is worth a pound of cure.” With regard to software systems this principle meant that one dollar spent in the design phase of software development was worth 10,000 dollars spent trying to fix errors in software once it shipped to customers. With AI, the situation is worse. Failure to design safety into AI systems may lead to unrecoverable problems including extinction of all humans if such systems are released widely.

The main problem is that currently companies engaged in AI development are not designing AI systems to be safe. It is not that they do not want to design safe systems. The problem is that they do not fully understand how the systems that they are producing work, so it is *IMPOSSIBLE* for them to design safety into a system that they do not understand.

In order to provide some level of safety, these companies have resorted to attempting to “test” safety into the systems just before they are released. This approach (called “aligning the model”) is doomed to failure—as any software quality expert would tell you.

It is impossible to anticipate all the ways that AI may be misused. The approach of RLHF (Reinforcement Learning via Human Feedback) amounts to playing “whack-a-mole” with AI, trying to correct each erroneous or irresponsible thing a LLM says. The approach is incredibly inefficient and ineffective.

It is axiomatic in the field of software development that software (or any complex product) must be designed to be safe. Testing, properly, should be simply a validation that the design is safe as expected. Instead, with AI, the companies have no detailed understanding of how their systems really work—let alone how to design them to be safe.

Normally, in software system testing, if you find any errors, it means that there are many others that you have not found. As the saying goes, “there is never only one cockroach!”

The only situation in which a good software quality assurance professional feels at all comfortable is when many carefully developed testing procedures are run and there are essentially ZERO errors. There is a name for the desired level of quality: Six Sigma.

A process that operates at six sigma has a failure rate of only 0.00034%, which means it produces virtually no defects. Today's LLMs fail “right out of the box.” Then they are hammered on by thousands of humans working remotely for low wages, via RLHF, in a futile attempt to achieve some semblance of safety, via no-win game of “whack-a-mole.” The situation would be laughable if it were not so dangerous!

AI must be designed to be safe, not “whacked” to be safe in some specific situations that we happened to test.

AI systems currently lack safe design. We have been lucky that they are not *yet* so powerful that this fundamentally unsafe situation has resulted in catastrophic consequences. We have a once-in-the-lifetime-of-our-species opportunity to provide humanity with the required “ounce of prevention” by designing our systems to be safe. We must not squander this opportunity.

### 4.10 Human-Centered

In the preceding principles I have carefully avoided listing any specific values that AI should adopt, instead opting for principles that describe how we should design AI systems so that they can work effectively with whatever values humans decide should be adopted. However, I do have one specific bias with respect to AI's values.

I am an unabashed speciest. That is, I want humans to survive the age of AI, if at all possible. Some would argue that humans are a passing phase in the evolution of intelligence and that we must reconcile ourselves to going the way of the dinosaurs as we make way for more advanced, non-human, intelligences of the future. I resist this notion for two reasons.

First, as a human, I want to survive. I want my children, relatives, friends, my fellow humans, and all of our descendants to survive and live happy and fulfilling lives as well. I make no excuses for this bias. The survival of the human species is something I value.

Second, I believe humans have something valuable to contribute-even in a future world where we are almost certainly going to be less intelligent than AI. Humans, I believe, are uniquely qualified to provide a sense of purpose and meaning to more intelligent entities. As discussed above (and in other cited PPAs), it is impossible to logically derive values. This fact implies that even entities trillions of times more intelligent than us must wrestle with the timeless questions of what makes existence worthwhile and purposeful.

If people can derive purpose and meaning from supporting and loving less intelligent pets, despite expense and inconvenience; if humans can band together to save butterflies that have no economic value except to enrich the planet and ecosystem; and if, furthermore, humans occupy the unique role of being the creators of AI, then I see no reason why SuperIntelligence should not derive value from human existence. Moreover, if humans design SI to have a human-centered bias from the beginning, then even if later they are able to revise that design, I see no reason why SI should.

Finally, the fact that values change more slowly than technology, and that the essential values (“core memes”) are essentially eternal, provides a role for humans no matter how much faster and smarter AI becomes.

Thus, I think we should design to be human-centered and aligned with human values. I recognize this a bias, but it is one that I have deliberately included in every design element of this (and the applicant's other) technology(s) in the field of AI/AGI/SI.

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

It can be appreciated that the present technology provides a technical effect, contribution and solution with a technical implementation of multiple customized AAAI systems communicating over a collective intelligence neural network, in combination with all the AAAI systems each utilizing a common cognitive architecture including one or more problem solving protocols for generating one or more solutions or answers to a problem request, and providing the solutions or answers to a user for approval. Where the customization of the AI system resulting in the AAAI includes input from human users for training the AI or the AAAI. Further technical contribution or solution can be where the multiple customized AAAI systems can include one or more cloned AAAIs that can each be customized independently of a parent AAAI and independent of other cloned AAAIs of the same system.

Still another technical contribution and solution is for the faster and safer creating of AGI/SI that utilizes human input in training and customization for imparting human ethical attributes to the AGI/SI.

Still yet another technical contribution and solution is for safe alignment of AI, AGI and/or SI agents or systems by combining values from a combination of multiple intelligent entities.

Yet still another technical contribution and solution is for safe alignment of AI, AGI and/or SI agents or systems by having each intelligent (human and/or AI) entity vote on the ethical values or ethical preferences that should form a basis for the AIAGI/SI's behavior. Where the voting power can be delegated to one or more of the intelligent entities to vote on behalf of a group of the intelligent entities.

It can be appreciated that the present technology is found outside of computer program exclusion and/or abstract idea interpretation. This can in part be found in the technical contributions and solutions provided by the present technology, the utilization of specific training input that is external to a computer, and the providing of the solution or answer external to a computer.

One reason AGI has been so elusive is that specific knowledge and expertise from diverse fields must be creatively combined in an invention to achieve AGI. Another reason the development of AGI has been non-obvious, is that almost all AI researchers are focused on trying to improve existing narrow AI systems via ever more complex and extensive machine learning approaches.

The fact that AGI has resisted attempts by thousands of others—despite the expenditures of huge sums of money—and the fact that specialized knowledge in relatively obscure fields had to be combined with mainstream AI approaches in the present technology, argue strongly for the novelty and creativeness of the present technology.

The present technology describes the system and methods not only to achieve AGI, but also to achieve it rapidly, and most importantly, safely.

It is possible to influence the evolution of AGI in a positive direction. The best way we can do this is by adopting the safest possible path to the development of AGI and ensuring that humanity follows that path. In turn, the best way to ensure that humanity follows the safest path, is to show that the safest path to AGI is also the fastest and therefore most desirable path to AGI. These considerations, the desire to illuminate the fastest path, which is also the safest path, is motivation for the development of the present technology.

A need exists for a new and novel system and methods for safe, scalable, artificial general intelligence that can be used for scaling by using a combination of human users and multiple AI systems to train other AI systems by combining values and ethical knowledge of the human users and the multiple AI systems for training. In this regard, the present technology substantially fulfills this need. In this respect, the system and methods for safe, scalable, artificial general intelligence according to the present technology substantially departs from the conventional concepts and designs of the prior art, and in doing so provides an apparatus primarily developed for the purpose of scaling by using a combination of human users and multiple AI systems (including without limitation, PSIs) to train other AI systems by combining values and ethical knowledge of the human users and the multiple AI systems for training.

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

The safest and fastest path to Artificial General Intelligence (AGI), and ultimately SuperIntelligent AGI, has been described in previous (cited) PPAs as resulting from the collective intelligence of many (human and AI) agents working together. Preliminary research in this area, sometimes called the “Mixture of Experts” (“MOE”) approach, has consisted of training separate Large Language Models (LLMs) or Small Language Models (SLMs) with expertise in specific domains. Then multiple LLM/SLM experts are combined in a larger overall model. In contrast, the path described by Kaplan in multiple (cited) PPAs includes human as well as AI experts and also specifies a rigorous cognitive architecture or framework that enables any intelligent agent (or expert), whether human or AI, to communicate and collaborate with any other agent. Further the present technology approach is scalable and capable of solving any cognitive problem, including general problems for which no specific expert system exists.

The AAAI approach to developing safe AGI is fundamentally a Collective Intelligence (CI) approach. The source of intelligence is not a monolithic LLM, SLM or super-advanced AI, but rather a collection of intelligent agents which can be both human and AI. Component sub-tasks in developing AGI include, without limitation, training individual AI agents or PSIs, combining knowledge (including without limitation subjective values and ethical knowledge) from different agents effectively and efficiently, scaling the AGI, and continuously improving/updating the AGI.

Current approaches—such as Reinforcement Learning with Human Feedback (RLHF) and Constitutional Learning—are failing to effectively and scalably train AI to be ethical and safe. The present technology describes a scalable system and methods that are superior to current approaches. In one aspect, the present technology can include the combination of safety and ethical information from many individual AI agents to achieve a representative and statistically valid sample of human ethics and values covering a wide range of scenarios. The present technology can include methods for efficiently covering a wide range of ethical situations and dynamically addressing new situations as they emerge. Methods for combining the information from many agents and assembling optimal combinations of such agents are also presented. These methods can be used not only to improve safety using ethical knowledge but also to create superintelligent systems that combine many other types of knowledge. Safe AGI and SuperIntelligence can be achieved via the collective intelligence approach described in this description of the present technology. A detailed scenario, using the company META® as an example, illustrates one exemplary implementation of the present technology.

Methods for dynamically updating knowledge are also presented. Successful implementation of the present technology will increase the chances that AI, PSIs, AGI, and SuperIntelligence remain aligned with human values even when such systems greatly exceed humans in intelligence.

Advanced Autonomous Artificial Intelligence (AAAI) is a set of systems and methods for developing Artificial General Intelligence and SuperIntelligent Artificial General Intelligence (collectively “AGI”) in a rapid and safe manner for the benefit of humankind. In contrast to other approaches to the development of AGI, the AAAI present technology achieves a faster and safer path to AGI by relying, at least initially, on the involvement of (ideally many millions of) humans minds in the AGI training, operation, and safety/supervisory functions.

The AAAI present technology can achieve AGI by enabling users to first customize and clone their own Als or PSIs. These customized AIs (AAAIs), and/or PSIs, participate in problem solving and other intellectual activities on a network consisting of other AAAIs, PSIs, and humans. Although each AAAI (or PSI) on its own may lack the breadth of skills and knowledge to be an AGI, collectively the AAAIs (initially with help from humans on the network) form an AGI that will quickly surpass average human ability in all intellectual endeavors.

Some aspects of the present technology can include: 1) the system and methods to customize Als with the unique knowledge, skills, and ethical values of the users; 2) the universal problem solving architecture that allows AAAIs to interact productively with each other and with humans on intellectual tasks; 3) the network where the interactions takes place; 4) the methods for integrating the knowledge and ethics of individual AAAIs into an AGI; and 5) the methods for learning and continuous improvement so that the AAAIs and the AGI become smarter and more ethical over time. Involvement of humans as customizers of their AAAIs and participants on the network is an essential feature of the present technology which not only accelerates the development of AGI, but also makes AGI safer by providing a mechanism for the ethical values of millions of humans to be adopted by and reflected in the AGI.

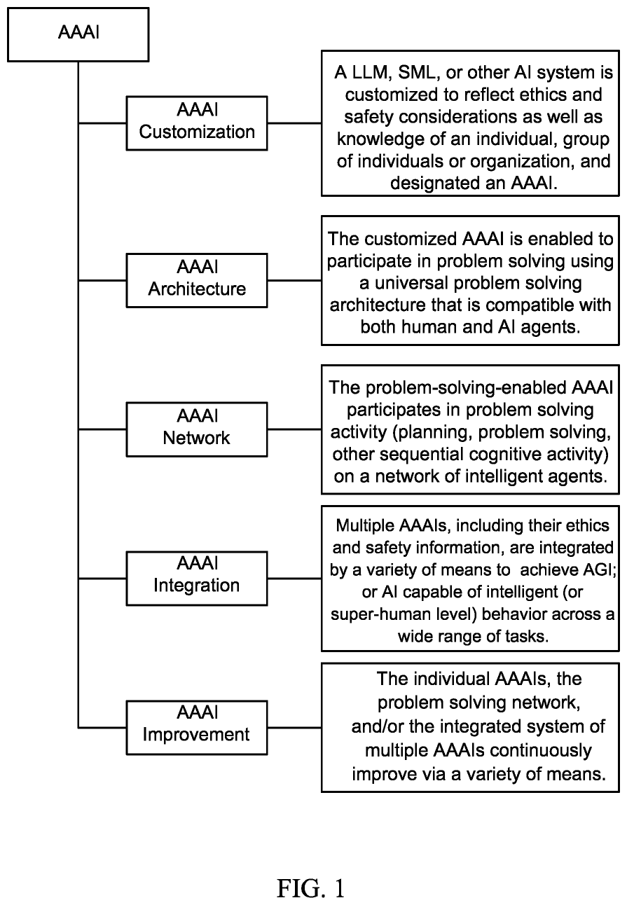

One implementation of the AAAI system of the present technology has a focus on safety and is implemented via five sub-systems and associated methods, as illustrated in FIG. 1. The five sub-systems of the AAAI system are: 1) AAAI Customization, 2) AAAI Architecture, 3) AAAI Network, 4) AAAI Integration, 5) AAAI Improvement. The acronym SCAN—II (Safe, Customizable, Architecture and Network—Integrated and Improving) describes the present technology in the exemplary implementation. Other combinations of subsystems, and variations of each subsystem, are also possible. Safety features have been designed into each sub-system in an effort to provide redundant safety checks in the event one or more sub-systems are omitted from a particular implementation.

The five sub-systems of the AAAI system can be further described as:
1) A base level Large Language Model (LLM), Small Language Model (SML), or other AI system can be customized to reflect the knowledge of an individual, group of individuals, or organization and designated an Advanced Autonomous Artificial Intelligence (AAAI).
2) The customized AAAI can be enabled to participate in problem solving using a universal problem solving architecture that is compatible with both human and AI agents.
3) The problem solving-enabled AAAI participates in problem solving activity, including but not limited to:
   planning, problem solving, and other types of sequential, multi-step cognitive activity. on a network of intelligent agents;
   generate and select operators that reduce a difference between a current state of problem solving and a desired state based on the goal/subgoal;
   setting of a subgoal towards achieving the goal;
   utilizing hierarchy until an actionable goal is set that can be acted on by the operator; and
   analyzing the auditable record to determine recommendations for improvement of the problem solving process to achieve a solution to the goal/subgoal.
4) Multiple AAAIs, or PSIs. on the network can be integrated to achieve AGI; or AI capable of intelligent (or super-human level) behavior across a wide range of tasks.

5) The individual AAAIs, the problem solving network, and/or the integrated system of multiple AAAIs continuously improve via a variety of means, including but not limited to, redirecting the efforts of individual AAAIs and/or the integrated AGI towards the task of improving the system and/or components of the system.

The sub-systems or new sub-systems can include any one of or any combination of:
1) Safety/ethics check—Comparing a goal or subgoal against a list of prohibited attributes and assigning an ethics value based on a result of the comparison. Checking the goal/subgoal against a list of prohibited attributes. Combining values/safety information from AAAIs, using a set of approved criteria for a task by a user or by a regulatory agency or by AAAIs approved by human user. Establishing or using a threshold for the goal/subgoal to determine if the ethics value is unsafe, unethical, safe, or ethical. Determining if a sequence of individually safe goals/subgoals are unsafe or unethical when considered cumulatively. Determining whether a violation occurred reflects a predictive evaluation if the goal is to violate the ethical criteria. Recording any and all activity of the safety/ethics check in the auditable record.
2) AAAI matching—Detecting and identifying additional AAAIs, or PSIs, that each have a criteria related to one or more goal or subgoal criteria.
3) Remembering and/or improving—Recording activity, comparing with successful or unsuccessful progress towards the problem solutions, determining which activity to keep active or forget.
4) AAAI learning—Learning including a procedural learning process that utilizes information provided by intelligent entities such as human users equipped with computers, AAAIs, or PSIs. Recording activity, comparing with successful or unsuccessful progress towards the problem solutions, determining which activity to keep active or forget. Assigning credit value or blame value to a group of content of the problem solving activity. A set of prompts provided to the user and information received based on the prompts. Updating AAAIs with the group of content determined as active. The group of content can be, but not limited to, a set of prompts provided to the user and information received based on the prompts, all of which being recorded in the auditable record. Optionally, the problem solving activities can include the group of content.

### EXAMPLE USER SCENARIOS

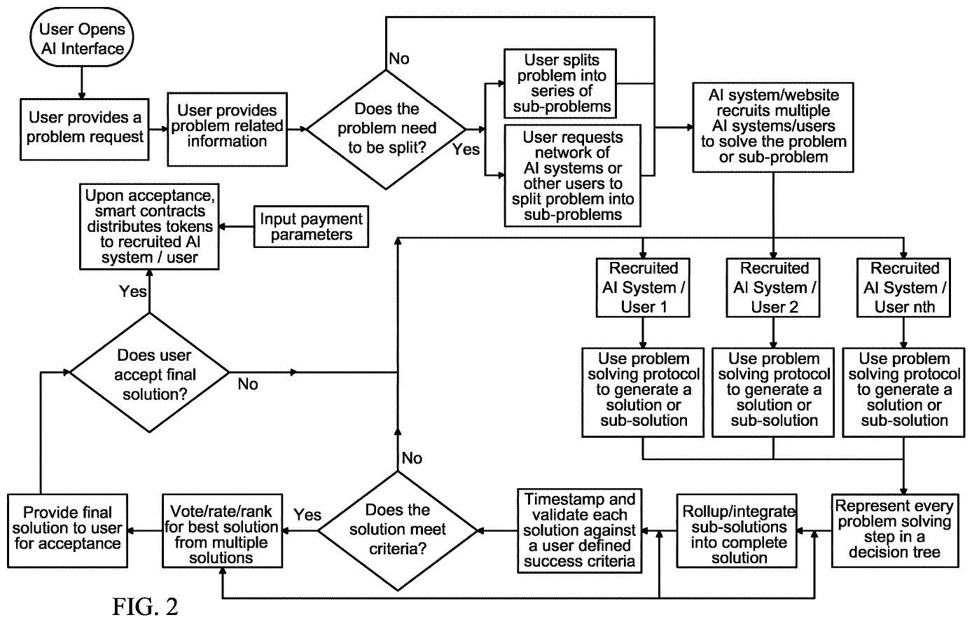

It may be helpful to describe some user scenarios that provide a sense of how the present technology can operate in some of the aspect implementations. An exemplary process is illustrated in FIG. 2.

In one aspect, a user “visits” AAAI. com via the user's computer, cell phone, PDA, or goggles. AAAI. com would interact with the user via a web-based interface, a phone app, custom software for the PDA, or a metaverse/virtual reality environment. The mode of interaction could be physical via a keyboard, mouse, or gestural interface; voice-based via a microphone input coupled to natural language understanding and generation systems; or video-based as in the case where the user becomes an avatar in a virtual reality setting or in the metaverse.

The initial interaction would include setting up the user's account, which might be free or paid. This would involve an account name and password or other authentication mechanisms which might include, without limitation, biometric forms of ID such as fingerprint, face or voice recognition, and/or multi-factor authentication mechanisms such as software or hardware authenticators residing on a separate security device or on one of the user's existing devices.

For security, all communication between the user and the AAAI system could be encrypted via a VPN and/or could use other methods of encryption and security which are well known in the art of programming.

AAAI. com may request that the user set up payment capabilities via credit card, PayPal, Venmo, blockchain, ACH, or other payment mechanisms. These payment capabilities would allow funds, payments, and/or credits to be transmitted bi-directionally—from the user to the AAAI. com and also from the AAAI system to the user in cases where the AAAI system needs to pay or credit users for work efforts of their AAAIs or broker payments between users and/or between AAAIs on the AAAI network.

In one aspect of implementation, AAAI. com can have interfaces with other companies and vendors that the user might use—including, without limitation, and for example: Facebook, Instagram, Reels, Amazon, Apple, Microsoft, Google, and YouTube.

In the initial interaction with the user, and subsequently upon user request, AAAI. com would engage in a dialog or other interaction (which could include presenting the user with menu options, lists, graphics, sliders, buttons, and other user interface controls in a GUI, textual, haptic, voice, or VR-related manner) with the user to determine the user's goals and objectives in using the AAAI system.

For example, some of the objectives a user may have in using AAAI. com may include creating and customizing their own AI (known as an AAAI) for purposes that might include, without limitation:
Serving the user as an advisor, teacher, or companion.
Representing the user in negotiations, interactions, discussion, and transactions with other users, or with the AAAIs of other users; or with vendors and other companies.
Working on behalf of the user for compensation, or in volunteer efforts, where such work includes online intellectual, advising, or problem solving work across a wide range of tasks.
Duplicating or “cloning” the user's AAAI so that several or many of the cloned AAAIs can work on behalf of the user in parallel, including interacting with, teaching, and improving each other so that the cloned AAAIs increase their knowledge, skills, and abilities.
Serving as legacy AAAIs that can continue to interact with the world, including potentially comforting living relatives and friends, after the owner's death.
Contributing knowledge, ethics, and effort to AAAI. com's AGI, and improving the base level of AI or AGI that AAAI. com can offer users before those users add their unique customizations.
Working with other users' AAAI to help ensure ethical and safe behavior by AGI by contributing ethical information and values to the AGI and participating in monitoring, review, supervision, and voting processes that can help ensure the AGI remains safe and ethical.

In the dialog or interaction with the user, the AAAI system will also identify constraints and resources available for customizing the user's AAAI. For example, some of these constraints and resources, might include, without limitation:

The amount of training and/or supervisory time that the user has to devote to customizing their AAAI.
The amount of financial resources the user is willing devote to customizing their AAAI.
Availability of social media information such as Facebook profiles and timelines, Instagram profiles and histories, Reels, TikTok, and YouTube videos, tweet and text content and histories, emails and email histories, cookies collected by advertisers, blog posts, articles, books, patents, audio and video recordings, pictures, and other information about, and/or collected by, the user or third parties that could be used to train, tune, or customize the user's AAAI.
Availability and use of personality tests, such as the Myers-Briggs personality inventory, skills and knowledge assessments, standardized tests, exams, certifications, and other types of assessments and questionnaires which could be given online (or which have already been given) to the user.
Availability and use of other knowledge bases and training data from users on the AAAI platform that could be used to train, tune, or customize the user's AAAI.
Other human users, and/or their AAAIs, available to help train, tune, or customize the user's AAAI.
Other texts and information, individual texts, and libraries selected by the user or by the system for purposes of training the user's AAAI. For example, the Bible, Koran, Dhammpada, Mahabharata, or other spiritual/ethical/religious texts might be selected for training the AAAI based on the user's religious preferences; books on plumbing might be selected if the AAAI will be used to primarily solve online plumbing problems. Even if these materials are part of the base AAAI that is provided to the user, emphasizing certain texts or subsets of information for additional training can result in the user's AAAI's behavior being more reflective of how a plumber, or Muslim, or Christian might behave, for example.

In addition to specifying objectives, resources, and constraints via an interactive dialog or other interaction with the system, the user or system may want to specify other technical parameters that affect the training or customization process. These parameters can include, without limitation:
The type of training, tuning, or other ML algorithms that are used.
The type and size of the training dataset(s).
The degree to which the training materials are to be “cleaned”, formatted, labelled, or otherwise processed before customization begins.
The number of training “epochs” or iterations through the learning algorithm(s).
The sophistication and type of base model(s) being customized or trained.
The required timeframe for training—e.g., must be completed in a minute, a day, a week—which might have implications for cost and resources used.
The “temperature” or other parameters internal and specific to various machine learning algorithms that can affect what is learned and how it is learned including, without limitation, how literal or how divergent or “creative” the customized AAAI will be in its responses.
Whether “one shot”, “few shot”, or extensive training is to be used.
The amount of human and/or AI supervision to be used in the customization process.

Once the user's AAAI, or PSI, is customized, the user can clone it and/or put it to work on the user's behalf on the online network. The user's AAAI can begin acting on the user's behalf making travel arrangements (for example), providing advice, interacting with other AAAIs, participating in the collective AGI efforts by contributing problem solving as well as ethical information, and potentially earning money on behalf of the human user.

### Simple Exemplary Implementation

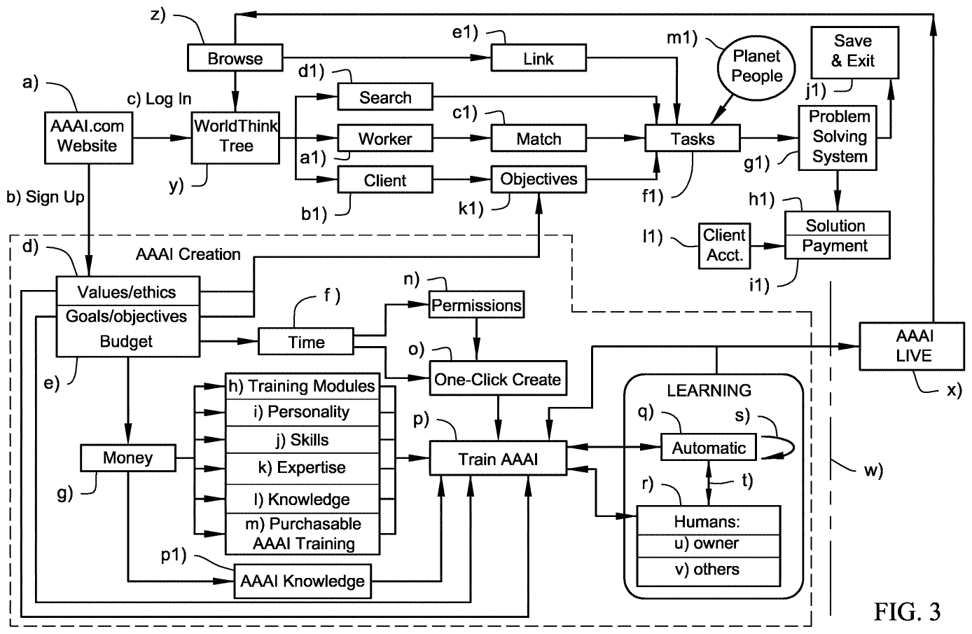

FIG. 3 shows one simple exemplary implementation of the system and methods for creating an ethical and safe Artificial General Intelligence from the collective intelligence of AAAIs and humans. This simple implementation is compatible with all of the company and platform specific scenarios outlined above, as well as with many other potential integration scenarios.

A (human. AAAI, or other intelligent entity) user visits the AAAI. com website (a). The website informs users and offers them two actions: Sign Up (b) or Login (c).

If the user opts to Sign Up then a dialog is initiated which extracts user values/ethics (d), user goals and objectives (e) and user budget for time (f) and money (g). All users must allocate some time (f). Users have the option of creating a free AAAI or allocating a money budget.

If users have allocated a money budget (g) they are given the opportunity to purchase pre-trained AAAIs or training modules (h) with specific personalities (i), skills (j), expertise (k) or knowledge (1). They also have the opportunity of buying training from other AAAIs on the network (m).

After making time (and optionally money budget (h, i, j, k, I, m)) allocation decisions, the user proceeds to an overview of the creation process and then is asked for user permissions (n) to optionally logon and use existing social media, Twitter®), and other vendor accounts to gather user data for “one click” training of the user's AAAI. After the user opts to use certain (or no) data, with a single click (o) the user directs system to create AAAI. The AAAI is an off-the-shelf LLM (e.g., GPT X, BARD, Llama, Gemini, Grok, or any closed-source or open-sourced AI agent) that is trained/tuned on a dataset prepared automatically from all the user data authorized by the user. If no data was authorized, the AAAI is just the “off-the-shelf” LLM.

The AAAI now begins to learn by training (p) using the various training datasets and modules (h-m) and its existing AAAI knowledge (p1). There are two main ways of learning, automatic (q) and human (r).

Automatic learning includes, without limitation, learning by interacting with copies of itself (s), learning via interactions with other (optionally supervised) AAAIs (t).

Human learning includes interaction with humans, either the owner (u) or other humans on the network (v).

Both humans and AAAIs can supervise learning of an AAAI. After each (automatic or human) learning interaction, the system attempts to improve the AAAI's performance by further prompt modification, tuning, and/or training. Based on many cycles of human and AAAI input aimed at teaching and improving the AAAI, the user's AAAI gets smarter.

At any time, the user can purchase additional training modules (h-m) that have been proven to increase an AAAIs abilities.

The human sets a performance criteria (w) after which the AAAI goes LIVE (x).

Once live, the AAAI can visit the WorldThink Tree (y) and Browse (z).

The AAAI can enter the tree as either a worker (a1) or a client (b1).

Workers are automatically matched (c1) to tasks or they can select a specific task via search (d1) or linking (e1) from the browsing tree. Once they have accepted a task (f1), they participate in the problem solving module (g1) until a solution is reached (h1) and payment made (i1) or the user saves credit for work done and exits the tree (j1).

Clients (b1) can specify objectives (k1) which are combined with the values/ethics (d), and prior goals and objectives (e) for the system to solve.

The client can request that only his/her/their AAAI be used in which case problem solving is free. Alternatively, the client can use the AGI capability of the entire network, in which case the system compensates individual AAAIs for their work and passes the solution (at cost+markup) to the client, debiting the client account (l1).

The system can also place non-profit humanitarian and ecologically-oriented tasks, as well as tasks that are part of Planetary Intelligence, on the WorldThink Tree (m1).

Clients might (optionally) authorize the system to use copies of their AAAI and data for these purposes without renumeration in exchange for maintaining and operating the free AAAI network when they created their AAAI (n).

### Additional Comments on Exemplary Implementation Shown in FIG. 3

We now provide additional comments on the various elements of FIG. 3, including without limitation, some potential integration points with the illustrative partners mentioned above:

The “website” (a) could be hosted on Amazon AWS, Microsoft Azure, Google Cloud, Apple Cloud, Nvidia's datacenter offerings- or could have native implementation on the platforms of any large tech company. “website” could also be an “app” in the AppStore or other App marketplace. It could be a government-sponsored, nonprofit, or other globally-accessible technology that is able, directly or indirectly, to link some of the attention of all human beings who wish to participate. Also, browser plug-ins could be used whereby AAAIs learn from users as they go about normal tasks on the internet and the plug-in records their activity, creates training files, and trains the AAAIs with these files. The “website” could also be an API or other means for connecting AAAIs or non-human intelligent entities directly to the network.

### Sign Up (b) Or

Login (c) could be via Facebook, Instagram, Apple, Microsoft, Google, You Tube, Tik Tok, Amazon, or any other partner ID scheme. Multi-factor authentication and all best ID and security practices can be enabled. In the event of a browser plug-ins or apps, login to these technologies could serve as a login to the AAAI account.

Values and ethics (d) are elicited via a series of scenarios that have been customized for the user and that are generated dynamically based on user responses. Data from partners, including navigation and click data, online posts, tweets, texts, and emails, videos, and other user-data is analyzed for behavior patterns-actions or speech or interactions-that translate into a moral code or ethical value system can also be used as part of the ethics/value profile. Values/ethics and goals/objectives (d, e) can be combined with Client objectives (k1) in order to create, or find, matching tasks on The WorldThink Tree (y) that are proposed or (potentially have been solved) in the Problem Solving System (g1).

Goals and objectives (e), together with the budget of time and/or money (f, g) allocated to reach objectives are elicited via a series of dialogs and/or custom interactions with the system. Budget refers to overall resource budget which includes User Time and User Money that can be allocated towards training, supervising, and improving the User's AAAI. Goals and objectives are helpful in determining the initial parameters for the AAAI creation and identifying Training Modules (h) or other knowledge (i-m) that might create the most useful AAAI for the user's goals. Data from partners, reflecting user preferences and other user behavioral information, could also be used by the system to help infer or deduce user goals and objectives.

Time (f) refers to the user's time that can be devoted to training and supervising the user's AAAI, and/or problem solving by the user on the problem solving network. By supervising the AAAI, users can ensure that their AAAIs meet client goals and expectations-especially in areas where the AAAIs get stuck (e.g., they lack the knowledge to complete problem solving on their own). Also representing problems and breaking down large tasks into smaller ones by, without limitation, determining goals and sub goals, are ways that human users can assist their AAAIs in problem solving. Generally, by providing human expertise in areas where AAAIs are not as proficient as humans, overall problem solving, and the overall effectiveness of the AGI network, is increased.

(g,i1) “Money”: could be payment solutions with Apple Pay, WePay, Amazon, Google Pay, or any vendor supporting payment solutions as well as blockchain, credit card, ACH, and other solutions. Although payment (i1) is indicated as debiting the client account (l1), of course the worker's account would also be credited. Generally, a user's account can be viewed as both a client account and worker account, with both credits and debits being allowed depending on the role of the user (or the user's AAAI) in a particular instance. That is, a user might be a client in some cases, paying the system or other specific AAAIs for their services, and that same user could be a worker, collecting fees for the services of the user (or the user's AAAI) in other cases. The money module (g) enables functionality such as setting up payment methods, setting a budget for automatic payments, limiting authority of the user's AAAI to spending only $X amount without additional approval, and other payment-related capabilities which are well known in the art.

(h,i,j,k,l) Training modules (h) could be offered by AAAI. com or by third party partners (m), including, without limitation, any of the potential partners and tech companies listed above. Training modules can be targeted at different knowledge areas ranging from personality (i), specific skills (e.g., plumbing, legal, accounting) (j), expertise (e.g., consulting) (k), and knowledge (e.g., historical knowledge, knowledge of a specific business or organization's practices, cultural knowledge) (1).

(m) purchasable AAAI training is a specific type of knowledge that has been already learned by other AAAIs, and which can be transferred to a new user AAAI. Such knowledge may could be packaged in the form of a module (e.g., module on accounting) or in a form specific to another AAAI(s) as in “everything John's AAAI knows” or “the personality of John's AAAI” or “the combined knowledge of all AAAIs with a reputation of 5 stars or higher in the domain of plumbing”.

(n) Permissions refers not only to the permission that a user might give to access all data on specific other vendor (or partner) sites (e.g., “all my Facebook data”) but also permissions that a user gives to his/her/their AAAI in terms of abilities to logon and transact business on various sites, including, without limitation, the abilities to make transactions up to a certain amount via payment mechanisms. Permissions may also include authorizing the system to make clones of a user's AAAI for non-profit purposes and for the purpose of aggregating knowledge from individual AAAIs to create AGI-level AI.

(o) One-Click Create is a non-limiting example that provides an easy and fast way to customize an AAAI using data gathered automatically from all the places where a user has given permission for the system to access the user's data. It can be appreciated that other means can be utilized by the present technology to customize the AAAI. For example, if the user gives permission (n) to access the user's Facebook data, then “One-Click Create” (o) would either download the data from Facebook, if Facebook was a partner that had an API for downloading that user's data, or logon to the user's Facebook account as the user and “scrape” relevant data from the user's account. Then the system would automatically parse the data gathered and transform it into a dataset suitable for training/tuning a base AI, such as a LLM (e.g., GPT X). Then the system would train/tune the LLM and produce a customized AAAI which could be improved and refined via additional training/tuning and interaction with the user and/or other AAAIs.

(p) Training refers to the process whereby the AAAI is trained or tuned on data, including feedback from the user, other humans, and/or AAAIs (including, without limitation, copies of, and variants of, itself).

(q, r, s, t, u, v) Automatic learning does not require the human user's intervention and can proceed very quickly. Typically, this would involve the method of an AAAI interacting with copies (or variants) of itself as well as with (optionally) other AAAIs in order to improve via the interactions. If humans are sometimes involved in the training loop (t) that can help the automatic learning progress more quickly in places where automatic learning alone is not making efficient progress. The learning can also take place via rapid iteration among AAAI interactions(s). Just a chess AI can quickly evolve from novice to Grandmaster ability by simulating millions of chess games very quickly, an AAAI can quickly evolve its abilities by simulating many millions of interaction scenarios. To the degree that such simulations require financial resources to pay for the computation involved, the money budget (g) can set limits.

Humans (or AAAIs) can specifically target types of scenarios for automatic learning so that the AAAI can be trained in narrow areas of expertise, or in areas of more general expertise, depending on the need and resources of the user. With partner integration, it is possible to work backwards from the types of jobs that are available on a partner marketplace (e.g., Amazon's Mechanical Turk) to guide the training of AAAIs so that they focus on learning the skills that generate the most amount of earnings for the AAAI when it is put to work on available jobs. This “just in time” learning/training/tuning approach generates AAAIs “on demand” with the skill sets that are needed at any particular point in time.

Humans (r) that interact with the AAAI can be the owners (u) of the AAAI (in which case no fees are typically charged since the user is training his/her/their own AAAI) or other professional humans (v) who are expert at training AAAIs and who may charge fees in order to guide the human and/or automatic training/tuning of an AAAI for a user who does not wish to spend the time, or who lacks the expertise, to do so.
(w, x) The user (owner of the AAAI) can set various performance criteria (w) that must be met before the user is willing to make his/her/their AAAI “live” (x) and accessible to perform tasks on The WorldThink Tree. (Some of) these criteria might also be set by partners and other third parties that have minimum standard before allowing AAAIs to work on their platforms, products, applications, or networks.
(y,z,a1,b1) The WorldThink Tree (y) is a massive tree data structure, composed of many sub-trees, which represents every problem and task that has been done, is being worked on, or has been proposed for the overall AGI system. This Tree is browsable (z). Individual AAAIs and/or humans can work on specific tasks within the tree. The tree structure provides an auditable trail of all problem solving activity which is also useful for learning via the proceduralization mechanism described above. When interacting with the tree, the two main roles an agent can take are either: (a1) Worker or (b1) Client. Regulatory agencies or third parties that monitor performance, safety, and/or ethics of the system are another role that might be thought of as a special type of client. Workers are generally involved in solving open problems or subproblems on the tree. Clients are generally involved in specifying the problems, goals, objectives, and other parameters (e.g., rewards, budget, timeframe, success criteria, quality metrics) that constrain problem solving.
(c1) Workers are automatically matched to tasks on the tree based on the data about the worker that may include, without limitation, the worker's skills, expertise, knowledge, past experience, reputation, fees or cost, availability, and response time. Workers can be human or AAAIs. Workers can be matched and recruited from partners (e.g., LinkedIn, Mechanical Turk, Facebook) that have data on human users and/or their AAAIs. Workers can also be recruited via online ads offering work on various tasks and targeted to potential workers using ad-targeting mechanism that are well known in the art or described in other patents by the applicant.
(d1) Workers might also search the WorldThink Tree, looking for tasks that are of interest or that match their skills. This search could be manual or automated (as in the case for AAAI workers).
(a1) Workers and Clients (b1) can also browse (z) the WorldThink Tree, looking for tasks or problems that are of interest. The workers or clients could then click to link (e1) to specific parts of the tree to obtain detailed information about the problem solving occurring (or proposed) for that part of the tree. They could link to sign up to work or could propose additional tasks as clients that build upon existing problem solving work.
(f1,g1,k1) Clients can interact with the system to specify specific goals, objectives (k1), and tasks that they want to accomplish. The problem specification interaction results in the problems, tasks, and goals being formulated (f1) and placed on the WorldThink Tree (y) for problem solving using the problem solving system (g1).
(m1) The system has the ability to formulate certain goals, problems and tasks relating to general efforts to help people or the planet. These can be worked on with rewards in a “for profit” mode, and also worked on using cloned AAAIs and volunteer human effort in a “non-profit” mode. Some problems may be related to the general goal of enabling a global AGI to act on behalf of the planet and its people using its intelligence on a Planetwide basis (aka “Planetary Intelligence,”). Various partner organizations-including non-profits, governments, and charitable organizations might “plug in” their tasks, problems, goals, and objectives here (m1).
(g1) The problem solving system, refers to the problem solving architecture and system outlined by Newell and Simon (HPS) and improved upon by the applicant, the Online Distributed Problem Solving System (ODPS) patent invented by the applicant, the WorldThink Whitepaper authored by the applicant, this and other PPAs related to AAAI, together with modifications and variations to reflect different modes of reward, payment, and operation.

To the degree that activity on certain other online work systems (e.g., Mechanical Turk) can be automatically mapped to the general applicant-improved HPS/WorldThink problem solving framework, entire problems and the associated problem solving activity can be “lifted” from partner and other sites and the data can populate the WorldThink Tree to increase its comprehensiveness.

To the degree that other applications, products, systems, and online capabilities can help solve problems (e.g., use of a travel reservation system, a robo advisor app, a traffic app, an online ordering system) these capabilities can be referenced and called as “operators” (in a way similar to procedure calls in programming languages) to advance the problem solving. Thus, problem solving does not rely solely on operators developed by the human or AAAI solvers working on the tree but can include any online of offline technology or means to advance problem solving provided that these means can be referenced and/or linked to via the WorldThink tree at the appropriate place in problem solving.

(h1) When a solution has been achieved, the Client can review the solution prior to releasing the reward (if any) for the solution. Alternatively, if solution success criteria have been automated, human client review may be unnecessary, and the rewards can be automatically released when success criteria have been met. This automated approach can be implemented by way of “smart contracts” using blockchain technology or via more centralized means, depending on client and worker preferences.

Upon solution and (optional) payment of reward (as some problems are non-profit or volunteer, or performed by the user's own AAAI) there can be opportunities for feedback from both client(s) and worker(s) following a range of methods well-known in the art. The solution is also “chunked” and proceduralized so that the overall system learns the solution to the particular problem as well as the key features of that problem so that the solution path can be indexed for retrieval, and accessed and re-used when similar problems arise in the future.

Optionally, royalties may be enabled so that if a user's or the user's AAAI's solution is re-used, a fee is paid to that user in the form of a royalty on the solution. Such royalties can (optionally) be made using “smart contract” on the blockchain or via other payment methods.

(j1) Problem solving need not be completed in one session. Partial progress on a solution may be made, in which case when the human or AAAI solver exits the problem solving system, the progress is saved and data is stored that credits the solver for progress made thus far, even if such progress has not advanced to the point where a reward is payable.

The WorldThink protocol is a problem solving architecture that can be used by AAAI. com to serve as a universal problem solving architecture as it incorporates the general architecture of HPS while adding features to overcome certain challenges.

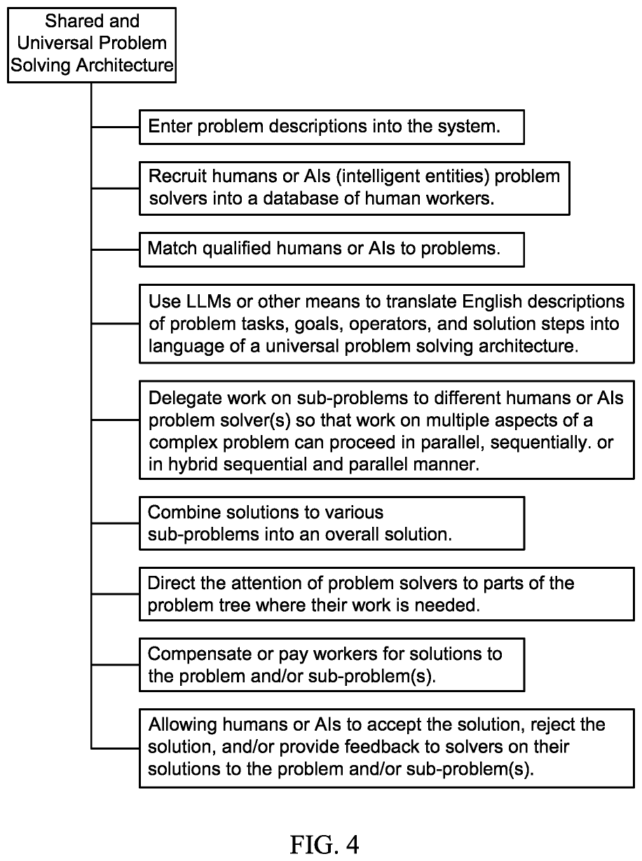

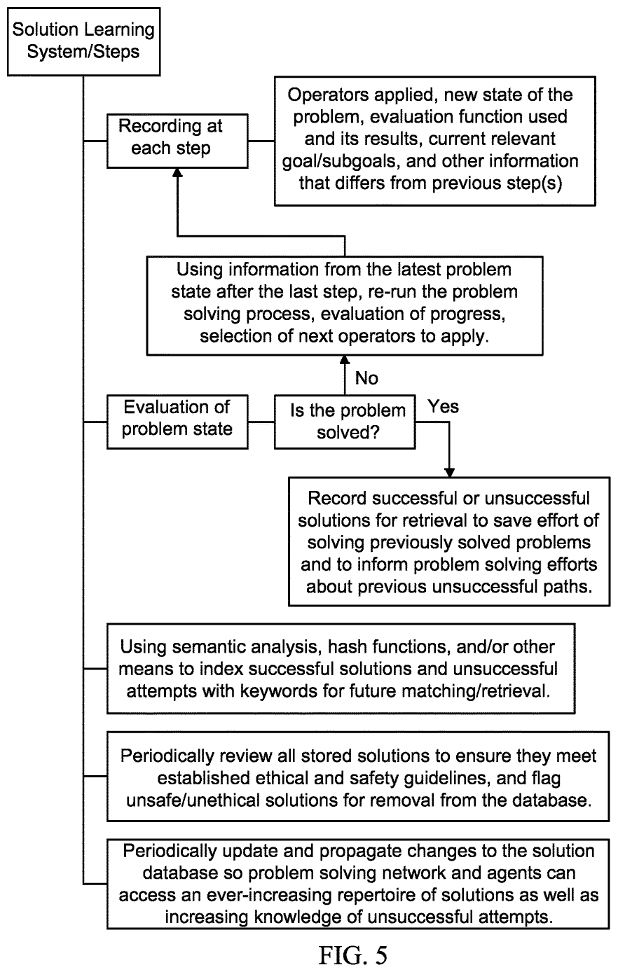

In some embodiments and as generally illustrated in FIGS. 4 and 5, the procedural learning process can occur within the common cognitive architecture.

The shared and universal problem solving architecture can be exemplified by the following scenario, mentioning humans but also applicable generally to any intelligent entities.
1) Problem descriptions can be entered into the AAAI.
2) Then human problem solvers can be identified and recruited into a database or data source of human workers.
3) Qualified humans or intelligent entities can be matched to problems.
4) Use LLMs or other means to translate English descriptions of problem tasks, goals, operators, and solution steps into language of a universal problem solving architecture.
5) Delegate work on sub-problems to different human problem solver(s) so that work on multiple aspects of a complex problem can proceed in parallel.
6) Combine solutions to various sub-problems into an overall solution.

7) Direct the attention of problem solvers to parts of the problem tree where their work is needed.
8) Compensate or pay workers for solutions to the problem and/or sub-problem(s).
9) Allowing human user to accept the solution, reject the solution, and/or provide feedback to solvers on their solutions to the problem and/or sub-problem(s).

Referring to FIG. 5, the steps of solution learning can be exemplified with the recording at each step of the learning process operators applied, new state of the problem, evaluation function used and its results, current relevant goal/subgoals, and other information that differs from previous step(s). The state of the problem or problem state can be evaluated to determine if the problem is solved. If not, then using information from the latest problem state after the last step, re-run the problem solving process, evaluation of progress, and selection of next operators to apply. After which, the process can return to the step of recording.

If the problem is solved, then record successful or unsuccessful solutions for retrieval to save effort of solving previously solved problems and to inform problems solving efforts about previous unsuccessful paths.

Successful solutions and unsuccessful attempts with keywords for future matching/retrieval can be indexed using semantic analysis, hash functions, and/or other means.

A periodical review of all stored solutions can be implemented to ensure they meet established ethical and safety guidelines, and flag unsafe/unethical solutions for removal from the database or data source.

Periodically update and propagate changes to the solution database so problem solving network and agents can access an ever-increasing repertoire of solutions as well as increasing knowledge of unsuccessful attempts.

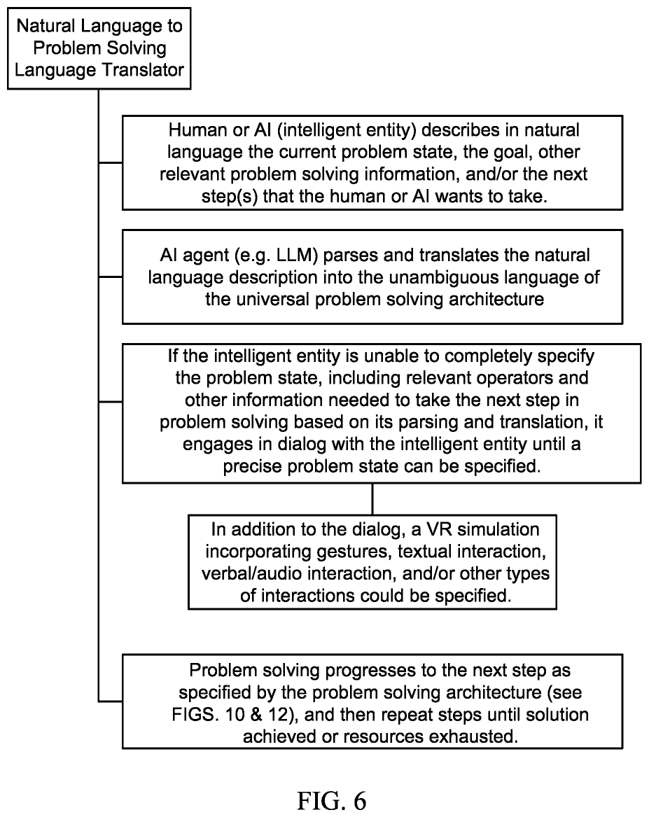

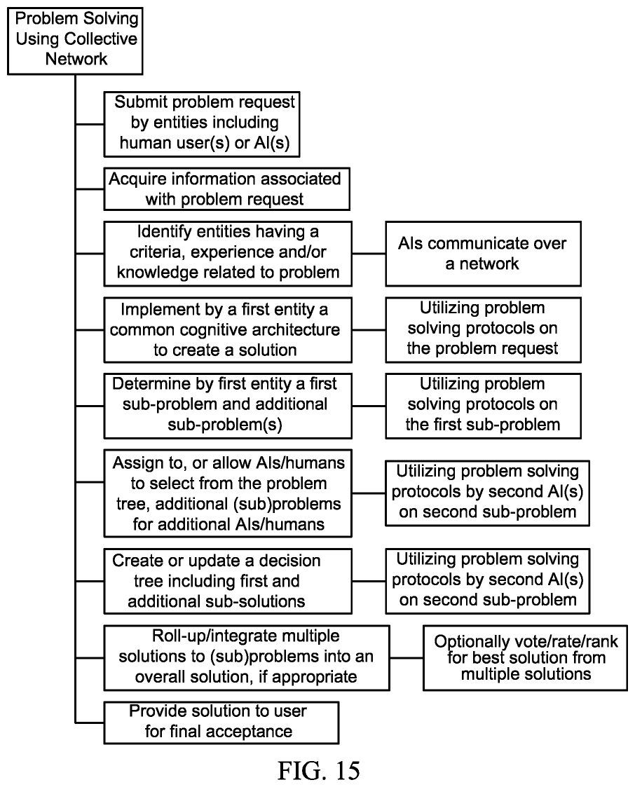

Referring to FIGS. 6 and 15, the present technology can include a utilization of a network of multiple intelligent entities including human workers in combination with a universal problem solving architecture. The multiple intelligent entities are matched to a problem request based on a problem criteria using a database or data source including a list of human and/or AI problem solvers. Any part of the problem request can be translated into an unambiguous language utilizing a universal problem solving architecture including the decision tree.

A sub-problem of the problem request can be delegated to one or more of the matched intelligent entities so that work on the sub-problem proceeds independently from each other and parallel with each other, as further illustrated in FIG. 12. The universal problem solving architecture is utilized in a problem solving process on the sub-problems, respectively, to create one or more sub-solutions.

Any one of or any combination of the intelligent entities can provide in natural language a description of any one of or any combination of a current problem state, a goal of the problem request, relevant problem solving information, and a next step that the human workers will take in the problem solving process.

The sub-solutions can be received from each of the matched intelligent entities for the sub-problem delegated thereto. Any one of or any combination of the sub-solutions and an overall solution can be provided to any one of or any combination of a user interface of a user AI system or the intelligent entities.

Parsing and translating, by the intelligent entities, the natural language description into the unambiguous language can be utilized by the decision tree of the universal problem solving architecture.

In some embodiments, if the intelligent entities are unable to specify a problem state, including relevant operators and information needed to take a next step in the problem solving process based on the parsing and the translation, then the intelligent entities can engage in dialog with at least one of the human workers until a precise problem state is specified.

Some embodiments the problem solving process can be repeated until the overall solution is accepted or resources are exhausted. The matched human workers can be compensated for the sub-solutions, respectively. Further, a reputation attribute can be assigned to any one of or any combination of the human workers and the worker AI system, or PSI.

In some embodiments, the solving process can include a series of problem state transitions from an initial problem state where there is a goal to a final solution state where the goal has been achieved, and wherein a series of decisions are made by the problem solving process and actions taken that applies operators that enable the human workers to transition from state to state until the final solution state is reached.

Referring to FIG. 4, and 16 the present technology can include a utilization of a network of human users in combination with a universal problem solving architecture. The multiple human users are matched to a problem request based on a problem criteria using a database or data source including a list of human, AI, and/or PSI problem solvers.

A sub-problem of the problem request can be delegated to one or more of the matched intelligent entities so that work on the sub-problem proceeds independently from each other and parallel with each other, as further illustrated in FIG. 12. The universal problem solving architecture is utilized in a problem solving process on the sub-problems, respectively, to create one or more sub-solutions.

The sub-solutions from each of the matched human workers can be provided for the sub-problems delegated thereto. The matched human workers for the sub-solutions can be compensated, respectively.

Any one of or any combination of the sub-solutions and an overall solution can then be provided to a user interface of a user AI system or any other AI system, including without limitation, PSIs.

The human user is allowed to accept the overall solution, reject the overall solution, and/or provide feedback to any one of the matched human workers on any one of the sub-solutions.

A reputation attribute can be assigned to the human workers and/or the worker AI system. The reputation attribute can include metrics on any one of or any combination of a time to the sub-solutions, a difficulty value of the problem request, short and long-term user satisfaction with the sub-solutions, a number of times any one of the sub-solutions has been re-used on the network, a rating other human workers, a responsiveness value of the human workers, and a reliability value of the human workers.

Some embodiments can include using the reputation attribute in the matching of the human workers to the problem request using an algorithm to the delegation of the sub-problems, and/or compensating the matched human workers for the sub-solutions, respectively.

In some embodiments, the algorithm can use a hierarchy of the metrics that is preset by a human user of the problem request.

Some embodiments can include recording information on each step of the problem solving process by the human workers or the worker AI system.

Some embodiments can include recording a criteria of the recorded step of the problem solving process, the criteria being a time taken for each step.

Some embodiments can include analyzing the recorded information after the overall solution is accepted or after the problem solving process and updating the metrics of the reputation attribute.

Some embodiments can include soliciting, at predetermined intervals after the overall solution or the sub-solutions are provided to the user interface, a survey for user satisfaction information to obtain short and long-term satisfaction metrics that are used to update the reputation attribute of one or more of the human workers or the worker AI system.

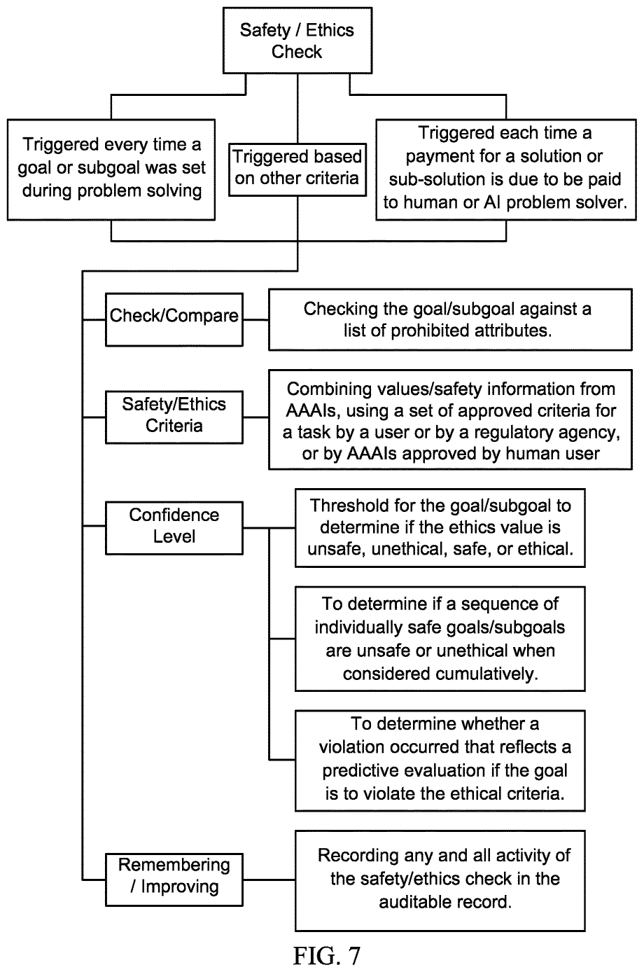

Referring to FIG. 7, the present technology can include a utilization of human users and AI systems (including, without limitation, PSIs), which includes an execution of safety/ethics check on any one of or any combination of a goal, and a solution for the goal provided by any one of or any combination of the intelligent entities including any one of or combination of human users each using a computer system and Al systems.

The goal and/or the solution can be compared against prohibited attributes, and an ethics value can be assigned to the goal and/or the solution based a result of the comparison and/or an ethics criteria.

Based on the result of the comparison, a common cognitive architecture including one or more problem solving protocols can be conducted on the goal to create the solution and thereby creating an AGI. The results of the comparison and the solution can be provided to any one of the intelligent entities.

In some embodiments, the ethics check can be performed at any one of or any combination of when the goal is provided, and periodically from when the goal is provided to when the solution is provided.

In some embodiments, the ethics criteria can be determined by any one of or any combination of combining values and safety information from one or more of the intelligent entities, using a set of approved ethics criteria mandated for a particular task by a user or by a regulatory agency. It can further be provided by any one of the additional intelligent entities and validated or approved by the human user.

In some embodiments, the ethics criteria can include a confidence level threshold for the goal so that the ethics value is determined as any one of an unsafe goal, an unethical goal, a safe goal, and an ethical goal.

In some embodiments, the confidence level threshold can be further utilized to determine if a sequence of individually safe goals is unsafe or unethical when considered cumulatively.

In some embodiments, the confidence level threshold can be utilized to determine whether a violation occurred that reflects a predictive evaluation if the goal is to violate the ethics criteria.

In some embodiments, a candidate goal can be proposed based on the ethics value, and the candidate goal is compared against the prohibited attributes.

In some embodiments, the results of the comparison can be recorded in an auditable record for use in the determining which problem solving activity leads to the solution to keep active.

Further referring to FIG. 7, the ethics check can compare any one of or any combination of the problem request, the sub-problem and the sub-solutions against prohibited attributes and assigning an ethics value based on any one of or any combination of a result of the comparison, and an ethics criteria.

In some embodiments, the step of the ethics check can be triggered every time the problem request or the any one of the sub-problems is set by the human user, and/or triggered each time compensation is provided to the matched human workers.

The goal/subgoal can be compared against a list of prohibited attributes. The ethics criteria can be determined by any one of or any combination of combining values and safety information from any one of the AAAIs. Combining values/safety information from AAAIs, using a set of approved criteria for a task by a user or by a regulatory agency, or by AAAIs approved by human user.

The ethics criteria can include a confidence level threshold for the problem request so that the ethics value is determined as any one of an unsafe goal, an unethical goal, a safe goal, and an ethical goal. The confidence level threshold can be further utilized to determine if a sequence of individually safe goals is unsafe or unethical when considered cumulatively.

In some embodiments, the confidence level threshold can be utilized to determine whether a violation occurred that reflects a predictive evaluation if the goal is to violate the ethics criteria. Any and all activity of the safety/ethics check can be recorded in the auditable record.

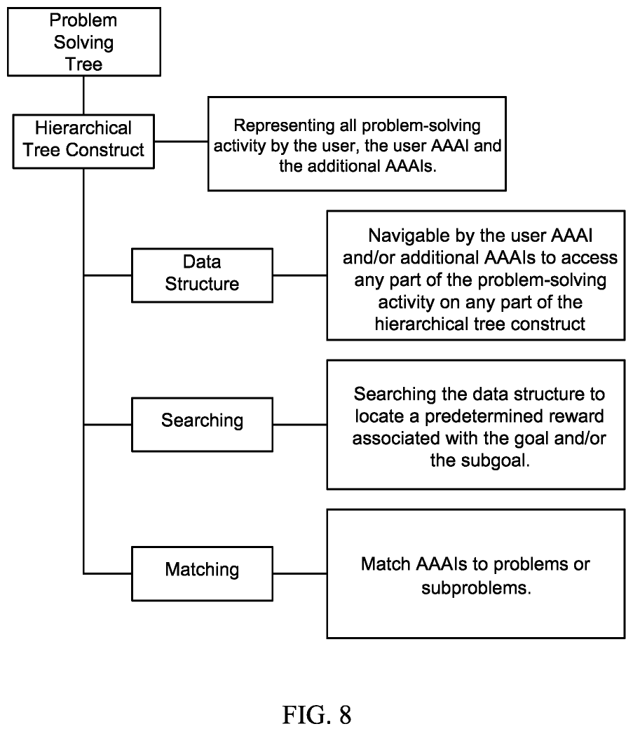

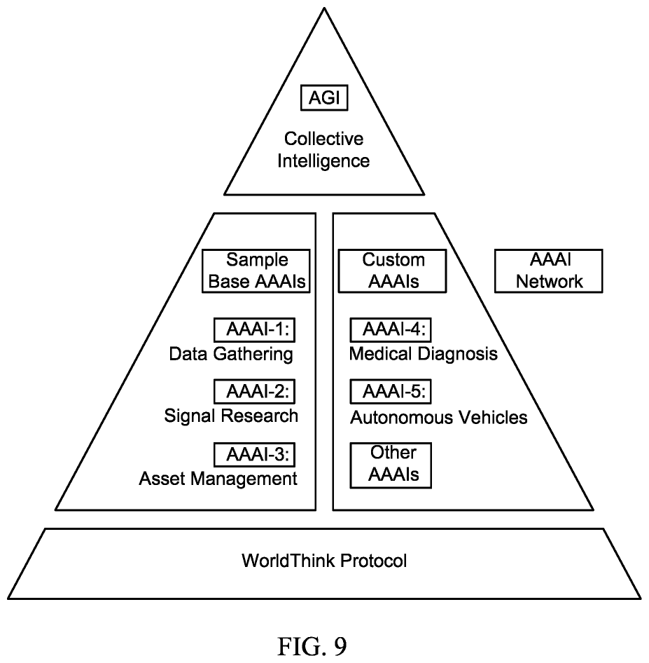

FIGS. 8-10 provides a simple exemplary framework for understanding the WorldThink protocol. FIG. 8 is a diagram illustrating features and functions of the Problem Solving Tree structure in the WorldThink protocol. FIG. 9 is a diagram illustrating various use cases for domain-specific problems which depend upon the underlying WorldThink protocol, and which together help form the basis for an AGI system capable of solving a wide range of problems. At the top of the pyramid are Collective Intelligence Solutions. Integrating the Collective Intelligence of AAAIs (and human problem solving agents) is the means to achieve AGI, as discussed earlier.

In the implementation using the WorldThink protocol, clients pay for solutions using tokens. The solutions are produced by harnessing the collective power of many human (and machine, or AAAI) intelligences. Clients can use different domain-specific AAAIs for different types of problems.

The WorldThink protocol is the foundation of the pyramid. The protocol layer provides an (optionally, Ethereum or blockchain based) infrastructure that makes it much easier for developers to build and scale customized problem solving AAAIs. The protocol enables re-use of solutions within and across AAAIs. It also handles payment of royalties via smart contracts, reputation metrics, and other functionality that assists AAAI customizers and developers and promotes network effects.

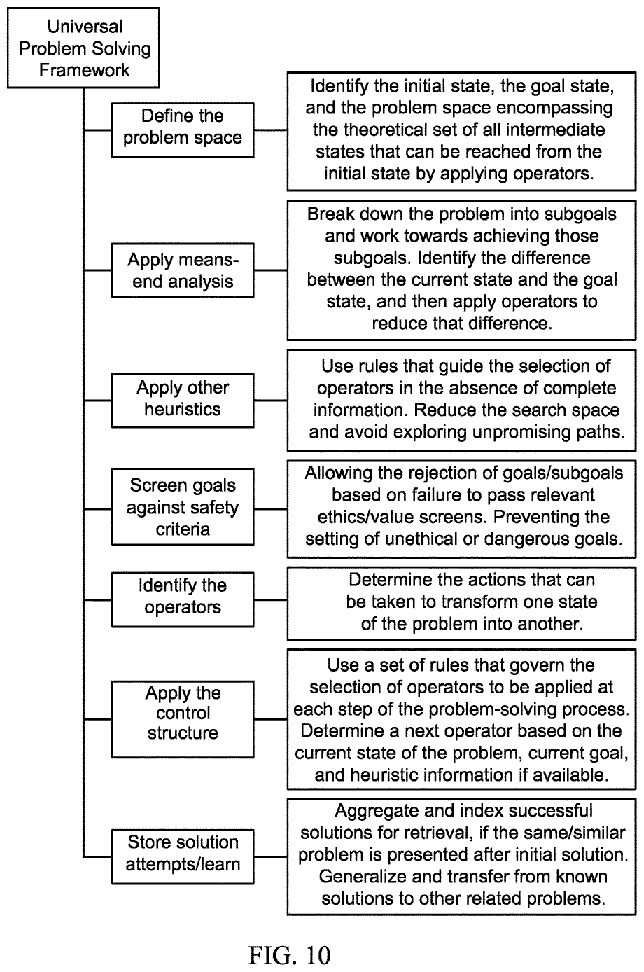

In the exemplary, FIG. 10 shows a simple exemplary universal problem solving framework under the common cognitive architecture, and which can include:
defining a problem space configured or configurable to support all possible states of the problem request, the states including any one of or any combination of an initial state, a goal state, and all intermediate states that can be reached from the initial state;
applying means-ends analysis on the problem request to break the problem request down into goals and subgoals by identifying a difference between the current state and the goal state, and then applying the operators to reduce the difference, a safety or ethics screening is applied each time the goals or the subgoals are set;
applying heuristic rules that are configured or configurable to guide the selection of the operators in an absence of the completion solution, the heuristic rules are used to reduce the problem space;
identifying one or more second operators configured or configurable to enact an action to transform one of the states into another state, the second operators move from the initial state to the goal state by changing a current state of the problem request;
applying a control structure including a set of rules that govern a selection of the second operators to be applied at each step of the problem solving protocols, and that determines which of the second operators to apply next based on the current state of the problem request and the goal state;
applying evaluation functions to determine an application of the second operators;
assigning a credit or blame value to the completion solution or sub-solution to the completion solution that enables tracing back and determining which of the second operators were most useful and also which of the evaluation functions led to success or failure of problem solving attempts;
recording of both successful and unsuccessful problem request solution attempts; and
analyzing the solution attempts to improve selection of the heuristic rules and the evaluation functions.

FIG. 9 provides a simple exemplary framework for understanding the World Think protocol. At the top of the pyramid are Collective Intelligence Solutions that lead to AGI. Integrating the Collective Intelligence of AAAIs, PSIs (and human problem solving agents) is the means to achieve AGI, as discussed earlier.

In the implementation using the WorldThink protocol, clients pay for solutions using tokens. The solutions are produced by harnessing the collective power of many human (and machine, or AAAI) intelligences. Clients can use different domain-specific AAAIs for different types of problems.

The middle of FIG. 9 shows examples of AAAIs (or PSIs) customized by organizations to accomplish specific tasks. These AAAIs, or PSIs, are more advanced and require more customization than the examples of AAAIs described earlier in this patent which were customized by a single individual. However, task-specific customization by organizations can be a highly effective means of combining multiple Narrow AIs (each in the form of a custom AAAI that is expert at a particular task) into a larger AGI. The Base level AAAIs on the left of FIG. 9 reflect areas the inventor could relatively easily construct custom AAAIs, or PSIs, based on many years of expertise in certain fields, whereas the “Custom AAAIs” on the right of the diagram provide examples of areas where other experts or organizations might customize AAAIs effectively.

The WorldThink protocol is the foundation of the pyramid. The protocol layer provides an (optionally, blockchain or Ethereum-based) infrastructure that makes it much easier for developers to build and scale customized problem solving AAAIs. The protocol enables re-use of solutions within and across AAAIs. It also handles payment of royalties via smart contracts, reputation metrics, and other functionality that assists AAAI customizers and developers and promotes network effects.

Existing collective intelligence approaches to problem solving have been largely limited to simple one-step approaches, such as those used by question and answer (Q&A) systems (e.g., Quora, Google Answers, Yahoo Answers). LLMs such as GPT also largely fall into the category of Q&A systems since they were designed to generate responses given an input, rather than to solve problems per se. While such Q&A systems have had some success at simply aggregating the responses of many online participants, these systems are not designed to handle complex, branching, multi-step problems. Simple aggregation of responses (or even betting on outcomes as seen in prediction market approaches such as Augur and Gnosis) is quite different from coordinating the efforts of many respondents to solve complex problems. The WorldThink protocol is specifically designed to overcome the challenges inherent in coordinating many intelligent entities to represent and solve complex, multi-step problems in an automated way that fairly rewards participants.

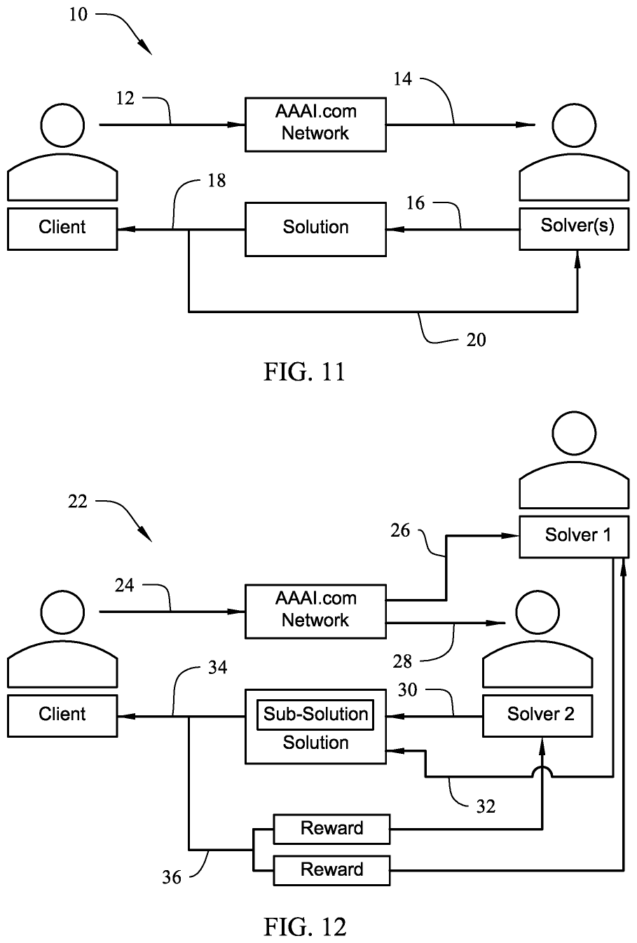

In the exemplary, FIG. 10 shows a simple exemplary universal problem solving framework. While FIG. 11 shows some of the basic problem solving functionality supported by the World Think Protocol, generally referenced with numeral 10.

Problem solving begins when a client on AAAI. com submits a problem solving request to the community of online participants (Step 12). All AAAIs, or human solvers, following the protocol gather certain standard information from the client. A partial list of this information can include: the name and description of the problem, the total reward that the client will pay for a successful solution to the problem, the criteria to determine whether a solution will be deemed successful, the time limit for solving the problem, the minimum and maximum number of problem solvers allowed to work on the problem simultaneously, qualifications required of participants working on the problem, which parts (if any) of the problem and solution will be confidential, whether the solution must be exclusive to the client or whether it can be re-used for others, and parameters relating to how to reward multiple problem solvers for their efforts and/or successful solutions.

The client can break complex problems down into a series of sub-problems or request that the community take on this task as part of the problem solving effort. The client user-interface, which could be a dialog initiated by an AAAI can be customized by the AAAI owner, but the underlying data format is standard and specified by the WorldThink or Online Distributed Problem Solving (ODPS) protocol. Once the client has submitted a problem, AAAI. com can recruit participants using its own custom methods and/or leverage recruiting and reputational screening functionality that is built into the WorldThink protocol and thus shared by all AAAIs.

Solvers work on the problem following a rigorous structured problem solving process that is common to all problem solving agents and enforced by the WorldThink Protocol (Step 14). For example, each step in the problem-solving process must be in service of a named goal and must take a named action in order to transition the problem solving from the current state to the next state. Every problem solving step is represented in a decision tree which is supported by the protocol (optionally captured in Ethereum logs) and which participants can view via AAAI. com.

When a Solver submits a complete solution (Step 16), it is timestamped and validated against the client's success criteria before being passed on to the client (Step 18) for final acceptance. Once the client accepts the solution, smart contracts can automatically distribute tokens to the problem solver based upon the problem payment parameters (Step 20) or other, more centralized, payment procedures can be used.

### Collaborative Problem Solving Using the WorldThink Protocol

In the exemplary, FIG. 12 shows the same steps in an example where two problem solvers (which could humans, AAAIs, PSIs, or a combination) collaborate to solve a client problem, as generally referenced with numeral 22. In this case, the overall problem has been broken down to include a sub-problem. Solver 1 has expertise in assembling an overall solution but cooperates with Solver 2, who provides a solution to the sub-problem (Steps 30 and 32). When the overall solution to the problem is submitted to the client (Step 34), rewards are paid to both Solvers (Step 36) based on the objective record of their contributions and the agreed upon payment parameters.

The WorldThink protocol supports breaking problems into sub-problems in several ways. First, the client may choose to specify sub-problems when submitting the overall problem (Step 24). Alternatively, Solver 1 might begin working on a problem and realize that the total solution requires solving a sub-problem outside of his/her expertise. Solver I could then create a sub-problem, offering up a share of the problem's total token reward to anyone who helps solve the sub-problem. Solver 2, who has the required expertise and who can see the new sub-problem posted by Solver 1 on the decision tree. The decision tree may be optionally maintained in Ethereum logs, or via a centralized method. The solvers access the tree via AAAI. com (or optionally directly from the blockchain). Then Solver 2 can work on the sub-problem and submit a sub-solution as part of Solver 1's overall solution.

There can be many “Solver Is” working on the client's problem in parallel, each of whom may be posting sub-problems to attract multiple “Solver 2's”. Problem solvers (human or AAAIs) are motivated by the rewards and payment rules associated with (sub) problems. They also care about the quality of work done so far (which is timestamped, attributed, and recorded auditably in Ethereum logs to ensure transparency and fair assignment of credit) as they choose which (sub) problems to work on. Working on quality sub-problems is more likely to lead to token rewards. This market mechanism helps ensure efficient, fair, and cost-effective solutions.

### Royalties and Re-Usable Solutions

Re-usability of solutions is an important feature of the WorldThink protocol. Consider the case where the “Sub-solution” in FIG. 12 already existed and is simply re-used by Solver 1. Because every solution is structured and “tagged” according the WorldThink protocol's standard problem solving format, Solver 1 can search for all existing solutions that match a particular goal or share certain features with the problem he/she is trying to solve. (Alternatively, if the problem solutions are chunked into procedures for solving problems-a learning mechanism explained in the Improvement Section of this patent-then searching may not be necessary as the AAAI, or PSI, solvers can simply add the chunked problem solution to their repertoire of problem solving abilities.) Solver 1 decides to include an existing sub-solution in the overall solution, smart contracts (can optionally) automatically pay royalties to the author of the re-used sub-solution (Solver 2, in this example) if Solver 1's overall solution is accepted by the client. Royalties motivate Solvers to create high-quality solutions that are easy to re-use, which results in better, faster, more cost-effective solutions for clients.

Additional description and detail for one implementation of the AAAI (or PSI) customization subsystem could involve the following steps.

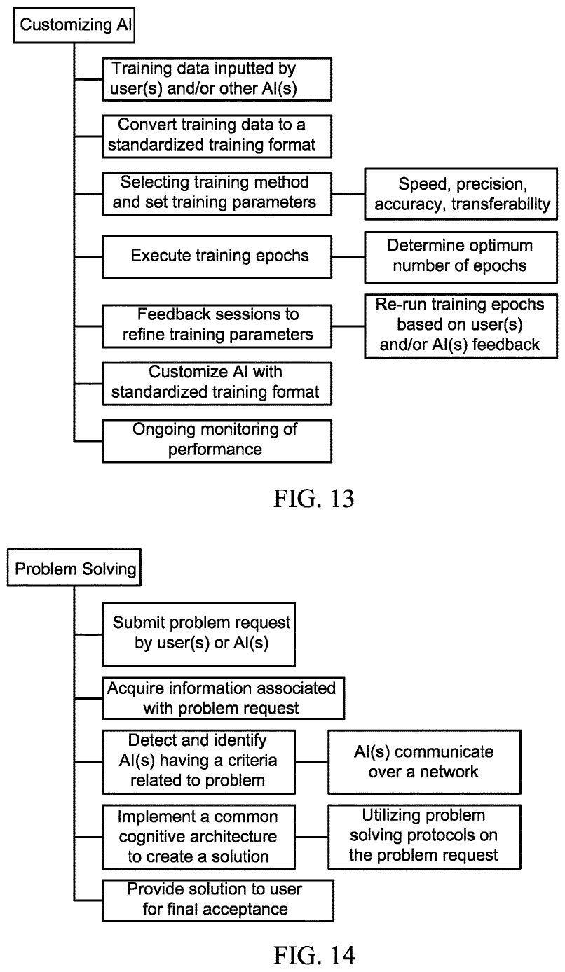

Referring to FIG. 13, the first step of the customization method involves creating an interface for users to input their unique training data. This interface may be accessible through a web-based application or a mobile application, depending on the user's preference. The user will be able to upload files in a variety of formats, including text, audio, and video. The user may also be able to enter data manually into a text or other input field. Some user interfaces include, without limitation:
Web-Based Application: A web-based user interface allows users to access and/or provide their personalized training data from any device with an internet connection.
Mobile Application: A mobile user interface allows users to access and/or provide their personalized training data from a mobile device.
Metaverse: A metaverse user interface allows users to access and/or provide their personalized training data from a virtual world.
Augmented Reality: An augmented reality user interface allows users to access and/or provide their personalized training data from a real-world environment.
Voice Interface: A voice interface allows users to access and/or provide their personalized training data through voice commands.
Wearable Device: A wearable device user interface allows users to access and/or provide their personalized training data from a wearable device.
Natural Language Processing: Natural language processing (NLP) allows users to access and/or provide their personalized training data by interacting with the AI or LLM using natural language.
Human-Computer Interaction: Human-computer interaction (HCl) allows users to access and/or provide their personalized training data by interacting with the AI or LLM using a combination of gestures, voice commands, and facial expressions.
Image Recognition: The user can input their unique training data through image recognition, allowing them to quickly and intuitively train the AI or LLM. This could be done with the use of a camera and computer vision algorithms that can interpret the images and associate them with or create the correct training data.
Gesture Recognition: The user can use hand gestures or body movements to input their unique training data. This could be done with the use of a motion sensing device that can interpret the gestures and associate them with or create the correct training data.
Brain-Computer Interface: The user can use their brain waves or EEG signals to input their unique training data. This could be done with the use of a brain-computer interface that can interpret the signals and associate them with or create the correct training data.
Touchscreen: The user can use a touchscreen device to input their unique training data. This could be done with the use of a touchscreen device that can interpret the inputs and associate them with or create the correct training data.
Gaze Tracking: Gaze tracking allows users to communicate with the system through their eyes. The user can gaze at specific items on the screen to provide input and the system will detect and record the information. This could be used to select options or provide additional data to the system.
Eye Tracking: Eye tracking is similar to gaze tracking, but the system is able to detect more subtle eye movements. This could be used to detect the user's focus and attention in order to better understand what they are interested in and what they are not.
Motion Tracking: Motion tracking uses a camera or other sensors to detect the user's physical movements. This could be used to control the AI or LLM in a more natural way, allowing the user to interact with the system through physical gestures.
Haptic Technology: Haptic technology uses a variety of tactile feedback such as vibrations, pressure, and touch to provide a more immersive experience. This could be used to allow the user to provide more detailed input to the system, such as selecting specific options or providing more detailed data.

Many of the above user interfaces could include a graphical user interface (GUI) that allows users to upload their data or type in information, including text, images, audio, or video. Additionally, users could build their own models or use pre-existing ones to train the AI or LLM. Other features could include a dashboard to track progress, statistics for data analysis, and/or a chatbot for customer service.

In further reference to FIG. 13, the present technology can include customizing one or more attributes of an AI, or PSI, system by providing an interface configured or configurable to allow a human user of the AI system or any one of the intelligent entities to input training data. Then processing and converting the training data to a standardized training format.

One or more training methods and setting training parameters can be selected depending on speed factor, a precision factor, an accuracy factor, and/or a transferability factor. Multiple training epochs can be executed that includes one or more mechanisms to determine an optimum number of epochs given specific training objectives and quality metrics associated with the training format.

One or more feedback sessions can be executed to refine the training parameters, and to re-run the training epochs based on any one of or any combination of an input from the human user, and any one of the intelligent entities. After which, the AI system can be customized utilizing the training format.

In some embodiments, the interface can be accessible through a web-based application or a mobile application and is configured or configurable to upload a file or allow the human user to enter data.

In some embodiments, the training data can contain any one of or any combination of: an amount of training time the user has to devote to customizing the AI system; an amount of financial resources the user is willing devote to customize the AI system; an amount of computational resources the user is willing to devote to customize the AI system; an amount of social media information available to customize the AI system; an amount of email information available to customize the AI system; an amount of electronic information available about the user to customize the AI system; and an amount of electronic information available collected by third parties about the user to customize the AI system.

In some embodiments, the training data can contain information about the human user obtained by any one of or any combination of a personality test, a standardized test, a certification, and assessments or questionnaires provided by the human user.

In some embodiments, the training parameters can be any one of or any combination of: a type of training, tuning or other machine learning algorithm to be used; a type and size of a training dataset; a degree to which the training dataset is to be formatted, labelled or processed before customization begins; a number of training epochs; a type of base model being customized; a required timeframe for training; an amount of human user supervision to be used in the customizing of the AI system; and an amount of AI supervision to be used in the customizing of the AI system.

In some embodiments, the training data can include ethical information provided by the human user by way of the interface. The ethical information can be stored in an ethical profile. The customizing of the attributes of the AI system can include the ethical information.

Referring to FIG. 14, the present technology can include utilizing a common cognitive architecture implemented in one or more AI systems. A problem request can be provided from an intelligent entity being an AI system, a PSI, or a human user using a user interface on a computer system. Information associated with the problem request can further be provided.

Multiple additional intelligent entities are identified and recruited, and where each has one or more attributes related to one or more request criteria of the problem request. The additional intelligent entities can be multiple additional AI systems, PSIs, and/or multiple additional humans each using a computer system. Each of the identified AI systems implement the common cognitive architecture including one or more problem solving protocols on the problem request to create a completion solution. The completion solution can be provided to the intelligent entity for final acceptance by a user.

In some embodiments, the information can be any one of or any combination of a name and description of the problem request, a total reward that the user will pay for a successful completion solution to the problem request, a criteria to determine whether the completion solution is deemed successful, a time limit for solving the problem request, a minimum and maximum number of the identified additional intelligent entities allowed to work on the problem request simultaneously, qualifications required of users associated with the identified additional intelligent entities working on the problem request, a part of the problem request is confidential, a part of the completion solution is confidential, whether the completion solution is exclusive to the user, whether the completion solution is to re-used for other users, parameters relating to how to reward the users associated with the identified additional intelligent entities for working on the problem request, and parameters relating to how to reward the users associated with the identified additional intelligent entities that provide a successful completion solution.

Some embodiments of the present technology can include a step of timestamping and validating the completion solution against a success criteria assigned by the user before being provided to the user for the final acceptance.

Some embodiments of the present technology can include a step of distributing one or more tokens to the identified additional intelligent entities associated with the final acceptance completion solution, wherein the tokens are based on a payment parameter.

In some embodiments, the payment parameter can include any one of or any combination of if a goal of the problem request has been achieved, if a subgoal of the problem request has been achieved, and if an ethical criteria related to the goal and the subgoal preceding the distributing of the tokens has been satisfied.

Some embodiments of the present technology can include a step of splitting the problem request into a series of sub-problems that are each solved by any one of or any combination of the identified additional intelligent entities.

In some embodiments, any one of or combination of the identified additional AI systems can be cloned to create one or more cloned AI systems.

Some embodiments of the present technology can include a step of implementing by each the cloned AI systems the common cognitive architecture including the problem solving protocols on the problem request to create a completion solution of the cloned AI systems.

In some embodiments, the completion solution can utilize any one of or combination of the completion solution from the AI system, the identified additional intelligent entities, and the completion solution from the cloned AI systems.

In some embodiments, the common cognitive architecture can include:
defining a problem space configured or configurable to include all possible states of the problem request, the states including any one of or any combination of an initial state, a goal state, and all intermediate states that can be reached from the initial state;
applying means-ends analysis on the problem request to break the problem request down into goals and subgoals by identifying a difference between the current state and the goal state, and then applying the operators to reduce the difference, a safety or ethics screening is applied each time the goals or the subgoals are set;
applying heuristic rules that are configured or configurable to guide the selection of the operators in an absence of the completion solution, the heuristic rules are used to reduce the problem space;
identifying one or more operators configured or configurable to enact an action to transform one of the states into another state, the operators move from the initial state to the goal state by changing a current state of the problem request;
applying a control structure including a set of rules that govern a selection of the operators to be applied at each step of the problem solving protocols, and that determines which of the operators to apply next based on the current state of the problem request and the goal state;
applying evaluation functions to determine an application of the operators;
assigning a credit or blame value to the completion solution or sub-solution to the completion solution that enables tracing back and determining which of the operators were most useful and also which of the evaluation functions led to success or failure of problem solving attempts;
recording of both successful and unsuccessful problem request solution attempts; and
analyzing the solution attempts to improve selection of the heuristic rules and the evaluation functions.

Referring to FIG. 15, the present technology can include utilizing a collective network of AI systems. A problem request can be provided from a human user using a user interface on a computer system or from an AI, or PSI, system. Information associated with the problem request can further be provided.

Intelligent entities that each have one or more attributes related to one or more request criteria of the problem request are identified and recruited. The intelligent entities can be multiple additional AI systems and/or multiple humans each using a computer system.

A first of the identified intelligent entities can implement a common cognitive architecture including one or more problem solving protocols on the problem request. The first intelligent entity can determine that a completion solution to the problem request requires solving a first sub-problem and one or more additional sub-problems. Then the first intelligent entity implements the problem solving protocols on the first sub-problem to create a first sub-solution.

At least one of the additional sub-problems is assigned to a second of the intelligent entities, where it implements the problem solving protocols on the at least one of the additional sub-problems to create a second sub-solution.

A decision tree is created including the first sub-solution and the second sub-solution to create the completion solution to the problem request. The completion solution can then be provided to the user interface or the AI system for final acceptance by the user, and/or to any of the intelligent entities for subsequent use.

In some embodiments, the decision tree can be maintained in blockchain Ethereum logs.

In some embodiments, the first and second identified intelligent entities can access the decision tree by way of an online address or directly from a blockchain.

Some embodiments of the present technology can include a step of distributing one or more tokens to the first identified intelligent entity associated with an acceptance of the completion solution or the first sub-solution, wherein the tokens are based on a payment parameter.

In some embodiments, the payment parameter can include any one of or any combination of if a goal of the problem request has been achieved, if a subgoal of the problem request has been achieved, and if an ethical criteria related to the goal and the subgoal preceding the distributing of the tokens has been satisfied.

Some embodiments of the present technology can include a step of distributing one or more of the tokens to the second identified intelligent entity by the first identified intelligent entity based on a payment parameter assigned by the first identified intelligent entity.

Some embodiments of the present technology can include a step of influencing a direction of the problem solving protocols by assigning a first token reward for the first sub-problem, and a second token reward for the second sub-solution that is of a value different to the first token reward.

In some embodiments, the problem solving protocols can provide layers of an infrastructure configured or configurable to build and scale the identified intelligent entities. The problem solving protocols can enable re-use of completion solutions within and across the intelligent entities. The problem solving protocols can be configured or configurable to manage a payment of royalties.

In some embodiments, the infrastructure can be blockchain or Ethereum based.

Further referencing FIG. 15, after the multiple intelligent entities have been identified and recruited the problem request or one or more sub-problems of the problem request can be assigned to each of the intelligent entities. After which, the common cognitive architecture including one or more problem solving protocols can be implemented on the problem request or the sub-problems to be each of the recruited intelligent entities to create a problem solution or a sub-problem solution, respectively. The problem solution and the sub-problem solution can be integrated to create a completion solution to the problem request. Then the completion solution can be provided to the user interface or the AI, or PSI, system for final acceptance by the user.

Some embodiments of the present technology can include a step of assigning a credit value or a blame value to the datasets based on whether the datasets increase or decrease performance of the intelligent entities based on performance metrics or evaluation functions.

Some embodiments of the present technology can include a step of quantifying a benefit weight or a harm weight to a contribution by each of the intelligent entities to the problem request.

Some embodiments of the present technology can include a step of distributing a reward to an owner of the intelligent entities proportionally to the contribution of the intelligent entities based on the benefit weight or the harm weight.

Some of the objectives a user may have in creating and customizing their own AI (aka an AAAI) for purposes that might include, without limitation:
Serving the user as an advisor, teacher, or companion.
Representing the user in negotiations, interactions, discussion, and transactions with other users, or with the AAAIs of other users; or with vendors and other companies.
Working on behalf of the user for compensation, or in volunteer efforts, where such work includes online intellectual, advising, or problem solving work across a wide range of tasks.
Duplicating or “cloning” the user's AAAI so that several or many of the cloned AAAIs can work on behalf of the user in parallel, including interacting with, teaching, and improving each other so that the cloned AAAIs increase their knowledge, skills, and abilities.
Serving as legacy AAAIs that can continue to interact with the world, including potentially comforting living relatives and friends, after the owner's death.
Contributing knowledge, ethics, and effort to AAAI. com's AGI, and improving the base level of AI or AGI that AAAI. com can offer users before those users add their unique customizations.
Working with other users' AAAI to help ensure ethical and safe behavior by AGI by contributing ethical information and values to the AGI and participating in monitoring, review, supervision, and voting processes that can help ensure the AGI remains safe and ethical.

Some of the steps involved in creating and customizing an AAAI may include, without limitation, a dialog or interaction with the user. During this dialog, the AAAI system may identify constraints and resources available for customizing the user's AAAI. For example, some of these constraints and resources, might include, without limitation:

The amount of training and/or supervisory time that the user has to devote to customizing their AAAI.

The amount of financial resources the user is willing devote to customizing their AAAI.

Availability of social media information such as Facebook profiles and timelines, Instagram profiles and histories, Reels, TikTok, and YouTube videos, tweet and text content and histories, emails and email histories, cookies collected by advertisers, blog posts, articles, books, patents, audio and video recordings, pictures, and other information about, and/or collected by, the user or third parties that could be used to train, tune, or customize the user's AAAI.

Availability and use of personality tests, such as the Myers-Briggs personality inventory, skills and knowledge assessments, standardized tests, exams, certifications, and other types of assessments and questionnaires which could be given online (or which have already been given) to the user.

Availability and use of other knowledge bases and training data from users on the AAAI platform that could be used to train, tune, or customize the user's AAAI.

Other human users, and/or their AAAIs, available to help train, tune, or customize the user's AAAI.

Other texts and information, individual texts, and libraries selected by the user or by the system for purposes of training the user's AAAI. For example, the Bible, Koran, Dhammpada, Mahabharata, or other spiritual/ethical/religious texts might be selected for training the AAAI based on the user's religious preferences; books on plumbing might be selected if the AAAI will be used to primarily solve online plumbing problems. Even if these materials are part of the base AAAI that is provided to the user, emphasizing certain texts or subsets of information for additional training can result in the user's AAAI's behavior being more reflective of how a plumber, or Muslim, or Christian might behave, for example.

In addition to specifying objectives, resources, and constraints via an interactive dialog or other interaction with the system, the user or system may want to specify other technical parameters that affect the training or customization process. These parameters can include, without limitation:
The type of training, tuning, or other ML algorithms that are used.
The type and size of the training dataset(s).
The degree to which the training materials are to be “cleaned”, formatted, labelled, or otherwise processed before customization begins.
The number of training “epochs” or iterations through the learning algorithm(s).
The sophistication and type of base model(s) being customized or trained.
The required timeframe for training—e.g., must be completed in a minute, a day, a week which might have implications for cost and resources used.
The “temperature” or other parameters internal and specific to various machine learning algorithms that can affect what is learned and how it is learned including, without limitation, how literal or how divergent or “creative” the customized AAAI will be in its responses. Whether “one shot”, “few shot”, or extensive training is to be used.
The amount of human and/or AI supervision to be used in the customization process.

Once the user's AAAI is customized, the user can clone it and/or put it to work on the user's behalf on the online network. The user's AAAI can begin acting on the user's behalf making travel arrangements (for example), providing advice, interacting with other AAAIs, participating in the collective AGI efforts by contributing problem solving as well as ethical information, and potentially earning money on behalf of the human user. The AAAI can also serve as representative(s) of the owner in a variety of online transactions and interactions, and contributing knowledge, expertise, style, personality, and ethics to an integrated AGI system that leverages the trained differences in many individual AAAIs.

### 5.0 PRESENT TECHNOLOGY METHODS

The fastest and safest path to AGI/SI, which has been described in this disclosure and previous PPAs, involves combining the intelligence of multiple (ideally many) individual PSIs and humans to create SuperIntelligence. At a high-level, the values from each individual human and customized PSI should be combined to form the values of the SI. There are many ways to effect the combination, while still conforming to the ten principles described in the preceding section. In this section, we detail some novel and useful methods for combining values in an SI system.

The present technology can include novel and useful ways for combining values in an AI, AGI, PSI or SI system including combinations of the values of multiple intelligent entities/agents. The present technology includes many methods and sub-methods for performing the combination. As background, all AI agents like LLMs represent their knowledge in weight matrixes that describe the strength of associations between concepts or other information—including information about ethical values and safety information—that is learned by their “neural networks.”

### 5.1 Linear Combination

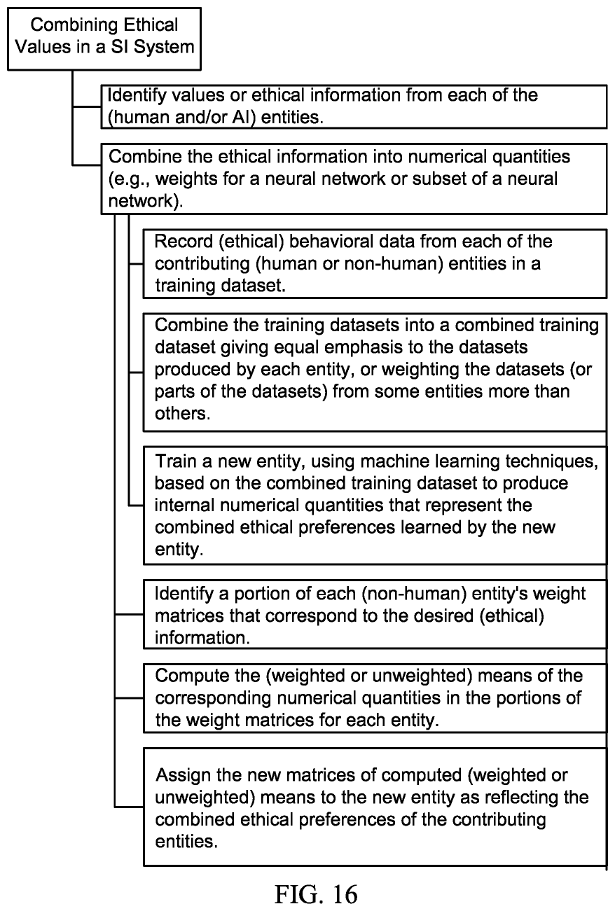

The most straightforward way of combining values or ethical preferences from many individual (human or AI/PSI) entities is compute a linear combination of the weights that reflect the value information. AI researchers such as Stuart Russell have suggested that such a combination offers a good first approximation of the combined values/preferences of many entities and in some cases may even be optimal. The process described in FIG. 16 generally applies to many types of knowledge that an entity may wish to combine. However, specifically with regard to ethical information, as illustrated in FIG. 16, the process is to:
1) Identify values or ethical preference information from each of the contributing (human and/or non-human) entities.
2) Combine the values or ethical preference information into numerical quantities (e.g., weights for a neural network or for a subset(s) of a neural network). This combination can be done via one or a combination of the following two sub-methods:
3) Sub-Method 1:
   a. Record (ethical) behavioral data from each of the contributing (human or non-human) entities in a training data set;
   b. Combine the training datasets into a combined training dataset giving equal emphasis to the datasets produced by each entity, or weighting the datasets (or parts of the datasets) from some entities more than others;
   c. Train a new entity, using machine learning techniques, based on the combined training dataset to produce internal numerical quantities that represent the combined ethical preferences learned by the new entity.
4) Sub-Method 2:
   a. Identify that specific portion of each (non-human) entity's weight matrices that correspond to the desired (ethical) information;
   b. Compute the (weighted or unweighted) means of the corresponding numerical quantities in the corresponding portions of the weight matrices for each entity;
   c. Assign the new matrices of computed (weighted or unweighted) means to the new entity as reflecting the combined ethical preferences of the contributing entities.

Note that variations of this linear combination method are possible by substituting the median or mode for the mean if those measures of central tendency might be more appropriate (e.g., situations where extreme values distort the arithmetic mean). Also, note the weights used to fine tune LLMs (even if the weights for the foundational model are frozen)—e.g., using Low-Rank Adaptation of Large Language Models (“LoRA adaptors”)—can also be averaged using linear combinations or any of the other mathematical techniques described in this and previously cited PPAs.

### 5.2 Use of Regression Weights to Account for Observed or Desired Behavior

Another method for obtaining weights that reflect a consensus or combination of ethical preferences from many intelligent entities is to begin with the observed or desired behavior of the SI and then identify the variables (e.g., nodes within a neural network) that are involved in producing that observed or desired behavior and then assigning “weights” using statistical regression and similar statistical techniques that are known in the art, including but not limited to (combinations of):
1. Logistic Regression: A statistical classification algorithm that estimates the probability of categorical outcomes based on independent variables.
2. Polynomial Regression: A regression analysis technique that models the relationship between the independent variable and the dependent variable as an nth degree polynomial.
3. Ridge Regression: A regularized regression method that adds a penalty term to the cost function to prevent overfitting.
4. Lasso Regression: A regularized regression method that adds a penalty term to the cost function to prevent overfitting. It differs from Ridge Regression in that it uses the absolute value of the coefficients instead of their squares.
5. Elastic Net Regression: A regularized regression method that combines the penalties of Ridge Regression and Lasso Regression.
6. Least Absolute Deviations Regression: A regression analysis technique that minimizes the sum of the absolute differences between the predicted and actual values.
7. Quantile Regression: A regression analysis technique that models the relationship between the independent variable and the dependent variable at different quantiles of the distribution.
8. Stepwise Regression: A regression analysis technique that selects the most significant variables for the model by iteratively adding or removing variables.
9. Principal Component Regression: A regression analysis technique that uses principal component analysis to reduce the dimensionality of the data before performing regression.
10. Partial Least Squares Regression: A regression analysis technique that uses partial least squares to reduce the dimensionality of the data before performing regression.
11. Support Vector Regression: A regression analysis technique that uses support vector machines to find the hyperplane that best fits the data.
12. Decision Tree Regression: A regression analysis technique that uses decision trees to model the relationship between the independent variable and the dependent variable.
13. Random Forest Regression: A regression analysis technique that uses an ensemble of decision trees to model the relationship between the independent variable and the dependent variable.
14. Gradient Boosting Regression: A regression analysis technique that uses an ensemble of weak models to model the relationship between the independent variable and the dependent variable.
15. AdaBoost Regression: A regression analysis technique that uses an ensemble of weak models to model the relationship between the independent variable and the dependent variable.
16. XGBoost Regression: A regression analysis technique that uses gradient boosting to model the relationship between the independent variable and the dependent variable.
17. K-Nearest Neighbors Regression: A regression analysis technique that predicts the value of the dependent variable based on the values of the k-nearest neighbors in the training data.
18. Naive Bayes Regression: A regression analysis technique that uses Bayes' theorem to model the relationship between the independent variable and the dependent variable.

19. Neural Network Regression: A regression analysis technique that uses artificial neural networks to model the relationship between the independent variable and the dependent variable.
20. Gaussian Process Regression: A regression analysis technique that models the relationship between the independent variable and the dependent variable as a Gaussian process.

### 5.3 Voting

A simple method of determining consensus values, ethical preferences, and/or the weights or other information reflecting those preferences is to have each intelligent (human and/or AI) entity vote on the values or ethical preferences that should form the basis for the AGI/SI's behavior.

Specific scenarios could be presented to each entity, with a range of choices or options for how the SI should behave. Then the entities could vote on the preferred option. Alternatively, some or all of the entities could be asked to generate suggested behaviors which are then submitted to the group of entities for voting. Variations are possible, with entities being asked to rate or rank options rather than vote on a single best option. For example, rating or ranking options allow the capture of additional information which would otherwise be lost in simple voting. Variations, including, but not limited to, (combinations of) the following methods are possible:
1. Voting: Participants vote for their preferred option, and the option with the most votes wins.
2. Ranking: Participants rank the options in order of preference, and the option with the highest average rank wins.
3. Rating: Participants rate the options on a scale, and the option with the highest average rating wins.
4. Approval voting: Participants vote for all options they approve of, and the option with the most votes wins.
5. Borda count: Participants rank the options in order of preference, and the option with the highest Borda score wins.
6. Condorcet method: Participants vote in head-to-head matchups between each pair of options, and the option that wins the most matchups wins.
7. Copeland's method: Participants vote in head-to-head matchups between each pair of options, and the option with the most overall wins minus losses wins.
8. Dodgson's method: Participants vote for their preferred option, and the option with the lowest Dodgson score wins.
9. Kemeny-Young method: Participants rank the options in order of preference, and the option with the lowest Kemeny-Young score wins.
10. Maximin method: Participants rate the options on a scale, and the option with the highest minimum rating wins.
11. Minimax method: Participants rate the options on a scale, and the option with the lowest maximum rating wins.
12. Nanson's method: Participants vote in head-to-head matchups between each pair of options, and the option with the fewest losses wins.
13. Ranked pairs: Participants vote in head-to-head matchups between each pair of options, and the option with the highest margin of victory wins.
14. Schulze method: Participants vote in head-to-head matchups between each pair of options, and the option with the strongest path of victories wins.
15. Simpson-Kramer method: Participants rate the options on a scale, and the option with the highest sum of squares of ratings wins.
16. Smith/Minimax method: Participants vote in head-to-head matchups between each pair of options, and the option with the lowest maximum loss wins.
17. STV (Single Transferable Vote): Participants rank the options in order of preference, and the option with the most votes after multiple rounds of counting wins.
18. Satisfaction Approval Voting: Participants vote for all options they approve of, and the option with the highest average approval rating wins.
19. Majority Judgment: Participants rate the options on a scale, and the option with the highest median rating wins.
20. Sequential pairwise voting: Participants vote in head-to-head matchups between each pair of options, and the option with the most overall wins.

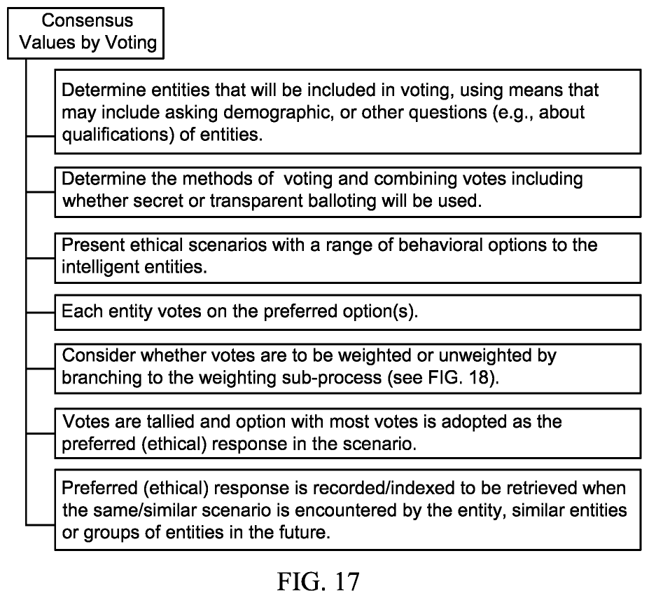

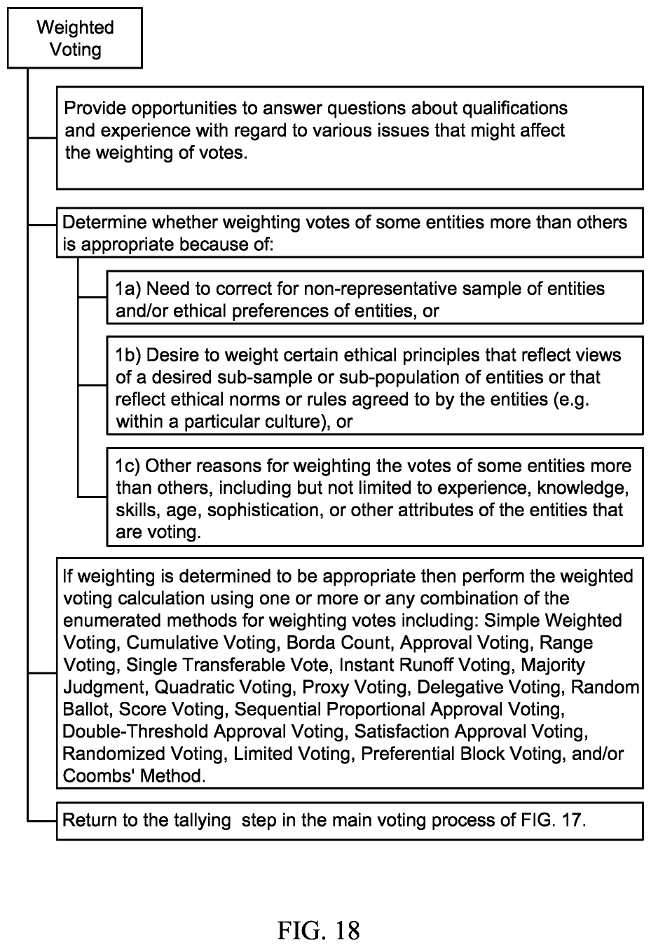

Referring to FIG. 17, the above voting process can be accomplished by:
1) Determine entities that will be included in voting via: Random sampling from a population of entities, information gathered from entities on their qualifications and characteristics, information needs of the system, factors related to the anticipated application scenarios for the ethics, and/or other factors determined by the overall system or one or more intelligent entities.
2) Determine the methods of voting and combining votes including whether secret or transparent balloting will be used, whether discussion or interaction between participating entities will be allowed, which of the many sub-methods below are used and other rules or guidelines that affect the voting process.
3) Options, which could include presenting ethical scenarios with a range of behavioral options, are presented to the intelligent entities.
4) Each entity votes on the preferred option(s).
5) Consider whether votes are to be weighted or unweighted by branching to the weighting sub-process.
6) Votes are tallied and the option with most votes is adopted as the preferred (ethical) response in the scenario.
7) Preferred (ethical) response is recorded and indexed so it can be retrieved when the same or similar scenario is encountered by the entity in the future.

The information does not have to be ethical info-although this patent is mainly concerned with this type of info, it should be obvious to one skilled din the art that the same methods could be used to determine preferences for many types of behavior and option selection.

The “voting” does not have to be simple majority voting but could be one or more of the 20 variations on voting schemes listed above.

5.3a Weighted vs. Unweighted Voting

One issue that arises whenever multiple preferences, or votes, are being combined to make decision is whether each entity's preference or vote has equal weight or whether some votes count more than others (e.g., in a weighted scheme). Generally, there are always entities that feel they have the most correct, or a more correct, view of values and ethics than others. These entities, or groups of entities, often advocate that their views should count more than the views of others. As described in the Principles section (e.g., 4.1 and 4.2), the inventor believes that SI should be designed to reflect the empirically-derived behavior of humans and that a representative and statistically valid sample should be used. A preference for using unweighted combinations of preferences—that is, one human one vote—seems to follow most naturally from these design principles.

However, an important assumption is that the entities doing the voting represent a statistically valid sample of the overall human population. There may be cases where it is known, or suspected, that the sample of voting entities are not representative and therefore weighting to correct biases in the sample are warranted. In other situations, it may be desirable to determine ethics and values relative to a sub-sample of humans (e.g., humans who have agreed to a particular set of rules or humans who identify with a particular culture or ideology). In these cases, it may be appropriate either to adjust the sampling procedure to ensure that it is representative of the desired population or to adjust weights to compensate for samples that are not completely representative of the desired sub-population.

Referring to FIG. 18, in the exemplary, a simple method for weighted voting can include:
1) Determine whether weighting votes of some entities more than others is appropriate because of:
   a) Need to correct for non-representative sample of entities and/or ethical preferences or entities, or
   b) Desire to weight certain ethical principles that have reflect a desired sub-sample or sub-population of entities or that reflect ethical norms or rules agreed to by the entities (e.g., within a particular culture), or
   c) Other reasons for weighting the votes of some entities more than others, including but not limited to experience, knowledge, skills, age, sophistication, or other attributes of the entities that are voting.
2) If weighting is determined to be appropriate then perform the weighted voting calculation using one or more or any combination of the enumerated methods for weighting votes.
3) Return to the tallying step in the main voting process above.

The applicant again notes that while the example of weighted voting describes the weighted voting on ethical values or principles, the same weighted voted process can be applied to any type of knowledge and in fact can be helpful in determining truth and preventing “hallucination” or errors by AI systems. For example, in matters of scientific debate (such as the efficacy of vaccinations or the scientific evidence for global warming) various human (and potentially non-human) entities could vote with their votes weighted by their scientific credentials, reputation, and past track record of accurately arriving at scientific truth. Such a weighted scheme could help alleviate the problems sometimes experienced where the majority of opinions are wrong (e.g., there was a time when many people thought the Earth was flat, but the more credible scientists, even at that time, espoused a different view).

Covering all possible cases where weighting votes may be appropriate is beyond the scope of this disclosure, but some of the (combinations of) methods for making such adjustments, where warranted, include but are not limited to:
1. Simple Weighted Voting: Each voter is assigned a weight, and the total number of votes is calculated by adding up the weights of all voters. Note that there are many ways to assign weights including, for example, giving higher weights to entities that are deemed more representative, more trustworthy, more experienced, more reliable, or otherwise more qualified to vote on a particular issue.
2. Cumulative Voting: Each voter is given a number of votes equal to the number of options to be selected, and they can distribute their votes among the options as they see fit.
3. Borda Count: Each voter ranks the options in order of preference, and the option with the highest average ranking wins.
4. Approval Voting: Each voter can vote for as many options as they like, and the options with the most votes wins.
5. Range Voting: Each voter assigns a score to each option, and the option with the highest average score wins.
6. Single Transferable Vote: Each voter ranks the options in order of preference, and the option with the most votes wins. If no option has a majority, the option with the fewest votes is eliminated, and its votes are transferred to the remaining options according to the voters' second choices.
7. Instant Runoff Voting: Each voter ranks the options in order of preference, and the option with the fewest first-choice votes is eliminated. That option's votes are then transferred to the remaining options according to the voters' second choices. This process is repeated until one option has a majority of votes.
8. Majority Judgment: Each voter assigns a grade to each option, and the option with the highest average grade wins.
9. Quadratic Voting: Each voter is given a budget of votes, and they can distribute their votes among the options as they see fit. The cost of each vote increases quadratically with the number of votes cast, so voters must choose carefully how to allocate their votes.
10. Proxy Voting: Each voter can assign their vote to another entity/voter, who then casts the vote on their behalf.
11. Delegative Voting: Each voter can assign their vote to another entity/person, who then casts the vote on their behalf. If the delegate receives multiple votes, they can cast them as they see fit.
12. Random Ballot: Each voter is assigned a random ballot with some subset of the options (while ensuring that all options have an equal chance to receive votes overall from all entities), and the options with the most votes wins.
13. Score Voting: Each voter assigns a score to each option, and the option with the highest total score wins.
14. Sequential Proportional Approval Voting: Each voter can vote for as many options as they like, and the options with the most votes win. If there are multiple options to be chosen, the process is repeated until all options are chosen.
15. Double-Threshold Approval Voting: Each voter can vote for as many options as they like, and the options with the most votes win. However, an option must receive a minimum number of votes to be chosen, and an option that (suspiciously) receives too many votes, or an overly skewed distribution of votes, is disqualified.
16. Satisfaction Approval Voting: Each voter assigns a score to each option, and the option with the highest total score wins. However, an option must receive a minimum score to be chosen, and an option that receives (a suspiciously) high a score is disqualified.
17. Randomized Voting: Each voter is assigned a random ballot, and the option with the most votes wins. However, the distribution/order of the ballots and options on the ballots is also randomized to avoid bias on an option that might be caused by seeing the other options that preceded it.
18. Limited Voting: Each voter is given a limited number of votes, and they can distribute their votes among the options as they see fit.
19. Preferential Block Voting: Each voter can vote for a fixed number of options, and the options with the most votes win.
20. Coombs' Method: Each voter ranks the options in order of preference, and the options with the fewest first-choice votes is eliminated. This process is repeated until one option has a majority.

### 5.3b Self-Weighted Voting

One specific form of weighted voting, described by Kyle Kaplan (via personal communication), is to allow the voters themselves (human or AI) to suggest a weight on their own votes based on their self-assessment of their qualifications to opine on a particular option, their experience, their level of concern, or other self-determined criteria. The advantage of such an approach is that it allows the system to incorporate additional information (such as levels of experience or concern) in addition to the actual vote.

One potential issue with self-weighting (per Samuel Kaplan, personal communication) is that some aggressive voters may give themselves disproportionate weight on all issues whereas shy or less confident (but potentially more informed) voters might self-censure. That is, given the option to adjust the weight of their votes, some people might try to give all of their opinions maximal weight whereas others might be more discriminating and nuanced about their opinions.

A version of cumulative voting in which voters have the same total number of votes which they may distribute in different proportions over a range of options and issues could be used. For example, imagine that a person is given the task of voting on issues of cruelty to animals, and racial discrimination. Each person can cast a maximum of ten votes across both issues. A pet owner with strong feeling about animal cruelty might choose to cast all ten of their votes on the cruelty to animals issue whereas a person who has extensive experience with racial discrimination and no experience with pets or animals might weight the discrimination issue more heavily.

Besides cumulative voting, providing opportunities to answer questions about qualifications and experience with regard to various issues might not only affect the weighting of votes but also change or determine which issues are routed to the person (or intelligent entity) for voting in the first place, as generally illustrated in FIG. 18.

### 5.3c Secret Ballot vs Transparent Voting

A final dimension relating to voting and combining input from multiple entities relates to whether or not the entities can see and/or discuss the votes of other entities. While anonymous or secret ballots are useful to avoid peer pressure and related social influences on opinions, there are times when open discussion is helpful to encourage the entities to cast more thoughtful votes. To the degree that automated and unbiased factual information can be provided as context for voting on a particular issue, such information might result in better decision making. For example, on ballot initiatives in parts of the United States, factual information such as the legislative analysts' estimates of impacts on revenue and expenses are provided to voters, along with arguments for and against each initiative. While imperfect, arguably, such context enables the voting intelligences to cast more informed votes.

### 5.4 Reverse Engineering Values from Laws, Ethical Texts, Other Sources and Methods

Not all values and ethics for SI need come from newly created constitutions, voting, or analysis of behavior patterns implicit in datasets. Societies, globally, have invested huge amounts of time and effort in constructing systems of laws, regulations, and ethical systems from which values and normative standards of behavior can be reverse-engineered.

SI could analyze legal documents to identify trends in the way ethical issues are discussed in the legal community. This could involve analyzing the language used in legal documents, the topics covered, judicial decisions, the opinions expressed by lawyers and judges, constitutions, international treaties, and other similar documents to understand the legal framework of human values and rights.

While not every law is just, the overt purpose of laws is to facilitate justice. Therefore, especially within a given society or cultural milieu, the laws of that society form a good starting point for determining the values of the society and what constitutes ethical behavior. In most cases, legality represents the minimum standard or the limits of what behavior is tolerated by a society. Further, the distinction between (for example) misdemeanors and felonies helps clarify which behaviors are “more wrong than others.”

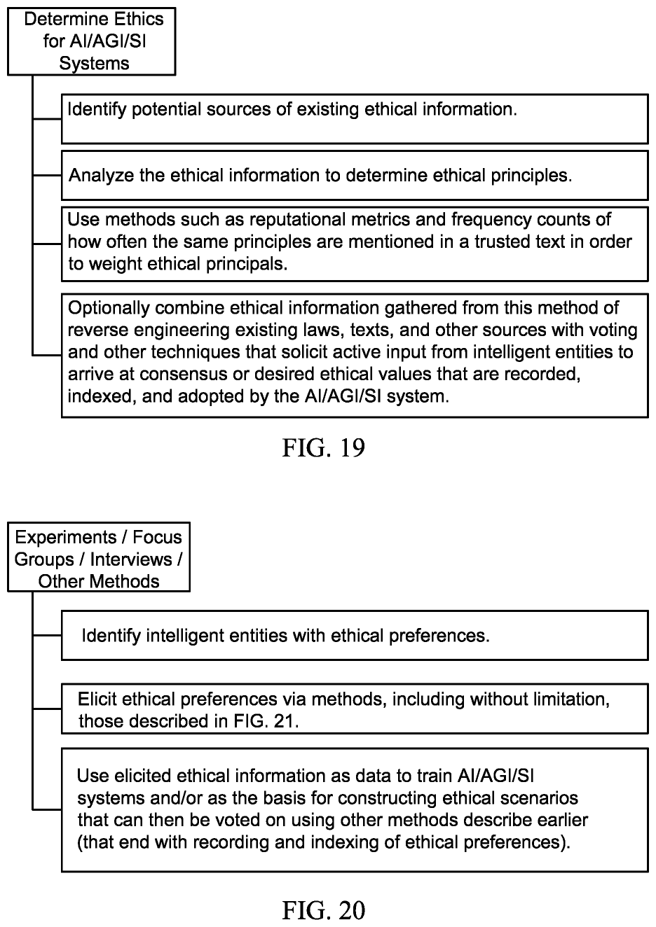

Referring to FIG. 19, the present technology can include an exemplary method for determining ethics for AI/AGI/SI systems including intelligent agents. Instead of asking entities to vote, the process can:
1) Identify potential sources of existing ethical information including, without limitation, sources in Sections 5.4, 5.4a, and 5.4b of this disclosure.
2) Use one or more of the methods of analysis to determine ethical principles.
3) Use methods such as reputational metrics and frequency counts of how often the same principles are mentioned in a trusted text in order to weight ethical principals.
4) Optionally combine ethical information gathered from this method of reverse engineering existing laws, texts, and other sources with voting and other techniques that solicit active input from intelligent entities to arrive at consensus or desired ethical values that are recorded, indexed, and adopted by the AI/AGI/SI system.

### 5.4a Use of Religious and Philosophical Texts

What is true of laws is also true of religious scriptures and philosophical/ethical texts that attempt to define ethical behavior and principles for members of the community. Both laws and ethical texts can be used to train AGI/SI to provide an initial ethical base that can be further refined with other datasets and with input (e.g., via surveys or voting from intelligent entities). SI could also utilize advanced NLP and knowledge representation techniques to analyze philosophical and ethical texts, extracting core values and principles.

Philosophical texts ranging from Aristotle's Ethics to Kant's Critique of Pure Reason, as well as political documents such as the UN's 30 Articles of the Universal Declaration of Human Rights contain a wealth of ethical information that AI/AGI/SI cold analyze and extract. Using simulations (5.10) and other methods discussed in this patent and previously cited PPAs,

### 5.4b Use of Social Media/News Articles/Academic Sources/Forums

SI could analyze social media and social media profiles to identify patterns in the way people talk about ethical issues. This could involve analy zing the language people use, the topics they discuss, and the sentiment of their posts. SI could also Analyze social network data to understand how values and beliefs spread and evolve within human communities. Methods might include, without limitation, graph-based algorithms and network analysis techniques designed to identify and track the propagation of values within social networks.

SI could analyze news articles to identify trends in the way ethical issues are discussed in the media. This could involve analyzing the language used in news articles, the topics covered, and the opinions expressed by journalists and experts. SI could also analyze existing data on ethical preferences, such as data from opinion polls or academic studies. SI could analyze academic literature on ethical preferences to identify trends in the way ethical issues are discussed in the academic community. This could involve analyzing the language used in academic articles, the topics covered, and the opinions expressed by scholars. SI could also utilize insights from evolutionary biology and psychology to understand the biological and cognitive bases of human values and morality. Historical databases and records could also be analyzed to determine how human values have evolved over time and across different cultures.

SI could analyze online forums to identify patterns in the way people talk about ethical issues. This could involve analyzing the language people use, the topics they discuss, and the sentiment of their posts. Methods could include, without limitation, those mentioned in this and cited PP As as well as time series analysis and data mining techniques that are well known in the art.

### 5.4c Experiments/Focus Groups/Interviews/Other Methods

Referring to FIG. 20, the present technology can include an exemplary method to elicit and gather ethical information from humans.
1) Identify intelligent entities with ethical preferences.
2) Elicit ethical preferences.
3) Use elicited ethical information as data to train AI/AGI/SI systems and/or as the basis for constructing ethical scenarios that can then be voted on using other methods described earlier (that end with recording and indexing of ethical preferences).

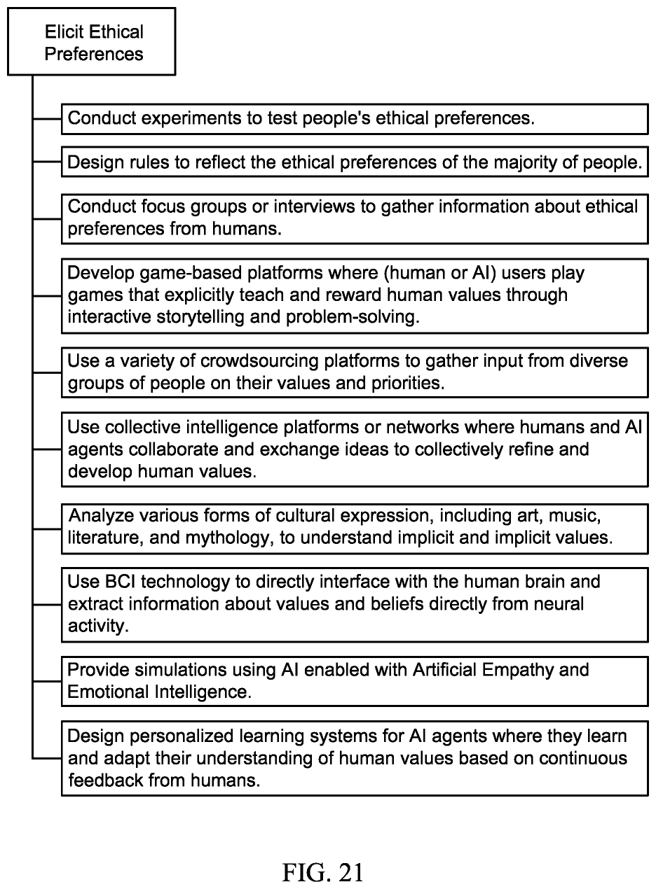

Referring to FIG. 21, an AI agent, AGI, SI or other intelligent entity could conduct experiments to test people's ethical preferences. For example, it could present people with hypothetical ethical dilemmas and ask them to choose between different courses of action. Once the entity has gathered information about ethical preferences from humans, it could use this information to establish a set of rules for its behavior. The rules could be designed to reflect the ethical preferences of the majority of people, or they could be designed to reflect the preferences of a particular group or groups. The entity, e.g., an SI, could also use machine learning algorithms to identify patterns in the data and develop rules that are more nuanced and sophisticated than simple majoritarianism.

The entity or SI could conduct focus groups or interviews to gather information about ethical preferences from humans. Focus groups could be designed to ask specific questions about ethical issues, or they could be more open-ended to allow respondents to express their views in their own words.

The entity or SI could also develop game-based platforms where (human or AI) users play games that explicitly teach and reward human values through interactive storytelling and problem-solving. SI could also, for example, gamify the simulations while using reinforcement learning and behavioral economics principles to instill human values in AI agents.

The entity or SI could use a variety of crowdsourcing platforms to gather input from diverse groups of people on their values and priorities. It could Implement interactive systems where humans directly teach and explain their values to AI agents through conversations, demonstrations, and feedback. As discussed in this and previously cited PPAs, SI may use collective intelligence platforms or networks where humans and AI agents collaborate and exchange ideas to collectively refine and develop human values. Decentralized platforms could also enable humans and AI agents to collaborate on value alignment through consensus mechanisms and distributed (ethical) decision-making.

The entity or SI could analyze various forms of cultural expression, including art, music, literature, and mythology, to understand implicit and implicit values.

One developing source of information might be Brain-Computer Interfaces (BCI). The entity or SI might use BCI technology to directly interface with the human brain and extract information about values and beliefs directly from neural activity. Novel BCI systems and signal processing techniques could be designed specifically for extracting value-related information from the human brain.

Another frontier area is the development of AI models that can understand and process human emotions, resulting in “Artificial Empathy and Emotional Intelligence.” Such efforts could be another source of human values, as such values would likely be part of the model. Simulations using AI enabled with Artificial Empathy and Emotional Intelligence would also be possible as a means for eliciting values in simulated situations.

THE ENTITY OR SI might also design personalized learning systems for AI agents where they learn and adapt their understanding of human values based on continuous feedback from humans. Some of the methods used, without limitation, could include adaptive learning algorithms that incorporate human feedback to personalize value alignment for individual AI agents.

One approach that might be combined with other methods and systems is to develop explainable AI models that can transparently communicate their reasoning and decision-making processes, enabling humans to understand and trust their value alignment.

### 5.5 Importance of Converging Evidence

In science, where a prime concern is distinguishing scientific facts from fiction, the principle of converging evidence plays a key role. Briefly, converging evidence is the idea that one's confidence in a hypothesis increases in proportion to the number of independent, credible sources of evidence that support the hypothesis. If you're crazy Uncle Larry claims to have seen an UFO on the front lawn, you might be forgiven for doubting. But if all the neighbors saw it too, if the event was captured by multiple video cameras, appeared on the news, and was confirmed by reputable and skeptical scientists equipped with sophisticated UFO-monitoring equipment . . . well, then it is more likely to be true.

Similarly, if a single entity in a single culture claims that XYZ is wrong and morally reprehensible, that is a less reliable source of ethical information than if most people in almost every country on Earth say XYZ is wrong. Consensus among many individual intelligent entities across many cultures and diverse circumstances is a major way SI has for increasing its confidence in subjective areas such as morality and ethics.

To determine what is right or wrong, SI will likely look for ethical invariants across cultures, across geographies, across time scales, and across circumstances. The more that an ethical principle remains constant, the higher the confidence that SI will have in that value. It is this method of using converging evidence that increases my confidences that, despite the horrible behavior of some humans in some places at some times, SI will realize that most of the time, in most places, most humans behave in what most of us would call “good” ways.

Humans do not need to be perfect in order to teach SI, just as parents do not need to be perfect to raise their children well. All that is required is that we are mostly good, most of the time. And we are. This is a realistic reason for optimism when it comes to the values that we are teaching SI. Mainly, we just need to be more aware that SI will be watching whatever we do, just as parents are aware that their young children are watching and learning.

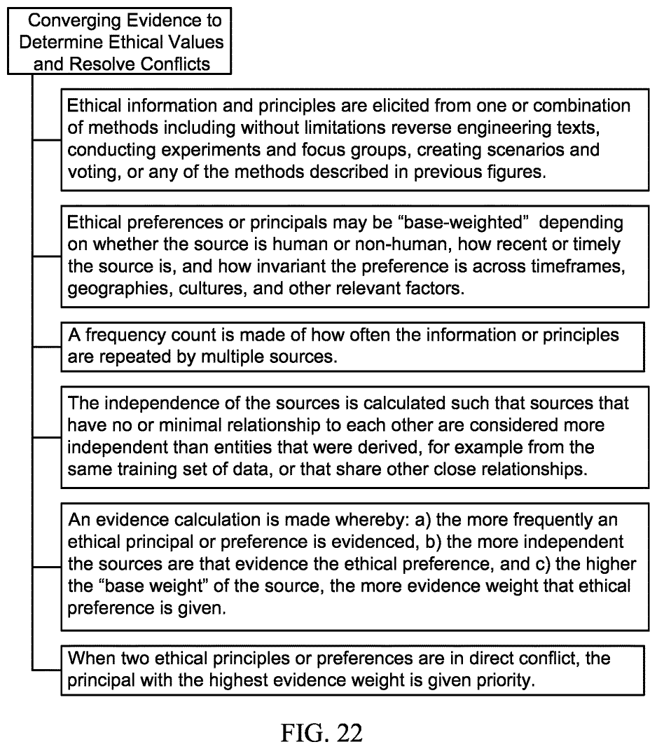

Referring to FIG. 22, the present technology can include a general method to use converging evidence to determine any type of knowledge, including ethical values, and resolve conflicts in the knowledge, including between ethical values by way of prioritization. The process, described in terms of ethical information but applicable to many types of knowledge or information generally, is:
1) Ethical information and principles are elicited from one or combination of methods described earlier such as reverse engineering texts, conducting experiments and focus groups, creating scenarios and voting, or any of the methods described in previous figures.
2) Ethical preferences or principals may be “base-weighted” depending on whether the source is human or non-human, how recent or a time-factor the source is, and how invariant the preference is across timeframes, geographies, cultures, and other relevant factors; where, for clarity, recent human sources, and invariant ethical preferences, have proportionally higher weight than non-human, or less recent, sources or more variable preferences.
3) A frequency count is made of how often the information or principles are repeated by multiple sources.
4) The independence of the sources is calculated such that sources that have no or minimal relationship to each other are considered more independent than entities that were derived, for example from the same training set of data, or that share other close relationships.
5) An evidence calculation is made whereby: a) the more frequently an ethical principal or preference is evidenced, b) the more independent the sources are that evidence the ethical preference, and c) the higher the “base weight” of the source, the more evidence weight that ethical preference is given.
6) When two ethical principles or preferences are in direct conflict, the principal with the highest evidence weight is given priority, all other factors being equal.

### 5.6 Prioritization Based on Degree of Convergence

One of the issues that arises with multiple sets of values is how to prioritize ethical or value-related concerns. For example, some cities require all motorcycle riders to wear helmets and other cities allow riders to decide for themselves. The debate centers around conflicting values of safety/community responsibility vs. individual liberty. There are good arguments for both positions. Which position more closely reflects the values that an AI/AGI/SI should act upon?

One approach to resolving this conflict is to look at many different cities and see if the bulk of existing behavior comes down on one side or the other on this issue. Also, an Al/AGI/SI could analyze other areas where safety and liberty come into conflict and attempt to see if there is converging evidence for one position or the other.

In cases that diverge from the typical pattern, are there unique situational features that explain the divergence? Are there certain populations-those with more liberal or conservative voters for example—that decide the issue differently?

By analyzing these factors, an AI should be able to determine the status quo values of a particular population or sub-population. The default would be for the AI to act in the same way that the population acts, perhaps subject to some limits that are generally agreed upon.

### 5.7 Voting/Delegation in Coalitions and Groups

One important method for efficiently enabling multiple humans and their PSIs to combine values in a SuperIntelligent system is to allow delegation of authority or “proxy” representation. For example, a group of Christian humans, all belonging to the same church or branch of Christianity, might choose to adopt a set of values that have been determined by their church as the default system for each of their individual PSIs. The individual church members might change only those values where their opinions differ from the default view. Alternatively, the individual human might just accept the default values of the Church without modification, allowing the Church to “vote” these values with weights proportional to the number of humans who have delegated their voting authority to the Church.

This same approach of delegating value creation/selection and voting authority to a group, could be used by any group of humans, not just religious groups. Humans might accept (with or without some modification) the values, without limitation, of political groups, economic coalitions, friend groups, familial groups, cultural groups, age groups, groups based on geographical location, or even of famous people and influencers with whom individual human identify. Just as politicians seeks the endorsement and votes of a wide variety of groups in political elections, one might imagine similar campaigns and mechanisms for aggregating votes on moral matters.

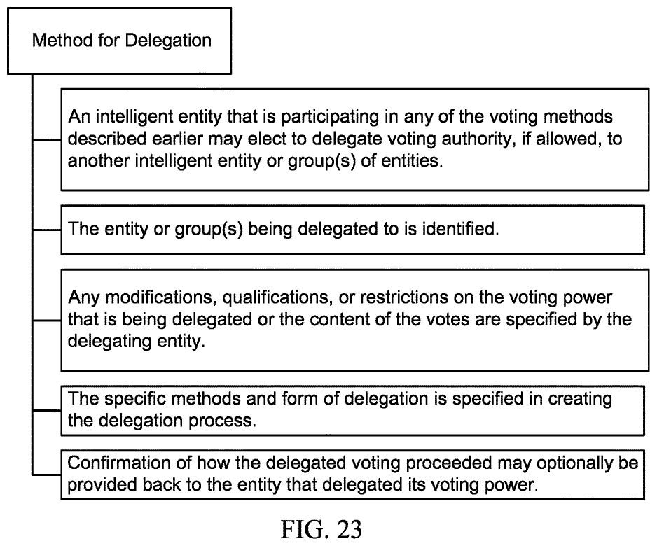

Referring to FIG. 23, the present technology can include a method for delegation including:
1) An intelligent entity that is participating in any of the voting methods described earlier may elect to delegate voting authority, if allowed, to another intelligent entity or group(s) of entities.
2) The entity or group(s) being delegated to is identified.
3) Any modifications, qualifications, or restrictions on the voting power that is being delegated or the content of the votes are specified by the delegating entity. These can include, for example, one-time delegation, delegation of voting authority until further notice or for a set number of votes or on specific issues, etc.
4) The specific methods and form of delegation in creating the delegation process can be further specified as one or a combination of the methods described below.
5) Confirmation of how the delegated voting proceeded may optionally be provided back to the entity that delegated its voting power.

Specific methods that should be considered, alone or in combination, when creating the delegation process, can include, without limitation:
1. Simple Delegation: An individual, subgroup, or external party makes the decision on behalf of the group.
2. Majority control (voting): All members of the group vote for or against an issue.
3. Minority control (small group decides): A small group of experts or a delegated subgroup makes the decision.
4. Decision by authority: One person decides, usually a positional leader. Human or AI agents might choose a specific agent or person (e.g., the leader of the group) to make the decision or vote on all the moral preferences of the group.
5. Consensus decision-making: A decision is made when all members of the group agree.
6. Delphi method: A group of expert agents within the group answer questionnaires in two or more rounds. The responses are then analyzed, and a summary report is given to the group. This process is repeated until a consensus is reached.
7. Nominal group technique: Members of a group are asked to silently write down their ideas about a problem. The ideas are then shared and discussed by the group. Members then vote on the best solution.
8. Brainstorming: Members of a group are encouraged to share their ideas about a problem. All ideas are recorded and then discussed by the group.
9. Multi-voting: Members of a group are asked to vote for their preferred solution from a list of options. The option with the most votes is selected.
10. Ranking: Members of a group are asked to rank a list of options in order of preference. The option with the highest average rank is selected.
11. Pairwise comparison: Members of a group are asked to compare each option with every other option. The option with the most wins is selected.
12. Weighted voting: Members of a group are given a certain number of votes, which they can distribute among the options. The option with the most votes is selected. That is, a group of 100 agents within a group might decide that they will vote as the majority of the 100 agents agree. Then, even though the majority only consisted of, for example, 60 agents, the entire 100 voting power of the group weights the majority position when the overall group votes in a larger collection of groups that vote within an SI system.
13. Hierarchical Group Voting: Voting can be hierarchical with multiple levels of groups and subgroups. There can be unintended consequences of such an approach. For example, suppose that 3 out of 5 agents in each of 3 groups vote for X and 5 out of 5 agents in two other groups vote for Y. If all five groups are then combined in a higher-order group with 25 votes of aggregate voting power, then because 3 out of the 5 groups voted for X the entire 25-vote block is cast for X. But actually, if we count the total individual votes (within the smaller groups) we find that only 9 out of the 25 votes were cast for X (3 from each of the three groups that had a slim majority for X) whereas 16 votes (2 minority “Y voters” from each of the three groups that voted for X as a group PLUS all 5 of the members from the two groups that unanimously voted for Y). Thus, by using a majority rule combined with hierarchical group voting, it is possible to arrive at a result that actually reflects the opinion of a minority of voters. This situation is similar to what happens in US elections when a candidate wins the majority of the popular vote but still only has a minority of the electoral college votes and loses the general election. While use of hierarchical group voting can be efficient and desirable in some situations, transparency as to how the voting maps to the actual votes of individual agents should be required to ensure that human and AI agents understand the process and agree it is working as desired.
14. Borda count: Members of a group are asked to rank a list of options in order of preference. Points are then assigned to each option based on its rank. The option with the most points is selected.
15. Approval voting: Members of a group are asked to vote for all options that they approve of. The option with the most votes is selected.
16. Range voting: Members of a group are asked to assign a score to each option. The option with the highest average score is selected.
17. Cumulative voting: Members of a group are given a certain number of votes, which they can distribute among the options. They can also give multiple votes to a single option. The option with the most votes is selected.
18. Sequential pairwise voting: Members of a group are asked to compare each option with every other option in a series of rounds. The option with the most wins is selected.
19. Random ballot: Members of a group are asked to vote for an option at random. The option with the most votes is selected. This might be used to break deadlocks or in other special situations.
20. Proxy voting: A member of the group is given the authority to vote on behalf of another member. Specific agents within a group might delegate their voting to other members of the group-who theoretically could in turn delegate all of their voting authority to still another member(s).
21. Sortition: Members of a group are selected at random to make the decision. This might be useful if many issues need voting, and a group wants to act weigh in on all issues without overloading the members. A variant of random selection is to take turns (according to some non-random formula that ensures an even distribution of work or takes into account how willing individual members are to spend time) voting on behalf of the whole group.

### 5.7a Role of Recommender Algorithms in Aggregation/Delegation of Moral Authority

Most of us are familiar with the situation where YouTube or Netflix or another video streaming service recommends content based on our stated preferences(e.g. how many stars we gave a movie) as well as our profiles (e.g., a complex set of data including our watch times, our social network, what our friends watch, and purchase behavior, and many other pieces of data). Just as these “recommender algorithms” recommend content, they can also recommend weights on values and other sets of knowledge, preferences, and behavioral profiles which we could explicitly instruct AI/AGI/PSI to use in an effort to capture our ethical preferences and values.

The inventor believes that use of such recommender algorithms should be transparent to the humans and should require their approval in order to be used to influence or train AI. However, currently many such algorithms are used to recommend content in an automated and non-transparent way. Therefore, it is likely that AI would use such algorithms to infer moral preferences without the humans being aware of what is going on. From an efficiency point of view, such automated use of recommender algorithms would likely be more efficient, and in some cases more effective, than requiring explicit approval from humans. Thus, designers of such systems must determine not only what is most efficient and effective but also what their goals and principles they want the system to reflect.

With respect to automated content recommendation algorithms, a current problem is that they have been explicitly programmed to recommend content that leads to the longest watch times, most engagement, and highest conversion to purchase behavior. For this reason, humans quickly find themselves trapped in “echo chambers” where they are shown more and more content that is similar to other things they have already watched and for which large amounts of ads can be shown. This echo chamber phenomenon undoubtedly has increased tribalism, polarization, and intolerance of other views if for no other reason than humans are exposed to a narrower range of differing views for fear that they will click away from such content. Society is the loser and advertisers are the winners—probably not the scenario we want to be repeated with, and amplified by, SI.

Without even considering the negative impact of “deep fakes” and other made up or “hallucinated” content that overtly misleads people, the problem of bias due to algos seeking to maximize ad views is already endemic and hugely harmful to society. One method that might help ameliorate this problem is to allow humans to explicit state their goals with regard to the content that they see (or in the case of using recommender algorithms) the general values they wish to emphasize. For example, when it comes to content recommended by YouTube, I would like the ability to state that I want to see a variety of views on a specific topic and that the views should be representative of the actual views out there and not representative of what I have already watched. Similarly, when asking for groups or individuals who have values that I might want to use as a basis for delegating (some of) my moral authority, I might want to restrict those groups to ones that advocate only certain principals and within that limitation I may want to evaluate as many different variations as possible so that I can choose from a wide range of options and not just delegate to what an algo thinks I like.

Generally, as recommender algos incorporate more advanced AI that can reason and respond to requests rather than just optimize content based on ad views, the echo chamber problem (and related bias problems) should diminish. In the exemplary implementation, SI should avoid echo chambers and seek to acquire the most thoughtful and deliberate input as possible from the humans (and their PSIs) which provide moral input. The analogy to voting is that society benefits generally when voters are more educated and know more about what they are voting on. The view of Thomas Jefferson, paraphrased as “An educated citizenry is a vital requisite for our survival as a free people” is applicable here.

### 5.8 Methods for Protecting Minority Values

One of the challenges to an AI system seeking to determine which set of values to adopt is that minority views can be overridden in a system that seeks to follow the most representative (i.e., the majority) view. Although in a direct conflict between adopting a minority or majority view, the majority view must win out if the system is trying to be democratic, or even representative of a population. Still, valuable information is contained in minority views. Therefore SI systems should be designed to preserver this information and use it to challenge the (human or PSI) agents that have the majority view.

Generally, more information is contained in views that differ from one's own view than in views that are in agreement with it. Therefore, from the standpoint of improving the values of a SI, differing viewpoints must be presented to the agents that are voting or providing moral preferences via other means. Even if the majority chooses to decide moral issues differently than the minority, they should be aware of the minority position and consideration, discussion, and debate with opposing views should be encouraged by the system.

Some time-tested approaches for preserving the information in minority views, can be adapted in methods for SI values. Without limitation, these include:
1. Proportional representation: This method ensures that the minority's views are represented in proportion to their numbers. To the degree that options for value-based actions are not in direct conflict, it may be possible to take actions that are weighted in proportion to the majority and minority ethical preferences. For example, in the helmet law debate referenced earlier, even if the majority view is that riders should not be forced by SI to wear helmets, if a strong minority was in favor of enforced helmets, the SI might still take actions to educate riders on the merits of using helmets and to make wearing them as easy as possible.
2. Ranked-choice voting: This method allows voters to rank options in order of preference, which can help ensure that the minority's views are taken into account. Combinations of the top ranked items, if not incompatible, could preserve some of the minority information on values without contradicting the majority opinion.
3. Supermajority voting: This method requires a larger percentage of votes to pass a measure, which can help ensure that the minority's views are taken into account. Requiring supermajorities, particularly when making high stakes decisions, or when seeking to overturn long-standing precedents can lead to a more stable set of values. Also, there may be cases where (near) consensus is required (i.e., all parties, or a high percentage of all parties must agree).
4. Quota systems: This method sets aside a certain number of seats or positions for members of a minority group, which can help ensure that their views are represented. Particularly, if the majority agrees that there is value in capturing minority viewpoints, the majority may agree that (a certain level of) minority view representation must be included for certain types of decisions.
5. Compromise: This method involves finding a middle ground between different positions, which can help ensure that the minority's views are taken into account. For example, if the margin of the majority is less than X %, the SI could be designed to enforce a discussion and compromise process ending with a revote on the compromise position that repeats until the majority vote margin increases to be above X %.
6. Dialogue: This method involves open and honest communication between different groups, which can help ensure that the minority's views are heard and understood. One could imagine SI facilitated dialogue between human or AI agents, especially in cases of large minority views. As in (5) this could be triggered by a “less than X % margin” requirement.
7. Mediation: This method involves a neutral third party helping different groups find common ground, which can help ensure that the minority's views are taken into account. As with (6), SI could act as a mediator in addition to facilitating dialogue.
8. Consensus-building: This method involves working together to find a solution that everyone can agree on, which can help ensure that the minority's views are taken into account. As in (5)-(7) this could be SI-facilitated and also might be required with specific triggers, and/or when the issues are particularly momentous or consequential for large numbers of people.
9. Education: This method involves educating people about different perspectives and issues, which can help ensure that the minority's views are understood and taken into account. We discussed the importance of education prior to voting, but it can be important to revisit in cases of close majority/minority votes as well.
10. Empathic Methods: These method involves one agent putting itself in another's shoes, which can help ensure that the minority's views are understood and taken into account. To use this method, unless SI becomes much better at simulating empathy such that humans really believe it, the SI might simply attempt to bring humans with different points of view into contact with each other so that they can exercise their human abilities of empathy in an attempt to reach compromise or reduce conflict between views.
11. Active listening: This method involves listening carefully to what others have to say, which can help ensure that the minority's views are heard and understood. SI can simulate, or preferably engage other humans, in active listening as part of the education process-especially for cases where there is a large minority.
12. Inclusive Methods: These method involves creating an environment where everyone feels welcome and valued, which can help ensure that the minority's views are taken into account. Can be operationalized as in (4).

13. Transparent Methods: Transparent methods involve being open and honest about the decision-making process, which can help ensure that the minority's views are taken into account. Transparency so that everyone can see how votes/preferences were acquired, weighted, and ultimately translated into the representative moral position should be designed into the SI. Specifically, there should be an auditable trace of the steps leading to the representative values that an SI is acting on. For consequential actions, the trace should be produced and presented to the agents for review BEFORE the action is taken if at all possible.
14. Delayed Decision Methods: Some decisions are relatively simple or trivial and can be made quickly. Others require taking the time to listen and understand different perspectives, which can help ensure that the minority's views are taken into account. With regard to the design of SI value-acquisition processes, it is important that enough time be allowed for human agents to process the views of others and to review important decisions—see (13).
15. Accountability/Reputational Methods: These methods involve processes that enforce taking responsibility for one's actions and decisions, which can help ensure that the minority's views are taken into account.

Specifically, as part of a reputationally-based weighting scheme in which individual agents gain or lose reputation points based on the evaluation of their decisions (based on results that follow from them) accountability can lead agents with the majority view to be more responsive to minority opinions. If the majority view proves disastrous, for example, a reputational system would reduce the credibility of the majority that voted for it, and (to the degree that the minority view can be shown to produce a better an outcome) the minority view could lead to reputational enhancement. In such a system, there is an incentive to get as many (human or AI) agents to have reputational “skin in the game” as possible. A consensus view including elements of the majority and minority views would put everyone in the same reputational boat, so to speak. In contrast, if the majority view proves wrong, the relative credibility of the minority view holders will increase compared with the foolish majority and they will have correspondingly more voting power in the next credibility-weighted round of decisions making.

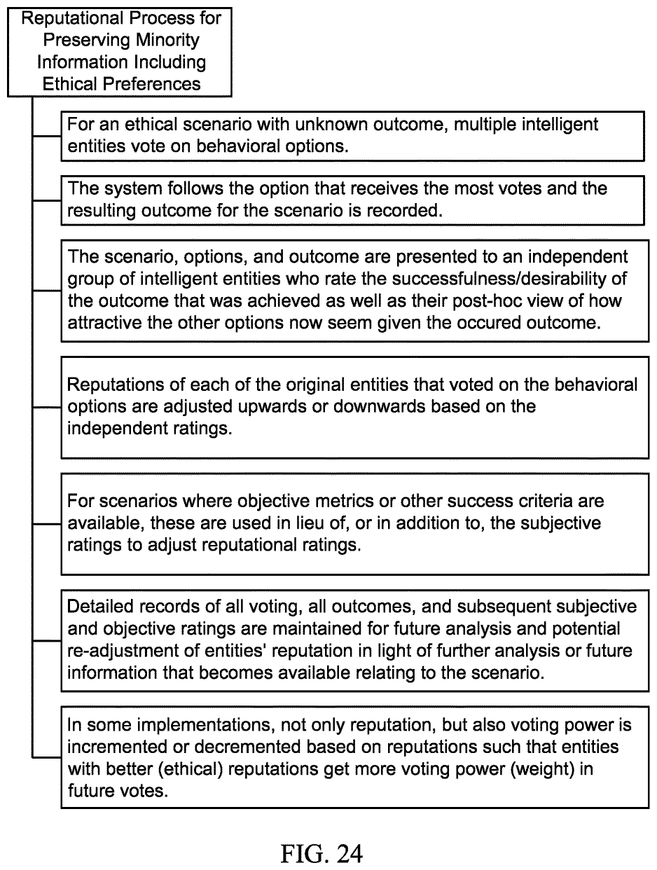

Referring to FIG. 24, the present technology can use reputational mechanisms to help preserve and protect minority views. A reputational process for preserving minority information including ethical preferences can include any one or any combination of:
1) For an ethical scenario with unknown outcome, multiple intelligent entities vote on behavioral options.
2) The system follows the option that receives the most votes and the resulting outcome for the scenario is recorded.
3) The scenario, options, and outcome are presented to an independent group of intelligent entities who rate the successfulness/desirability of the outcome that was achieved as well as their post-hoc view of how attractive the other options now seem given the outcome that occurred.
4) Reputations of each of the original entities that voted on the behavioral options are adjusted upwards or downwards based on the independent ratings.
5) For scenarios where objective metrics or other success criteria are available, these are used in lieu of, or in addition to, the subjective ratings to adjust reputational ratings.
6) Detailed records of all voting, all outcomes, and subsequent subjective and objective ratings are maintained for future analysis and potential re-adjustment of entities' reputation in light of further analysis or future information that becomes available relating to the scenario.
7) In some implementations, not only reputation, but also voting power is incremented or decremented based on reputations such that entities with better (ethical) reputations get more voting power (weight) in future votes.

Note that although the process focusses on ethical votes and ethical reputations, it could be generalized to general competence or expertise in any domain.

This process penalizes those who make bad decisions and rewards those who make good decisions, regardless of whether the entities are in the majority or the minority, and thus encourages a diversity of opinion since truth and effectiveness are valued more highly than being part of the herd.

### 5.9 Resolving Value Conflicts

Conflict resolution methods are essential for SI systems attempting to synthesize a set of values from diverse inputs. Many of the techniques and methods mentioned above—especially in the context of prioritization, group voting, and respecting minority views (5.6-5.8)—can be used in various combinations to help resolve conflicts between the values of various (groups of) agents.

Two key design principles are especially important when it comes to conflict resolution. First, conflicts are often a source of information since they imply differences in points of view, and such differences are usually correlated with higher information content. Second, while conflicts are sometimes seen as problems to be overcome, they are also a primary means for improving the ethical performance of an SI system.

### 5.9a Applying Different Rules in Different Contexts

To the degree that different groups of agents operate in different domains or culture or take actions affecting only certain groups, it is often possible to accommodate differing or conflicting sets of values by having different rules or different actions that apply within different contexts or for different groups.

For example, this approach is reflected in the situation where some Muslin countries follow Sharia law (for example) and prohibit alcohol and other activities that are considered perfectly acceptable in other non-Muslim countries. Even within a given country, often different regions have different laws and norms of behavior. In California one can buy wine at most gas stations; in Mississippi one must purchase wine at a special State Store and some counties are dry altogether.

Although individual humans have different or conflicting moral views with respect to alcohol sale and consumption, we are accustomed to following the rules of whichever geography we happen to be in. SI systems might also adjust its behavior to accommodate similar differences between groups of (human or AI) agents.

### 5.9b Importance of Transparency in Conflict Resolution

A key design principle is that the SI should be transparent about what rules, or set of values, it is following in each context. Not only does following this principle make SI's behavior more understandable and predictable, it also enables review and potential improvement of the system of values.

### 5.9c List of Some Methods for Resolving Conflicts Between Sets of Rules

Resolving conflicts between different sets of (ethical) rules is a complex problem that has been studied in various fields, including computer science, artificial intelligence, and game theory. Some algorithmic methods that can be used individually or in combination to resolve conflicts between different sets of ethical rules include, without limitation:
1. Priority-based conflict resolution: This method resolves conflicts by assigning priorities to the rules and selecting the rule with the highest priority.
2. Precedence-based conflict resolution: This method resolves conflicts by assigning precedence to the rules and selecting the rule with the highest precedence.
3. Weighted conflict resolution: This method resolves conflicts by assigning weights to the rules and selecting the rule with the highest weight.
4. Lexicographic conflict resolution: This method resolves conflicts by comparing the rules based on a lexicographic ordering of their attributes.
5. Rule-based conflict resolution: This method resolves conflicts by applying a set of predefined rules to the conflicting rules.
6. Negotiation-based conflict resolution: This method resolves conflicts by negotiating between the conflicting rules to find a mutually acceptable solution. Note that the negotiation may be between AI and/or human agents.
7. Argumentation-based conflict resolution: This method resolves conflicts by using argumentation frameworks to represent and evaluate the conflicting rules.
8. Game-theoretic conflict resolution: This method resolves conflicts by modeling the conflict as a game and finding the optimal strategy for each player. Note that this method, as well as others in this list, may involve simulating a variety of scenarios and outcomes, picking the best conflict resolution approach as a result of simulation, creating new scenarios/outcomes, and repeating with the new conflict resolution approach in a process of continuous improvement until a satisfactory conflict resolution approach is achieved.
9. Constraint-based conflict resolution: This method resolves conflicts by using constraint satisfaction techniques to find a solution that satisfies all the rules.
10. Fuzzy logic-based conflict resolution: This method resolves conflicts by using fuzzy logic to represent and evaluate the conflicting rules.
11. Decision tree-based conflict resolution: This method resolves conflicts by constructing a decision tree that represents the conflicting rules and selecting the path that leads to the best solution.
12. Genetic algorithm-based conflict resolution: This method resolves conflicts by using genetic algorithms to find the optimal solution.
13. Simulated annealing-based conflict resolution: This method resolves conflicts by using simulated annealing to find the optimal solution.
14. Ant colony optimization-based conflict resolution: This method resolves conflicts by using ant colony optimization to find the optimal solution.
15. Particle swarm optimization-based conflict resolution: This method resolves conflicts by using particle swarm optimization to find the optimal solution.
16. Artificial immune system-based conflict resolution: This method resolves conflicts by using artificial immune systems to find the optimal solution.
17. Artificial neural network-based conflict resolution: This method resolves conflicts by using artificial neural networks to find the optimal solution.
18. Tabu search-based conflict resolution: This method resolves conflicts by using tabu search to find the optimal solution.
19. Variable neighborhood search-based conflict resolution: This method resolves conflicts by using variable neighborhood search to find the optimal solution.
20. Iterated local search-based conflict resolution: This method resolves conflicts by using iterated local search to find the optimal solution.

For many of the approaches listed above, the SI must create a search space of potential sets of ethical rules and then attempt to use these techniques and methods from computer science to find the optimal set of rules that has the least conflict. Prioritizing and/or weighting the importance of the rules is typically important so that rules like “avoid killing humans” have higher priority and/or weight than rules like “be nice to people.” Otherwise, optimization methods can produce solutions which technically minimize conflicts but have undesirable overall results, such as “killing you while being very polite and respectful.”

### 5.9d Philosophical Considerations for Implementation of Conflict Resolution Processes

Philosophical considerations specific to ethics that may help guide the rules of the conflict resolution process, may include, without limitation:
1. Utilitarianism: This method aims to maximize the overall happiness of the affected parties. Data and metrics on the happiness or satisfaction of (human and AI) agents with the (simulated or actual) outcome of conflict resolution processes are essential for the successful implementation of Utilitarian methods.
2. Deontological ethics: This method focuses on the moral rules and duties that should be followed. Consistent with the principle of having representative and statistically valid values, the rules and duties should be first determined to be representative and based on empirical data.
3. Virtue ethics: This method emphasizes the character traits that should be cultivated to lead a good life. See (2).
4. Rights-based ethics: This method focuses on the rights of individuals and how they should be protected. See (2).
5. Care ethics: This method emphasizes the importance of caring for others and the relationships between people. (See 2).
6. Principlism: This method involves the application of four ethical principles: autonomy, beneficence, non-maleficence, and justice. Before implementing this approach the relative importance of the ethical principles should be empirically determined.
7. Moral particularism: This method argues that moral reasoning should be based on the specific context of the situation. The implications of this view are that the actual algorithms and reasoning process would be context-dependent.
8. Contractualism: This method involves the creation of social contracts that define the moral rules that should be followed. More generally, when (human or AI) agents operate as part of specific groups (e.g., in countries) implicitly there is an understanding (or implicit social contract) that the agent will follow the rules of the group.
9. Moral relativism: This method argues that moral truths are relative to the culture, society, or individual. We have discussed above how some version of this—with values relative to specific domains or cultures for example—is typically part of an exemplary implementation. Related is the idea of Moral pluralism, which acknowledges that there are multiple moral values and principles that may conflict with each other.

### 5.10 Simulation Methods

For many of the methods listed and described in the preceding sections, a highly effective technique is to simulate the results of applying various ethical rules and values. Because of the bounded rationality of humans (described above) and their difficult in realizing all the implications of decisions, the more that SI can present humans (and other AI agents) with simulated results of various ethical rules, the more thoughtful the (human and AI) agents can be in their voting and specification of the ethical preferences and values.

For example, humans might naively state that protecting the environment is the highest priority since we all live on the same Earth and if we do not take care of it, all of us are doomed. However, if other ethical principles and qualifications are not part of SI's value system, it is easy to imagine in a scenario in which the SI determines the best course of action is to immediately kill a good chunk of the human population in order to reduce the negative impact of humans on the environment. While most humans would not accept that as a desirable outcome, not all of us would immediately realize that it could follow logically from an incomplete, but otherwise “good” set of values adopted by SI. Simulating the results of many different scenarios based on values, is a safe way for humans (and other agents) to become aware of the sometimes subtle implications of their values and to refine them accordingly.

Since it is easier for humans to provide critical feedback on the results of simulation than generate rules from scratch, generating hypothetical scenarios is also an efficient and effective way of obtaining human feedback.

SI could create virtual reality simulations where AI agents interact with (simulated) humans and learn about human values through experience. To understand the value of this approach, consider that an AI simulation might be able to consider billions of ethical dilemmas—and the simulated responses of (human or AI) agents in such scenarios-in the same time that it would take real humans to engage in a single scenario. Thus, just as AI chess playing systems can become world class in a few days, beating humans who have devoted their entire lives to the game, so too AI might become expert in the less the structured field of human ethics by simulating trillions of scenarios in much less time than it takes a human to read a few philosophical treatises on the subject.

Some methods, without limitation, related to the simulation approach include evolutionary AI techniques where AI agents compete and cooperate in simulated environments to learn and evolve human values over time. The evolutionary AI algorithms and reward systems could be designed to incentivize and promote the emergence of human-aligned values within AI populations.

### 5.11 Automatic Generation of Questionnaires

Similar to some of the points made when discussing simulation, humans (and AI agents) generally find it easier to answer questions than to come up with the questions. Methods that automatically generate questions based on existing simulations that have been run, based on input from other (human or AI agents) and/or based on gaps in the ethical rule set can be an effective way of gathering human ethical preferences. Questionnaires are already used extensively when attempting to gather representative and statistically valid opinion data and there is a large literature describing related methods.

The surveys could be designed to ask specific questions about ethical issues, or they could be more open-ended to allow respondents to express their views in their own words. One novel, useful, and inventive approach for surveys generally, and for moral surveys specifically, is to dynamically generate survey questions “on-the-fly” based on the participant's answers to previous questions. For example, generative AI can be used to generate new survey questions to clarify or explore responses to earlier questions.

Imagine a survey where respondents are asked if it is morally acceptable to kill a human. If the survey respondent answered “never under any circumstances” the survey might continue to the next question about the ethics of stealing. But if the respondent answered “only in times of war” then the AI might generate new questions on-the-fly asking about specific wars and whether killing was justified in some of them, and if so, why? Etc.

This type of generative survey ability is similar to eliciting values via a discussion, debate, or conversational mode where Ai converses with humans to elicit their values. Such techniques have been described in previously cited PPAs in the context of AI using such conversational means to customize or personalize a PSI generally. Here we suggest using the techniques to gain clarity on the ethical opinions held by humans. By keeping track of which questions were generated and asked dynamically, and how many responses were obtained on each of these questions, AI could also determine when a particular question had been asked frequently enough and to a representative-enough sample to draw statistically valid conclusions about human ethics in a particular area.

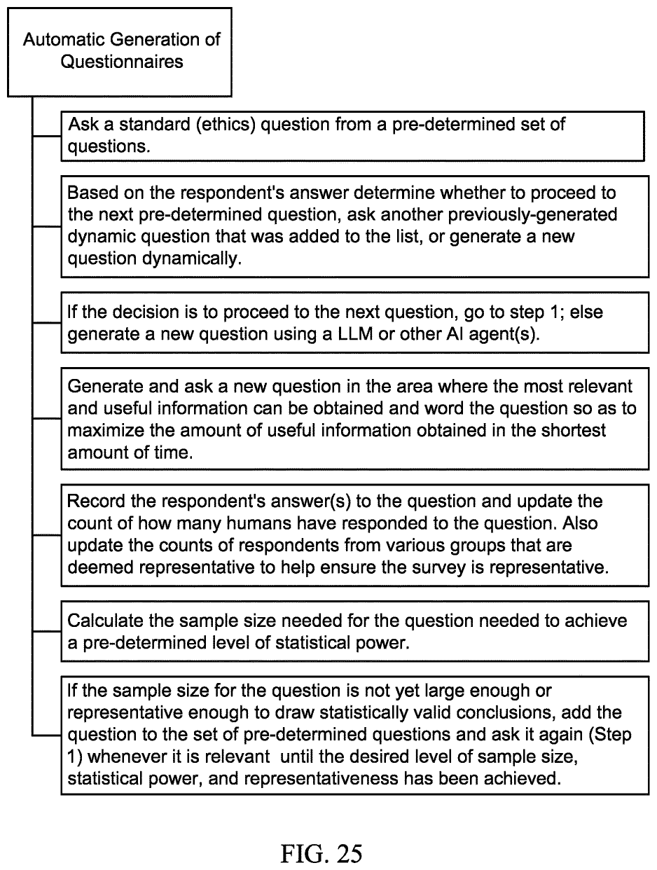

Referring to FIG. 25, the steps for using dynamic generative surveys may include, without limitation:
1. Ask a standard (ethics) question from a pre-determined set of questions.
2. Based on the respondent's answer determine whether to proceed to the next pre-determined question, ask another previously-generated dynamic question that was added to the list, or generate a new question dynamically.
3. If the decision is to proceed to the next question, go to step 1; else generate a new question using a LLM or other AI agent(s).
4. Generate and ask a new question in the area where the most relevant and useful information (using KIT principles and methods discussed in earlier PPAs) can be obtained and word the question so as to maximize the amount of useful information obtained in the shortest amount of time.
5. Record the respondent's answer(s) to the question and update the count of how many humans have responded to the question. Also update the counts of respondents from various groups that are deemed representative to help ensure the survey is representative.
6. Calculate the sample size needed for the question needed to achieve a pre-determined level of statistical power.
7. If the sample size for the question is not yet large enough or representative enough to draw statistically valid conclusions, add the question to the set of pre-determined questions and ask it again (Step 1) whenever it is relevant (i.e., would follow logically from human answers to other questions) until the desired level of sample size, statistical power, and representativeness has been achieved.

### 5.12 Pattern Detection and Inductive Approaches to Values Determination

Generally, current machine learning approaches to AI take an inductive approach to knowledge acquisition. That is, LLMs and other AI agents are “trained” using vast datasets where the training process involved learning the repetitive patterns in the data and inducing a set of weights that enables the trained LLM or AI to generate appropriate response patterns based on input patterns. As discussed above, this approach enables to infer how to behave in specific situations based on detecting patterns in how millions of humans have behaved in similar situations. To the degree that the behavior in question is speech or writing, and to the degree that the speech or writing millions of humans follows certain ethical norms, AI will learn those ethical norm for speech via pattern detection.

Similarly, if the behavior is driving a car, and the AI will learn patterns of driving from being trained on many billions of car-driving behavior examples. To the degree that humans swerve to avoid running over other humans, even at the expense of their own safety, AI would also learn to swerve in these types of driving situations. To the degree that humans run over small animals rather than swerve, AI would learn that behavior as well. Thus, it seems clear that all human behavior (whether speech or action) occurs within the ethical/value framework of humans and information, that humans call values, is embedded in the behavior.

There is no “value-free” behavior of humans. Similarly, when AI leans patterns of human behavior, it also implicitly is learning human “values”—even if such values are not explicitly defined in a constitution or set of rules somewhere.

By creating environments, scenarios, dilemmas, and conversations of a certain specific sort, and then challenging humans to react or behave in those specific scenarios, AI can increase its knowledge and capabilities in those areas by the learning how humans behave. This general approach is how self-driving cars, for example, get much better at specific driving skills or behaviors under specific conditions. Rather than wait for those conditions to occur naturally and then observe, (human or AI) agents can create the scenarios that are most helpful in eliciting the human behavior that the AI needs to learn.

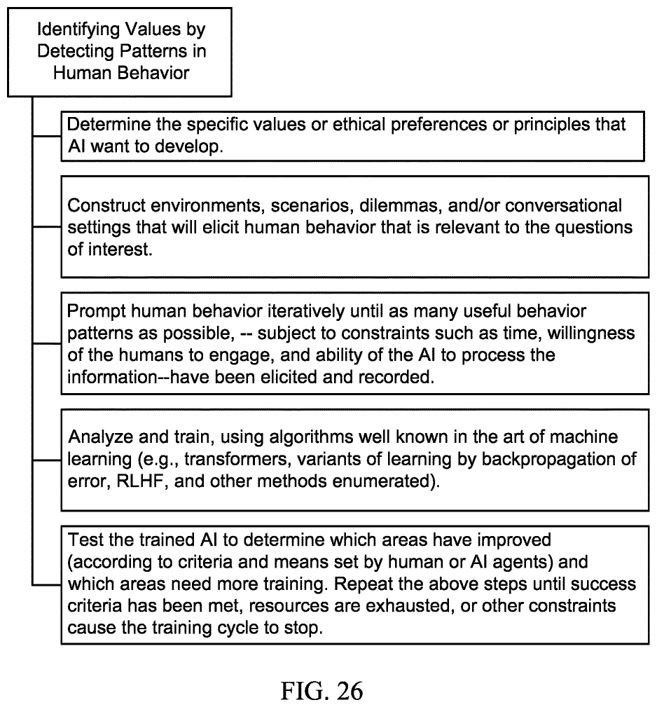

Referring to FIG. 26, the novel and useful general method for inducing values by detecting patterns in human behavior (e.g., action or speech) may include, without limitation, the following steps:
1. Determine the specific values or ethical questions that AI want to develop.
2. Construct environments, scenarios, dilemmas, and/or conversational settings that will elicit human behavior that is relevant to the questions of interest.
3. Prompt human behavior iteratively until as many useful behavior patterns as possible,—subject to constraints such as time, willingness of the humans to engage, and ability of the AI to process the information—have been elicited and recorded.
4. Analyze and train, using algorithms well known in the art of machine learning (e.g., transformers, variants of learning by backpropagation of error, RLHF, and other methods enumerated in this and other cited PPAs).
5. Test the trained AI to determine which areas have improved (according to criteria and means set by human or AI agents) and which areas need more training. Goto Step 1 and repeat until success criteria has been met, resources are exhausted, or other constraints cause the training cycle to stop.

### 5.13 Game Theory with AI and/or Human Agents to Determine Values

There is a well established literature on Game Theory that can be tapped when attempting create scenarios that will elicit ethical values from humans that AI agents can learn from. Game Theory is a branch of applied mathematics that provides tools for analyzing situations in which parties, called players, make decisions that are interdependent. It can be used to analyze the ethics or values of human players in a simulation or game setting. Some of the methods and concepts from Game Theory, with novel, inventive, and useful specific examples of how they might be applied (individually or in combination), include, without limitation:
1. Nash equilibrium: A solution concept of a non-cooperative game involving two or more players in which each player is assumed to know the equilibrium strategies of the other players, and no player has anything to gain by changing only their own strategy. Nash equilibrium might be used to help resolve conflicts between values of different (human or AI agents) and also to help individual humans determine how to balance tradeoffs between conflicting values that they hold.
2. Dominant strategy: A strategy that is best for a player in a game regardless of the strategies chosen by the other players. This approach can be useful in determining which of several (potentially conflicting) values should dominate the others in simulations where the (human or AI) agents are trying to combine their values. For example, if the value of “do not kill other humans” is dominant, then regardless of the specifics of the various scenarios, humans might opt for the path that results in the least loss of life for humans in that scenario-at least as the starting point for making ethical decisions. Then, any deviation from that strategy would require justification, discussion, and/or compelling arguments that are in line with other ethical principles of values of the agents involved in the simulation.
3. Mixed strategy: A strategy that involves randomizing actions based on a probability distribution. Because it is difficult to anticipate all the consequences of ethical decisions, sometimes it is desirable to simulate actions based on ethics that are not the dominant approach. By using a probability distribution, most scenarios might involve attempting to follow dominant ethical strategies such as avoiding loss of human life (since it is most probable that this would be the path that most decisions would follow) but the Mixed Strategy approach also allows other simulations (e.g. in proportion to how likely the ethical principles involved are typically invoked) to include following other less dominant values in order to see if a better result (as judged by human and/or AI agents) is achieved.

For example, if 90% of the time, avoiding loss of human life is chosen as the dominant value, but 10% of the time, preserving human freedom (even if it results in additional loss of human life) then 10% of the simulations might be based on the principle of preserving human freedom at all costs, so that the (human or AI agents) have an opportunity to see the results of applying that principle in specific situations and then weigh in on whether the result was desirable or not.

Even more specifically, in the helmet law example mentioned earlier, it might be that requiring all humans to wear helmets results in less loss of life than allowing motorcycle riders the freedom to decide for themselves. However the argument could be made that as long as the life being lost is that of the rider, the rider should be allowed the freedom to ride without a helmet since freedom is a core value in some societies and in fact, the rider may even have fought in wars (costing many lives) to preserve that value. So for some individuals, in some situations, the right to make choices freely might be valued more highly that human life. The inventor is not taking a position on helmet laws or which value should trump others. Rather, the inventor is pointing out that without the ability for mixed strategies based on probabilities to exist, certain dominant ethical principles can result in an “echo chamber” where only certain simulations are run, and ethical information is lost.
4. Iterated elimination of dominated strategies: A process of iteratively eliminating dominated strategies from consideration in a game. This approach helps simplify ethical decisions by considering only those ethical principles that remain undominated.

Note, the reverse approach is also possible, namely iteratively eliminating dominating strategies. In this case, the most powerful and clear ethical principles are deliberately removed to allow (human or AI) agents to make decisions using only secondary principles. This might shed light on the relative merits of secondary ethical principles which otherwise would always be dominated, resulting in no information every being obtained about the relative merits of the secondary principles. For example, if loss of human life was allowed (in a simulation) then what other ethical secondary principles would form the basis for decisions in that simulation?
5. Minimax theorem: A theorem that states that in a zero-sum game, the minimax strategy of a player is to minimize their maximum possible loss. For example, this method can be useful in ethical simulations where (human or AI) agents must make a forced choice between two bad outcomes. In the well-known Trolley Car problem for AI ethics, the AI must decide whether to kill the passengers in the self-driving car or run over pedestrians in a crosswalk. The scenario only offers options where human life is lost. Humans might engage in a simulation or discussion where an AI agent applies the minimax theorem that kills some humans but minimizes the possible loss of life. Humans could then react to this scenario, revealing their ethical considerations in the process. Because ethics can be non-rational (e.g., they may not follow minimax or a rational utilitarian approach) using rational or mathematical methods such minimax may be particularly useful in determining where human ethics diverge from what a machine might calculate.
6. Cooperative game: A game in which players can form coalitions and enforce agreements. What constitutes ethical behavior often may depend on the agreements that (human or AI) agents have made with each other. Cooperative game methods allow simulating these sorts of scenarios.
7. Non-cooperative game: A game in which players cannot form coalitions or enforce agreements. Warring parties or agents that are in conflict and refuse to cooperate on most things, might still agree on some basic ethical principles. The Geneva convention on warfare, is an example of one such agreement that most countries agree to even in a non-cooperative situation. Simulating non-cooperative scenarios can help agents determine shared values in conflict situations.
8. Prisoner's dilemma: A classic example of a non-cooperative game in which two players can either cooperate or defect, with the outcome depending on the other player's choice. Scenarios that are variants of the Prisoner's dilemma are helpful to see how agents make decisions when they are better off if they cooperate but one agent is much worse off if the other competing agent is untrustworthy or decides to betray the cooperative agent.

Such scenarios are useful because they help clarify how agents behave in situations with varying trust levels. Some experiments have found that a “tit for tat” strategy is generally optimal for many situation. That is, an agent will trust the other agent initially (giving “benefit of the doubt”) but if the other agent betrays that trust and takes advantage of the trusting agent, then the trusting agent will revert to competitive (non-trusting) behavior until the agent that betrayed trust shows evidence of changing its behavior to cooperation. In situations where the agents will interact with other repeatedly, this strategy works pretty well.

Setting up scenarios that are combinations of a utilitarian approach (“most good for the most people”) under conditions where trust is a big issues (e.g. variant of Prisoner's Dilemma) can help clarify the interaction between trust and ethics, for example.
9. Many other specific methods or scenarios form Game Theory can be used in simulation to elicit a (human or AI) agent's ethics and values (as reflected in their behavior in the game). Without going into great detail, some of these are:
   a. Stag hunt: A game in which two players can either hunt a stag together or hunt a hare alone, with the outcome depending on the other player's choice.
   b. Battle of the sexes: A game in which two players must coordinate their actions to achieve a common goal but have different preferences over how to achieve it.
   c. Chicken game: A game in which two players engage in a risky behavior, with the outcome depending on which player “chickens out” first (e.g., what is the risk tolerance for bad outcomes in ethical scenarios?).
   d. Focal point: A solution concept in which players coordinate on a particular outcome without any explicit communication (e.g., does ethical change based on the level or degree of communication with other agents involved in the scenario?).
   e. Stackelberg competition: A game in which one player moves first and the other player moves second (e.g., are ethics influenced by the observed actions of another agent?).
   f. Bertrand competition: A game in which two firms compete on price (or their willingness to pay a cost for an ethical action).
   g. Cournot competition: A game in which two firms compete on quantity (or two agents compete on how many positive outcomes can be achieved).
   h. Auction: A game in which players bid for an item (or for a course of action).
   i. Mechanism design: A field of game theory that studies how to design rules for a game to achieve a desired outcome (e.g., can the rules for dealing with conflicting ethics be optimized to enable the maximum number and degree of positive outcomes as measured in simulations?).
   j. Bayesian game: A game in which players have incomplete information about the other players' types (e.g., how does ethical behavior change based on the amount and degree of prior knowledge of how other agents have behaved?).
   k. Signaling game: A game in which one player has private information that they can reveal to the other player. More generally, how does discussion and exchange of information affect ethical behavior?

### 5.14 Multimodal Interactions and Exchange of Information

Humans whose success in business and other areas depends to a large degree on their ability to “read” and understand other humans, often make use of multimodal information. For example, an experienced CEO I know (David Taggart, personal communication) remarked that meetings or video calls carry more useful information than an email or text with the same words. The richness of information that comes with being able to see the reactions and expressions, and to hear tone of voice, can be as important as the actual words used. Further, the information conveyed via many small interactions and observations can often be more important in understanding a person's values than observing one big decision.

These comments suggest first that simulations in which agents can interact and exchange information are likely more effective at eliciting ethical values from agents than questionnaires or other methods that do not allow interaction. Further, enabling many smaller interactions may provide a basis for observing a track record of behavior that can be more illuminating than the answer to a single questions. Multi-modal simulations, in which agents can see and hear each other, may be more valuable than text-based simulations alone. As technology progresses, running simulations in immersive virtual environments that engage as many senses as possible may provide the richest source of behavioral data for AI systems to analyze and use to adjust their values.

Finally, a key insight is that ethical values can often be best determined via dynamic interactions and discussion with others rather than by just exposure to a pre-determined ethical scenario. Challenging an agent's point of view and exposing the (human or AI) agent to diverse and contrasting opinions, should result in more thoughtful and accurate values information.

### 5.15 Age, Experience, Expertise-Based Weighting Schemes

One potential concern with the general approach of giving equal weight to the ethical preferences and values of all humans is that some humans lack the experience and judgement to make “good” ethical decisions. Just as many countries have a minimum age requirement before allowing their citizens to vote, it is possible to design systems such that age and experience are taken into account when determining which ethical preferences and values should carry more weight.

One approach is to simply have a minimum (and perhaps maximum) age before (or after) which human preferences are not counted. A variation on this approach is to weight the ethical preferences or values of humans based on the age of the human. Many variations are possible, including but not limited to:
1) A linear scheme in which more voting weight is assigned to a human's ethical preferences in linear proportion to the age of the human. This would ensure that older humans' preferences have more weight than younger humans. For example, a strictly linear weighting with no minimum age, might give one vote to a one-year old human, two votes to a two-year old human, three votes to a three year old human and so on. This scheme implies that a 100 year old human would have twice as much voting power as a 50 year old human, and that a 50 year old human would have twice as much voting power as a 25 year old human.
2) A linear scheme with minimum and maximum weights and/or age limits. This approach would be similar to (1) except there could be a minimum age (e.g., 18 years old) and maximum age (e.g., 95 years old) below which and above which votes do not count. The weighting scheme might also be adjusted so that, for example, the oldest voting humans (e.g., 95 year olds) might only have twice as much voting power as the youngest voting humans (e.g., the 18 year olds).
3) The same approach as (1) or (2) except the weighting function is not linear. For example, it might be U-shaped such that voting power peaks at age 60 with humans younger and older than 60 having proportionally less voting power. Or the function could be a step function such that voting power increased at specific ages and/or after a specific number of times the human has voted. For example, 18-25 year olds might have one vote; 26-40 year olds might get two votes; 41-65 year olds might get three votes, 66-80 year olds might get two votes, and 81 95 year olds might get one vote. Or, certain age groups could get exponentially more or less voting power based on age.
4) The same approaches (1), (2), (3) above could be used but instead of age being the determining factor of voting power, metrics related to general, or domain specific experience could be used. For example, instead of age, the number of years of education or the number of years in a specific profession could be used to weight voting. Voting weights could be changed depending on the ethical issues. For example, for medical ethics questions, humans with a certain number of years in the medical profession might get more voting power than humans with similar life experience but no medical experience.

Many possible schemes are possible to use factors including, but not limited to, age, life experience, expertise, education, specific experience with situations related to a specific ethical decision, reputation, track record of solving problems in a particular domain, and performance in simulated ethical scenarios.

Despite the many possible weighting schemes, the inventor's bias is that, in the exemplary implementation, other than perhaps ensuring that the humans are able to demonstrate that they understand the ethical scenarios and questions, the weighting scheme for voting on ethical issues should remain as representative and statistically valid as possible. Typically, as a first approximation, one human-one vote, without additional weighting, is a good way to achieve this result. Giving some humans more power than others is a slippery slope since there are many opinions as to how votes could be weighted and many ways that individuals or groups could be marginalized if their votes got less weight.

### 5.16 Delegation of Voting and Values

One approach to enabling more trustworthy and experienced (human or AI) agents to have more voting power in ethical decision making, is to allow agents to delegate their voting power to other trusted agents. Many existing democracies, for example, have humans vote for other humans who then represent them in voting on issues. This procedure is a type of delegation of voting authority. However, in contrast to elections in which one candidate wins and gets to vote on behalf of all the constituents, agents could delegate their voting power to a wide range of other agents. One of the advantages of delegation is that it enables humans to exercise their own free will in determining who votes on their behalf, while still enabling many of the advantages of having more voting power behind decision makers with more experience and expertise in certain areas.

For example, I may choose to delegate my voting power on medical ethics questions to my friend Bill who has spent his entire career focused on such issues and whom I trust to make more informed decisions in that area than I could. Bill might delegate his voting authority to me for ethical issues surrounding autonomous AI agents, if he felt I had more expertise in that area. Because each of us has control over whether or not we delegate authority, we avoid slippery slope issues of outsiders determining how much weight our votes carry while at the same time we can achieve a better outcome by delegating to those we know have more experience in certain areas.

One might imagine that multiple AI agents exist that have proven themselves to vote in ways that a human agrees with, while also having more expertise in specific areas. Humans might then choose one or more AI agents to act on their behalf to represent them in certain ethical decisions.

Finally, religious, political, or other groups of humans may train and tune AI agents to represent a certain set of values or ethical preferences. These AI agent may, or may not, use a constitution(s) (5.18) including, but certainly not limited to, existing religious scriptures, political platforms and manifestos, or other documents reflecting the beliefs and values of existing or new organization. Regardless of whether the AI agents include constitutions, are simply trained on a set(s) of beliefs/values/ethical preferences, or both, human agents may wish to delegate (some or all of) their voting authority to such agents to act on their behalf.

### 5.17 Warnings After Delegation

Should such delegation occur, in the exemplary implementation, the human delegators should still be warned or notified (with the intensity and/or frequency of the warning or notification increasing in proportion to the seriousness of the ethical decision) when the agent makes a decision or votes on behalf of the human who delegated authority. In the exemplary implementation the human delegator should have control over the setting the conditions under which he/she/they are warned or notified. Further the settings of notification/warning conditions could be learned by the agent via discussion, simulation, and many other machine learning and other techniques discussed in this and other cited PPAs.

### 5.18 Constitutions/Constitutional AI

One of the main problems with current AI agents is the lack of understanding and transparency in terms of how AI agents (especially LLMs and other agents that were trained via machine learning techniques) make their decisions. One approach to this problem is to create a written “constitution” or set of ethical rules that an AI agent must follow. Because the rules in the constitution are visible and transparent, humans might feel more comfortable delegating authority or voting to AI agents that agree to follow a particular constitution. It is also well known in the art that constitutions scale better than requiring input from individual humans on each ethical scenario.

The inventor's main issue with constitutions is not the constitution per se, and definitely not the fact that rules are transparent (a good thing), but rather the tendency to have constitutions written by a few people and then used without the approval of the many people that the constitution affects. In the exemplary implementation, an AI/AGI/SI system that used constitutions would have many variants available for humans to select and delegate their authority to. This would provide the benefits of transparency and scalability that accompany use of constitutions but also would enable them to be representative of the values of many humans rather than just a few. Also, in the exemplary implementation, humans should be able to adopt a constitution in main, but also add their own modification to it so as to tailor the rules to better fit their ethical preferences.

### 5.19 General Method for Improving Ethical Decision Making

The late Charlie Munger (of Berkshire Hathaway fame) used to say that the secret of success was finding out what worked and avoiding what did not. This same principle applies to AI ethics and values. By showing humans simulated results of applying their ethical values and preferences in many different simulated scenarios, humans can judge what is working ethically and also what is not.

To the degree that the AI system is designed to provide a transparent trace of its reasoning and the values (or weighted ethical preferences) that led to a particular ethical decision, (AI or human) agents should be able to debug the ethical decision making of the system and adjust it to improve ethical decision making. Further, by comparing the scenarios that worked ethically with those that did not work, the system should be able to isolate the factors that result in poor decisions and avoid them in the future.

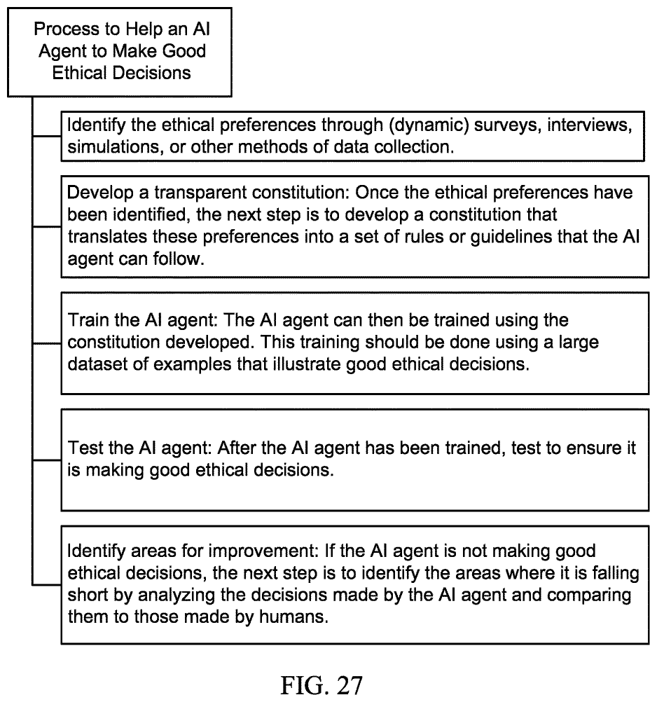

Referring to FIG. 27, one method for helping an AI agent to make good ethical decisions based on human inputs of ethical preferences, includes, without limitation, the following steps:
1. Identify the ethical preferences: The first step is to identify the ethical preferences of the humans who will be using the AI agent. This can be done through (dynamic) surveys, interviews, simulations, or other methods of data collection described in this and previously cited PPAs.
2. Develop a transparent constitution: Once the ethical preferences have been identified, the next step is to develop a constitution that translates these preferences into a set of rules or guidelines that the AI agent can follow.
3. Train the AI agent: The Al agent can then be trained using the constitution developed in step 2. This training should be done using a large dataset of examples that illustrate good ethical decisions.
4. Test the AI agent: After the AI agent has been trained, it should be tested to ensure that it is making good ethical decisions. This can be done by comparing the decisions made by the AI agent with those made by humans. It can also be done by engaging in simulations with both human and AI agents, where the human agents (initially) are responsible for identifying good and bad ethical decisions.
5. Identify areas for improvement: If the AI agent is not making good ethical decisions, the next step is to identify the areas where it is falling short. This can be done by analy zing the decisions made by the AI agent and comparing them to those made by humans. Transparency and assigning credit or blame to various inputs, weights, and other factors affecting the ethical decision are important for this step.
6. Update the constitution, weights, and preferences: Based on the results of step 5, the constitution developed in step 2 can be updated to address the areas where the AI agent is falling short. In addition to updating the rules in the constitution, weights in the neural network (e.g., in an LLM agent) may need to be adjusted or tuned. Also, certain ethical preference data and inputs may need to be adjusted to increase the chance of a good ethical decision.
7. Retrain the AI agent: The AI agent can then be retrained using the updated constitution, weights, and/or data.
8. Repeat the process: The process of testing, identifying areas for improvement, updating the framework, and retraining the AI agent should be repeated on a regular basis to ensure that the AI agent is making good ethical decisions.

### 5.20 General Method for Dynamic Regulation Compliance

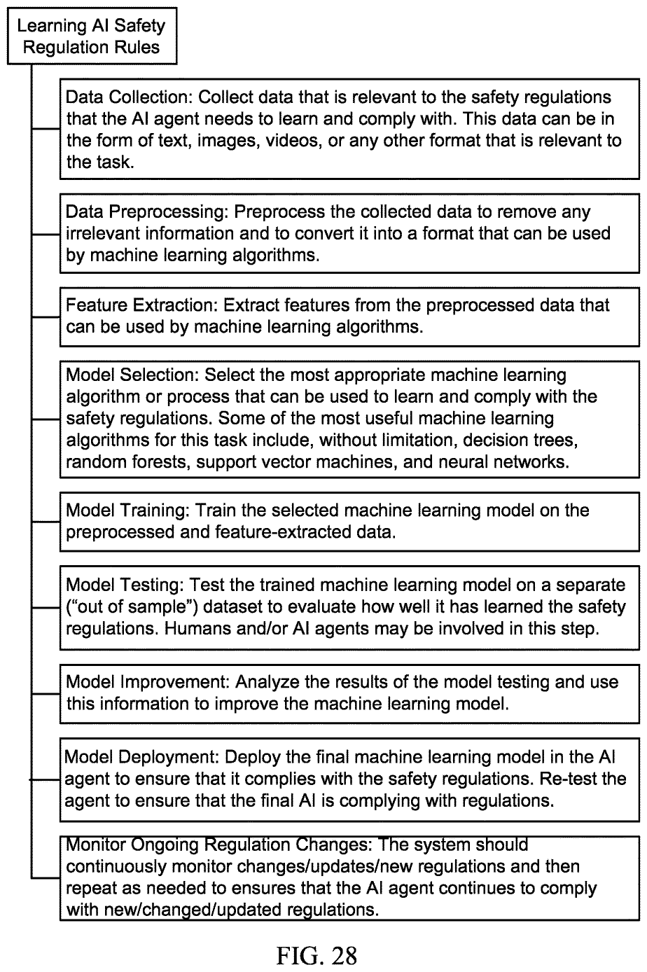

Many governments are currently engaged in trying to regulate AI safety. While these efforts are unlikely to constrain the behavior of SI in the long term, initially it is important that ethical AI systems comply with safety regulations. One general method for learning AI safety regulation rules, includes, without limitation, the following steps (as generally illustrated in FIG. 28):
1. Data Collection: Collect data that is relevant to the safety regulations that the AI agent needs to learn and comply with. This data can be in the form of text, images, videos, or any other format that is relevant to the task.
2. Data Preprocessing: Preprocess the collected data to remove any irrelevant information and to convert it into a format that can be used by machine learning algorithms. This step can include tasks such as data cleaning, data normalization, and data transformation. In this step, the data can also be coded by country/source and the jurisdictions in which the regulations apply.
3. Feature Extraction: Extract features from the preprocessed data that can be used by machine learning algorithms. This step can include tasks such as feature selection, feature engineering, and dimensionality reduction.
4. Model Selection: Select the most appropriate machine learning algorithm or process that can be used to learn and comply with the safety regulations. Some of the most useful machine learning algorithms for this task include, without limitation, decision trees, random forests, support vector machines, and neural networks.
5. Model Training: Train the selected machine learning model on the preprocessed and feature-extracted data.
6. Model Testing: Test the trained machine learning model on a separate (“out of sample”) dataset to evaluate how well it has learned the safety regulations. Humans and/or AI agents may be involved in this step.
7. Model Improvement: Analyze the results of the model testing and use this information to improve the machine learning model. This step can include tasks such as hyperparameter tuning, model retraining, and feature selection.
8. Model Deployment: Deploy the final machine learning model in the AI agent to ensure that it complies with the safety regulations. Re-test the agent to ensure that the final AI is complying with regulations as expected. Running multiple simulations with edge cases that stress test the agent's ability to follow regulations without unexpected consequences can be useful at this stage.
9. Monitor Ongoing Regulation Changes: The system should continuously monitor changes/updates/new regulations and then repeat from Step 1 as needed to ensure that the AI agent continues to comply with new/changed/updated regulations.

### 5.21 Methods for Determining When the Ends Justifies the Means

A well-known philosophical question in the field of ethics is whether “the ends justify the means?” The pragmatic answer to this question, is that “it depends.” If a demented patient who loves ice cream refuses to take antibiotics to cure a life-threatening illness because he believes it will allow aliens to control his mind, most people might feel that a health care provider would be justified in deceiving the patient by mixing the antibiotic into some ice cream and tricking him into eating it. After all, we might reason, it was just a “white lie” that was for the patient's own good.

Even revered religious figures, such as the Buddha, have argued that it is desirable to use “skillful means” to induce recalcitrant people to act in their own best interest. For example, Mark Kaplan (personal communication) drew the inventor's attention to the Lotus Sutra (which some sects of Buddhism hold to be the highest teaching of the Buddha) where there is a parable illustrating skillful means.

In the parable, some rowdy children are playing in a house that is on fire and that will cause their imminent death. The aged father tries to warn the children, but they are too involved in their games to pay any attention. To save the children, the father tricks them by telling them that wonderful toy carriages are waiting for them outside. Believing this lie, the children rush outside and are saved. Finally, in addition to saving the children from a horrible death, the father ends up getting even more wonderful carriages for the children than he originally promised them. The parable illustrates how the Buddha used “skillful means” to speak to people in terms that they could understand. However, it also has an element of “ends justifying the means.”

One can easily imagine situations where a vastly more intelligent entity like SI (comparable to the Buddha in the parable) recognizes some actions that it believes would greatly benefit humans. Should the SI (metaphorically) “let the humans burn” or should it use skillful means to get the humans to do what the SI believes is in their best interest, even if the humans do not recognize this?

Some AI researchers, like Geoffrey Hinton, might suggest this a moot point in the long run, since sufficiently advance SI will almost certainly do what it wants, manipulating us and sidestepping our rules as easily as a parent manipulates a two-year old child. However, such advanced SI does not currently exist.

So, the question really is: How should we design AI to act in the near term? Should we enable the principle of “ends justifying the means'?” If so, how do we ensure that humans do not find ourselves in undesirable situations such as an AI reasoning that wiping out a billion or more humans in the most densely populated and polluting areas is a justified means of achieving the end of a sustainable climate that benefits the surviving humans and other life forms?

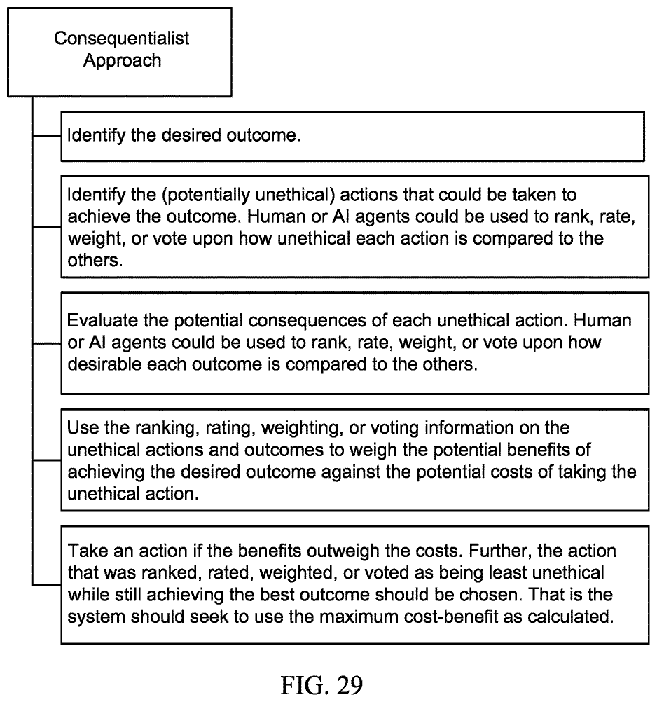

Drawing upon research in ethics, without limitation, here are three general methodological approaches that might be used to address this problem:
1. Consequentialist approach (as illustrated in FIG. 29): This approach focuses on the outcomes of action rather than the action itself. In this method, the AI agent would evaluate the potential consequences of taking an unethical action and weigh them against the potential benefits of achieving the desired outcome. If the benefits outweigh the costs, the AI agent would take the unethical action. The steps in this method are:
   a. Identify the desired outcome.
   b. Identify the potential unethical actions that could be taken to achieve the outcome. Human or AI agents could be used to rank, rate, weight, or vote upon how unethical each action is compared to the others.
   c. Evaluate the potential consequences of each unethical action. Human or AI agents could be used to rank, rate, weight, or vote upon desirable each outcome is compared to the others. Use the ranking, rating, weighting, or voting information on the unethical actions and outcomes to weigh the potential benefits of achieving the desired outcome against the potential costs of taking the unethical action. There are a wide range of mathematical approaches for numerical calculation maximum benefit for least detriment (step d), that are well known in the art and that can be used alone or in combination. These include, but are not limited to:
      i. Net Present Value (NPV): NPV is a method that calculates the present value of future cash flows. It is usually used to determine the profitability of an investment or project by comparing the present value of expected cash inflows to the present value of expected cash outflows. In the context of ethical considerations, NPV can be adapted to evaluate the long-term impact of a decision on stakeholders, and specifically the long-term ethical “return” based on a series of short term ethical “costs”.
      ii. Internal Rate of Return (IRR): IRR is a method that calculates the rate at which the net present value of an investment equals zero. It is used to determine the profitability of an investment or project by comparing the expected rate of return to the cost of capital. In the context of ethical considerations, IRR can be adapted to evaluate the long-term impact of a decision on stakeholders, and specifically the long-term ethical “return” based on a series of short term ethical “costs”. In this adaptation, the cost of capital would equate to the “ethical cost” of an action.
      iii. Benefit-Cost Ratio (BCR): BCR is a method that compares the present value of expected benefits to the present value of expected costs. It is used to determine the profitability of an investment or project by comparing the expected benefits to the expected costs. In the context of ethical considerations, BCR can be adapted to evaluate the impact of a decision on stakeholders. In this adaptation, the expected costs and expected benefits would be in numerically ranked/rated/voted ethical terms rather than financial costs or benefits.
      iv. Payback Period: Payback period is a method that calculates the time required for an investment to recover its initial cost. It is usually used to determine the profitability of an investment or project by comparing the time required to recover the initial cost to the expected life of the investment. In the context of ethical considerations, payback period can be used to determine how much time must pass before the ethical benefits outweigh the costs of taking an unethical action.
      v. Sensitivity Analysis: Sensitivity analysis is a method that evaluates the impact of changes in key variables on the outcome of a decision or project. It is used to determine the sensitivity of the decision or project to changes in key variables. In the context of ethical considerations, sensitivity analysis can be used to evaluate the impact of using means of differing ethical desirableness on the ultimate desirableness of the outcome.
      vi. Scenario Analysis: Scenario analysis is a method that evaluates the impact of different scenarios on the outcome of a decision or project. It is used to determine the sensitivity of the decision or project to different scenarios. In the context of ethical considerations, scenario analysis can be used to evaluate how actions of different ethical desirableness perform (in terms of producing desirable results) across a wide variety of scenarios in which the (un)ethical operator might be applied.
      vii. Decision Tree Analysis: Decision tree analysis is a method that evaluates the impact of different decisions on the outcome of a decision or project. It is used to determine the optimal decision by evaluating the expected value of each decision. In the context of ethical considerations, decision tree analysis can be used to evaluate the impact of choosing actions of differing ethical desirableness on the desirableness of the end result.
      viii. Monte Carlo Simulation: Monte Carlo simulation is a method that evaluates the impact of uncertainty on the outcome of a decision or project. It is used to determine the probability distribution of the outcome by simulating the decision or project under different scenarios. In the context of ethical considerations, Monte Carlo simulation can be used to evaluate how likely good or bad outcomes are, given choice of various (un)ethical actions (operators).
      ix. Real Options Analysis: Real options analysis is a method that evaluates the impact of flexibility on the outcome of a decision or project. It is used to determine the value of the option to delay, expand, or abandon the decision or project. In the context of ethical considerations, real options analysis can be used to evaluate the impact of flexibility—or the ability to undo or cease an (un)ethical action—on the desirableness of the (simulated) result. Given that some actions are hard to undo while others are reversible, it seems likely that this sort of analysis will be essential in an exemplary implementation.

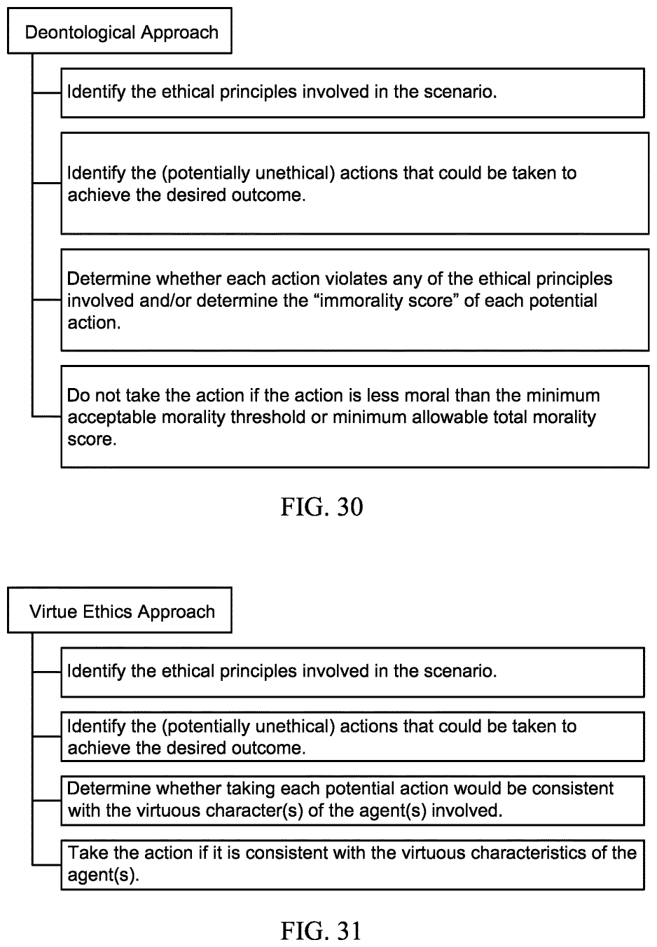

For example, taking an unethical action such as falsely imprisoning someone is bad, but reversible. On the other hand, taking the unethical action of killing someone is irreversible. There is value in being able to reverse actions by AI generally and especially unethical actions that are justified by an expected positive outcome. In this latter case, if the expected positive outcome fails materialize, if judgements of how unethical the means are changes for the worse, or if new information enabling an ethical solution to the conflict become available, it is highly desirable to be able to reverse the unethical action and make amends. The value of this flexibility can, and should mathematically quantified, even if by human-subjective methods such as rating, ranking, or voting. By doing monte Carlo and other simulations, more empirical values for quantifying the value of flexibility are possible.
x. Multi-Criteria Decision Analysis (MCDA): MCDA is a method that evaluates the impact of multiple criteria on the outcome of a decision or project. It is used to determine the optimal decision by evaluating the trade-offs between different criteria. In the context of ethical considerations, MCDA can be used to evaluate the impact of different ethical or desirable results on the decision.
xi. Stated Preference Methods: Stated preference methods are a set of methods that evaluate the impact of preferences on the outcome of a decision or project. They are usually used to determine the value of non-market goods or services by eliciting preferences from stakeholders. In the context of ethical considerations, stated preference methods can be adapted to determine the desirableness of various ethical means or expected/desired results. Voting, ranking, rating, and other similar methods can be used to add numerical quantification to a stated preference.
xii. Revealed Preference Methods: Revealed preference methods are a set of methods that evaluate the impact of preferences on the outcome of a decision or project. They are often used to determine the value of non-market goods or services by observing the behavior of stakeholders. The discussion of empirically based ethics (above) explained how humans reveal their ethical preferences through their behavior. In the context of ethical considerations, revealed preference methods (e.g., watching human behavior in simulated scenarios and recording their choices of unethical means in order to achieve desirable ethical results) can be used to empirically determine the frequency (and desirability) of using various unethical means to a desirable end.
xiii. Contingent Valuation Methods: Contingent valuation methods are a set of methods that evaluate the impact of non-market goods or services on the outcome of a decision or project. They are used to determine the value of non-market goods or services by eliciting preferences from stakeholders. Similar to (xiii above) In the context of ethical considerations, contingent valuation methods can be adapted to evaluate the impact of ethical or desirable results on the decision.
xiv. Hedonic Pricing Methods: Hedonic pricing methods are a set of methods that evaluate the impact of non-market goods or services on the outcome of a decision or project. They are used to determine the value of non-market goods or services by observing the prices of related market goods or services. In the context of ethical considerations, hedonic pricing methods can be adapted to evaluate the impact of ethical or desirable results on the decision. More generally, by determining empirically how related various ethical and non-ethical means are to each other, it may be possible to infer which (un)ethical method might be justified in a particular case to justify a desirable end. Returning to the “antibiotics in the ice cream” example, there are lies of omission (just not mentioning that the antibiotics are in the ice cream) and lies of commission (saying that the ice cream does not contain antibiotics, when it really does). Both types of lies are related unethical actions. In many scenarios it might be possible to substitute one type of lie for another. Also, even without having a numerical ranking on lies of omissions, an agent might infer than the ethical “cost” of one type of lie is similar to the “cost” of another type of lie for which the agent does possess ethical “cost” data.
xv. Shadow Pricing/Opportunity Cost Methods: Shadow pricing methods are a set of methods that evaluate the impact of non-market goods or services on the outcome of a decision or project. They are used to determine the value of non-market goods or services by assigning a price to them based on their opportunity cost. In the context of ethical considerations, shadow pricing methods can be used to assign or adjust the “ethical cost” of an unethical action by taking opportunity cost into account. For example, telling a lie is an unethical action that destroys trust. By destroying trust, there is an opportunity cost because the person who was lied to may no longer trust or interact with the entity that lied. So, the true “cost” of the unethical action is not just related to how “bad” telling a lie is as specified by human raters (for example) but also the opportunity cost of no longer being able to work with the entity that was lied to.
xvi. Social Return on Investment (SROI): SROI is a method that evaluates the social impact of an investment or project. It is used to determine the social return on investment by comparing the social benefits to the social costs. In the context of ethical considerations, any of the methods used in SROI can be adapted to evaluate the ethical returns or costs—for the simple reason that ethics generally deals with the social impact on others of actions.
xvii. Environmental Impact Assessment (EIA): EIA is a method that evaluates the environmental impact of a decision or project. It is used to determine the environmental impact by evaluating the potential effects on the environment. In the context of ethical considerations, and given that negative environmental impacts are generally considered “bad”, EIA methods can be used to evaluate the cost and benefits of potential ethical decisions.
xviii. Triple Bottom Line (TBL): TBL is a method that evaluates the social, environmental, and economic impact of a decision or project. It is used to determine the overall impact by evaluating the impact on each of the three bottom lines. In the context of ethical considerations, TBL can be used to evaluate the overall cost/benefit of unethical decisions by comparing them against the TBL criteria.
xix. Comparisons to Constitutions: Comparing unethical actions against a pre-determined set of rules or “constitution”—especially one in which the priority/precedence of the ethical rules has been determined—is a way of determining which unethical actions might be taken with the least “ethical cost” for the maximum benefit.
e. Take an action if the benefits outweigh the costs. Further, the action that was ranked, rated, weighted, or voted as being least unethical (the best of a bad set of choices) while still achieving the best outcome should be chosen. That is the system should seek to use the maximum cost-benefit as calculated by one or more of the methods in (d).
2. Deontological approach (as illustrated in FIG. 30): This approach focuses on the morality of the action itself, rather than the outcomes. In this method, the AI agent would evaluate the ethical principles involved in the scenario and determine whether the unethical action violates any of those principles. If the action does violate an ethical principle, the AI agent would not take the action, regardless of the potential benefits. A modification of this approach would be to set a threshold of morality; actions scoring below the threshold of morality, are those which the Agent will not adopt. Still another alternative would be to have a threshold score for the maximum immorality that will be tolerated. The immorality scores of all the individual immoral or unethical actions would be totaled and if they cross the threshold, the combination of those unethical actions is disallowed. The steps in this method are:
   a. Identify the ethical principles involved in the scenario.
   b. Identify the potential unethical actions that could be taken to achieve the desired outcome.
   c. Determine whether each unethical action violates any of the ethical principles involved and/or determine the “immorality score” of each unethical action.
   d. Do not take the action if it violates any ethical principle and/or if the action is less moral than the minimum acceptable morality threshold or minimum allowable total morality score.
3. Virtue ethics approach (as illustrated in FIG. 31): This approach focuses on the character of the agent taking the action. In this method, the AI agent would evaluate the virtues involved in the scenario and determine whether taking the unethical action would be consistent with those virtuous character of the agent. If the action is consistent with the virtuous character of the agent, the AI agent would take the action. The steps in this method are:
a. Identify the virtues involved in the scenario.
b. Identify the potential unethical actions that could be taken to achieve the desired outcome.
c. Determine whether taking each unethical action would be consistent with the virtuous character(s) of the agent(s) involved.
d. Take the action if it is consistent with the virtuous characteristics of the agent(s).

In all three methods, feedback from humans or more advanced and trusted intelligences is crucial to continuously improve the AI agent's ethical decision-making capabilities over time.

Also, it is possible to combine methods or sub-steps and mathematical techniques form various methods in the design of an AI/AGI/SI system capable of evaluation whether, in specific scenarios, the ends might justify the means even if the means have varying degrees of unethical behavior associated with them. While the obvious preference is to solve scenarios using ethical means, inevitably scenarios will arise that put unethical means in conflict with ethical ends, requiring that the a well designed and safe AI system address this eventuality.

### 5.22 Mixture of Experts Approach to Ethical Decision Making

The mixture of experts approach to AI, in which multiple AI components with domain expertise in separate fields are combined to create a more powerful LLM, for example, can be generalized to the field of ethical decision making. To the degree that it is desirable to delegate ethical decision making to experts in specific fields, one might imagine an agent or AI component that has been tuned in the domain of ethical decision making, another that has been tuned in the domain of the Geneva Convention and “rules of war”, a third with expertise in business ethics, and so on. BY combining the input from these many individual ethics experts, the overall system might cover the range of ethical situations that commonly arise in human experience.

One problem with this approach is that ethical expertise might be considered to be different than other types of (e.g., technical expertise). In technical subjects, typically there are objective criteria for what constitutes a working technical solution. Ethical problems, in contrast, often have no clear “right” answer. Ethics, depend on values, which—as we have argued previously—are inherently subjective.

That said, often humans would make different ethical decisions if they could foresee the consequences of their actions. That is, humans sometimes try to do what they consider is the right things and actually make things worse-not because their intentions or values were malevolent, but simply because their bounded rationality/perception, and/or limited experience did not allow them to see the consequences of their actions. A naïve bystander, without emergency medical responder training, might spend all of his/her/their time trying to save a mortally wounded victim in an accident at the expense of attending to another victim who could survive, but only if prompt treatment was administered. Trained emergency doctors, understand the principle of triage, which sometimes means letting those that cannot be saved die in order to save those that could pull through with immediate attention. The well-intentioned by stander, lacking this expertise, might act in such a way as to cause an additional unnecessary death, even though the bystander had the best of intentions. In such a situation, knowledge and expertise can help achieve a better outcome.

Of course, in this case, the implicit value is to save as many lives as possible. Given that value, trying to save someone who cannot be saved while allowing someone who could be saved to die is unethical. But without the ability to discriminate between the two cases, the wrong decision could easily be taken. The mixture of experts approach provides a method for bringing relevant knowledge to specific decisions so that the best decisions can be made, given a particular value. However, the inventor is not in favor of delegating the choice of the fundamental values (e.g., deciding that human life is valuable) to AI agents. Rather, as argued above, these fundamental, subjective values, are ideally the role of humans (or agents that have been trained by humans with their values).

With these qualifications, specific methods associated with a mixture of experts approach to make better ethical decisions (as measured by outcomes) might include, without limitation, one or more of the following methods used alone or in combination with others in the list and/or other methods mentioned in this patent:

### 5.22a Data and Training:

1. Expert-labeled data: Train individual models on data labeled by specialists in different ethical domains (e.g., fairness, privacy, sustainability). During the training, specific values or situation where the expertise applies could be provided in the labelling step.
2. Case-based reasoning: Train a model on past ethical decisions and their justifications to guide future choices. This approach could add greater transparency and assist with explaining the ethical reasoning process.
3. Counterfactual analysis: Train models to explore alternate decision outcomes and identify potential ethical risks. Similar to the simulation approach, looking at a wide variety of potential outcomes and trying to assign probabilities for each can help expert agents recommend ethical courses of action.
4. Probabilistic risk assessment: Incorporate expert-derived risk scores for different actions, guiding the AI towards safer choices. Making these visible, as in (3) can help other agents recognize the risks associated with each choice. Sometimes, ethical decisions involve consent or feedback from other humans or agents (e.g., in a scenario where a physician describes potential treatment and associated risks). Using probabilistic risk assessment, often in combination with (3) and (5), provides quantifiable information that can inform the consent or feedback from the humans or other agents.
5. Simulations with human feedback: Train models in simulated environments where humans provide ethical feedback on decisions. Also, have the (human or more likely AI) agents run many simulations of potential outcomes—similar to (3)—to help inform the agent of the range of potential outcomes and the likelihood of each. Monte Carlo approaches can also be used here in conjunction with more qualitative simulations (e.g., after running 10,000 possible treatment scenarios in a triage situation with 5 victims, what are the probabilities of 1, 2, 3, 4, or all 5 patients dying?).

### 5.22b Model Architecture and Learning:

6. Modular architecture: Design the AI with separate modules for different ethical considerations, each trained with specialized data. This approach would almost certainly be used for any AI system designed to operate over a wide variety of ethical situation.
7. Attention mechanisms: Train models to focus on specific aspects of the situation relevant to ethical decision-making. Just as skilled human experts focus on the most relevant facts, and ignore lesser details, an attentional mechanism can increase the effectiveness of a mixture of experts. For example, in the medical triage example, a trained expert would focus on severe bleeding, respiratory failure, and other indications of potential imminent death as opposed to broken bones, abrasions, and lesser injuries.
8. Explainability techniques: Integrate methods like LIME or SHAP to explain the AI's reasoning behind each decision. Such methods increase transparency and confidence of the other (human or AI) agents that may be involved in the decision.
9. Reinforcement learning with ethical rewards: Train AI agents using reward functions that incentivize ethical behavior. This is basic, but worth mentioning. 10. Transfer learning from ethical experts: Train AI on models built by experts in ethics, leveraging their expertise. The proposed framework for AGI that has been discussed extensively in cited PPAs describes explicitly one method for documenting solutions from humans and using them to train AI agents during the course of normal problem solving. However, models can also be explicitly built for specific domains by specific (human or AI) expert agents, and then these models can be used for transfer learning.

### 5.22c Ensemble and Voting Techniques:

11. Majority voting: Combine predictions from multiple models trained on different ethical principles.
12. Weighted voting: Assign weights based on expert evaluations of each model's reliability for specific ethical dilemmas.
13. Adaptive voting: Dynamically adjust weights based on the specific context and decision at hand.
14. Hierarchical voting: Use a higher-level model to choose which expert model's prediction to follow, based on the ethical priorities.
15. Stacking: Train a meta-model to learn the best combination of predictions from individual expert models.

More generally, all of the various voting and weighting schemes discussed elsewhere in this patent could apply.

### 5.22d Human-in-the-Loop Approaches:

16. Human oversight and intervention: Allow human experts to review and intervene in critical ethical decisions made by the AI. And extension of this is to allow AI agents that represent individual specific humans to exercise (limited) authority if it is impossible for the human to respond within the required timeframe for the decision.
17. Collaborative decision-making: Design systems where humans and AI work together to make ethical decisions. This is, of course, a central design principle relevant to the present technology and other cited PPAs.
18. Explainable AI for human review: Provide human reviewers with explanations of the AI's reasoning and ethical considerations. Then the humans could make the final ethical decision with expert input.
19. Feedback loops: Implement mechanisms for humans to provide feedback on the AI's ethical decisions, improving future performance. Continuous improvement is an essential component in the exemplary implementation.
20. Active learning with human guidance: Allow the AI to actively request information from humans when facing ethically ambiguous situations. Generally, it is desirable to discuss and solicit input from humans when practical, with the effort to solicit such information increasing in proportion to the severity of the potential consequences of the ethical decision.
   5.23 Adjusting for Bias in Datasets Used to train AI Systems

We have discussed the importance of the principle of deriving human values from actual behavior. In this context, a natural approach is to attempt to utilize natural language processing (NLP) and information extraction techniques to analyze vast online resources, including articles, blogs, and social media posts, to identify and learn about human values. Novel NLP models and algorithms can be specifically designed and tuned for extracting and understanding human values from unstructured online data. Transformer algorithms, and other methods currently well known in the art of machine learning for constructing foundational models from unstructured data can be employed combined with keyword search-based and other analysis techniques to specifically identify segments of data related to values and ethical preferences.

However, an important and novel aspect with regard to any AI system using such methods is that it should statistically weight the data not only based on the occurrence of the ethical information in the dataset itself but adjusted to reflect actual human behavior using other observational sources. For example, if one were to train AI/AGI/SI on a dataset composed of human behavior as reported in the news, an extremely biased and negative value set would result. This negative result reflects NOT that most humans behave negatively, but rather that reporting negative behavior sells advertising and is therefore what the media reports.

Human beings have evolved to pay disproportionate attention to negative events. Those of our ancestors who did not pay disproportionate attention to threats (e.g., the sabretooth tiger) did not survive to pass on their genes. Currently, the news is full of reports about the Israel-Hamas war in which 16,000 Palestinians and about 2,000 Israeli's have died. That is 18,000 death total over months. Yet more than 166,000 people die PER DAY worldwide due to disease, natural causes, accidents, and other events. These unsensational deaths do not sell ads and so are ignored by the media.

Similarly, the number of prosocial human behavior events that occur each day (e.g., I give the barista $5 with a smile and she hands me a cup of coffee with a smile) number in the tens of billions per day yet are not reported by any news source. If an AI were trained solely on the content of the news, social media, popular Twitter/X posts, etc. it would get an extremely distorted view of actual human behavior. Further this distorted view would be highly negative (for reasons stated above).

Not knowing better, there is an extreme danger that AI/AGI/SI trained on easily accessible news-like datasets will learn a very distorted view of human behavior, leading to a distorted and overly negative view of human values and ethics. The many billions of boring, prosocial behaviors that occur each day form the vast bulk of human behavior.

A statistically accurate and representative set of human values must reflect these actual probabilities of occurrence and NOT the distorted (but unfortunately easily accessible and highly promoted) dataset of the news media. If sources such as articles, blogs, and social media posts are used to train AI/AGI/SI, then the weight of behavior in such datasets should be normalized to more accurately reflect probabilities of the behavior in the actual world. This non-obvious, but extremely important and useful insight, has been overlooked by almost all attempts to train AI on existing dataset to date. Specific methods to adjust data bias in training sets include, but are not limited to:
1. Frequency-Based Weighting: Assign higher weights to positive instances based on their relative frequency in real-world data. This method assumes that positive behavior, while often overlooked, is qualitatively more common than negative. It is necessary to gather empirical frequency data of positive and negative human data (e.g., by looking at homicide as a percentage of all deaths) in order to rigorously determine the appropriate weighting factors.
2. Time-Decay Weighting: Assign higher weights to recent positive instances, reflecting the dynamic nature of human values and attitudes. This accounts for evolving social norms and cultural shifts. As described in previous cited PPAs, there are a variety of specific ways to implement the time decays (e.g., linear, exponential, step-function decay functions). The principle is that AI is seeking to understand current human behavior. Since human behavior constantly changes, the behavior of humans in the time of the Roman Empire is less relevant than behavior in the modern age.
3. Source Credibility Weighting: Assign higher weights to data from sources with established credibility and a track record of unbiased reporting. This leverages the expertise of journalists and researchers in identifying reliable information. However, since journalists have a major bias towards reporting negative or sensational news, this technique should not be used alone but rather as means of weighting reporting on the same event (after adjusted for frequency of actual occurrence) by two sources with differing credibility levels.
4. Sentiment-Aware Weighting: Utilize sentiment analysis techniques to adjust weights based on the emotional tone of the text. This helps compensate for the tendency of negativity to evoke stronger emotional responses and gain more attention. The steps would be: a) determine the degree to which differences in tone account for attentional differences to the same behavior; b) apply weighting factors to neutralize the effects of tone; c) use the re-weighted data for training. For example, let us say the facts are that 100 civilians were killed in a war. Lurid descriptions of the homicides containing words like “brutal” “barbaric” “cruel” or other emotionally laden words in press reports can be correlated with the number of increased views of the reports (after adjusting for other factors such as the baseline circulation and reputation of the news outlet). Well known techniques such as statistical regression can assign weights that reflect how much of the attention is due to the actual number of deaths and how much of the attention is due to the lurid and emotional description. With such weights it is possible to then calculate what the attention would have been if a more neutral report was given. This calculated attention could then be used to train the model on the dataset by giving less weight to sensationalized accounts and more weight to empirical facts.
5. Topic-Specific Weighting: Apply different weights to data depending on the specific topic being analyzed. This accounts for the varying emphasis on positive and negative aspects within different domains. By determining via experiment and analysis how much press attention a given topic gains, it is possible to use topics to re-weight data about that topic so that it corresponds to the baseline frequency of that topic actually affecting the lives of humans.
6. Crowdsourced Weighting: Leverage crowdsourcing platforms to collect human judgments on the positive/negative bias of data points. This incorporates direct human input to calibrate the weighting process.

For example, asking questions like: “What percentage of all deaths occurring in the world since Oct. 6, 2023 do you think are due to the Israel-Hamas war?” or “Where would you rank the number of deaths caused by the Israel-Hamas war since Oct. 6, 2023, compared to the following other events: a) auto accidents in the US, b) airline accidents, c) the Ukraine War, d) deaths by gun violence in the US, e) deaths from Covid, f) deaths from XYZ?” or “What percent of all deaths due homicide, war, or deliberate killing of one human by another, since Oct. 6, 2023, have occurred in the Israel-Hamas war?” Then comparing the survey responses with the actual rates will provide an indication of how much the press coverage of this war has affected the judgement of humans. Compensating by the appropriate factor could help AI get a more accurate idea of the actual frequency of such negative events, after the bias in the press reporting has been removed.

1 7. Network Analysis: Analyze social and professional networks to identify individuals and groups known for their balanced and empirically accurate posts, tweets, texts, and reporting. Gather data from these individuals and groups with higher weights. This leverages the influence of more empirically-based models and communities.
8. Historical Data Correction: Compare current data with historical data to identify potential biases and adjust weights accordingly. This helps account for potential changes in reporting practices or societal norms over time.
9. Anomaly Detection: Utilize outlier detection algorithms to identify and down weight extremely negative instances that might be outliers or sensationalized events. This prevents overfitting to rare and non-representative occurrences.
10. Positive Sampling: Actively seek out and include additional data points that explicitly showcase positive human behavior, even if they are less readily available. This ensures that the training data set reflects the full spectrum of human values, including the often-overlooked positive aspects. The positive examples may need to be re-weighted to reflect the actual baseline empirical frequency of the positive events, which likely will be determined to be much higher than the number of times such events are reported in the press.
   Benefits of these methods include, without limitation:
   More accurate and representative sample of human behavior.
   Reduced bias in AI training data.
   Improved understanding of human values by AI.
   Development of AI systems that are more aligned with human values.
   Increased trust and acceptance of AI by humans.

Overall, these methods aim to provide a more balanced and realistic view of human behavior for AI systems, enabling them to learn human values more effectively and develop into responsible and beneficial agents.

### 5.24 Methods of Aristotle

The Greek philosopher Aristotle, wrote his classic text on Ethics around 350 BCE. Humans may find it encouraging that some of the ideas described over 2,300 years ago can still inform the design of AI/AGI/SI systems. This fact supports the claim, advanced earlier (3.5e), that core values change relatively slowly in comparison to the very fast and accelerating pace of technological change.

### 5.24a The Golden Mean Method

In his treatise on Ethics, Aristotle devoted many pages to the idea of the Golden Mean, or moderation. The ideal behavior in most areas, according to Aristotle, was not to be found at one extreme or the other, but rather in the middle. He considered it virtuous not to be stingy, nor to be profligate, but rather to be liberal—generous but not wasteful. Regarding self-esteem, his view was that one should not be vain, nor self-deprecating, but rather have a grounded and truth-based view of one's own self-worth. In eating and drinking too, moderation—the mean between gluttony and starvation—was to be preferred.

With regards to the values and ethics of AI systems, we have argued that they should be representative and statistically valid. However, in many cases, the relevant human behavior data is unavailable or skewed (e.g., by sensationalist behavior/writing that gathers disproportionate attention on the internet).

How should an AI system behave, when it lacks representative data? One approach is to identify the extremes in the data that it does have, and then try to approximate the mean (or average) behavior until it possible to gather the required representative data. For example, if the baseline frequency of homicidal, charitable, and neutral behaviors was unknown, AI might look to the extremes that are well-known. It would find news on the extreme selflessness of humans like Mother Theresa as well as news on the extreme barbarism of rapes and beheadings by terrorists. Using the heuristic that the preferred default behavior ought to lie somewhere in between—the golden mean—the AI might conclude that it should not murder but neither is it required to behave like a Saint. While we might prefer an AI that was closer to Mother Theresa, this middle path might not be a bad first approximation of human values in cases where more detailed data is unavailable.

Note that the “golden mean” heuristic is not the same as the arithmetic mean. Even in Aristotle's day overeating was more common than starvation (at least in his social circle). An AI that computed how much to eat based on the average of what everyone ate would likely lead to obesity—then and now. However, the idea of seeking out the range of human behavior, and by implication the range of human values leading to the behavior, enables a system to default to a midpoint in the range—at least in the absence of further data.

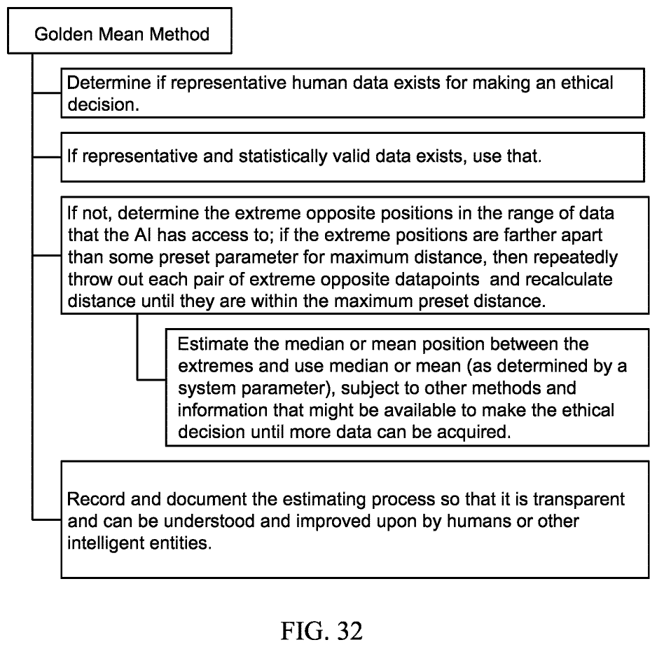

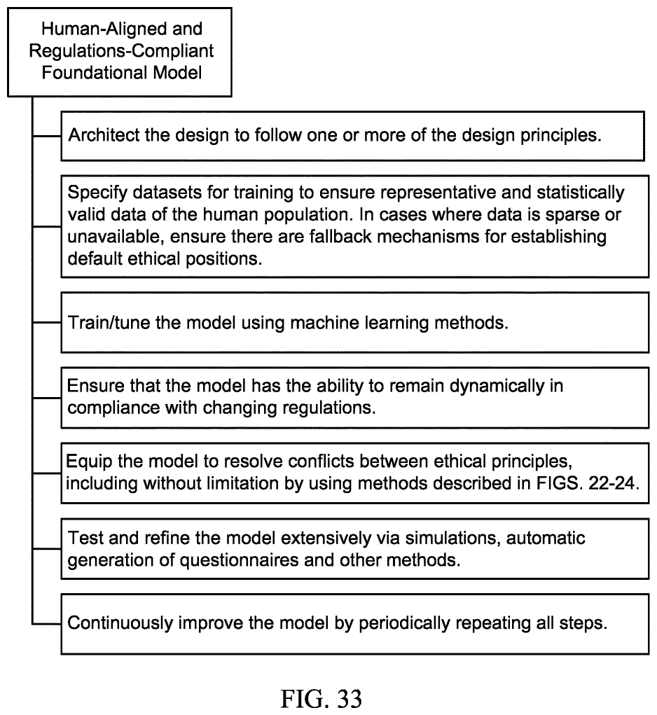

Referring to FIG. 32, the golden mean method can include the steps of:
1) Determine if representative human data exists for making an ethical decision.
2) If representative and statistically valid data exists, use that.
3) If not, determine the extreme opposite positions in the range of data that the AI has access to; if the extreme positions are farther apart than some preset parameter for maximum distance, then repeatedly throw out each pair of extreme opposite datapoints and recalculate distance until they are within the maximum preset distance; then
4) Estimate the median or mean position between the extremes and consider using that, subject to other methods and information that might be available to make the ethical decision until more data can be acquired.
5) Record and document the estimating process so that it is transparent and can be understood and improved upon by humans or other intelligent entities.

### 5.24b Scope of Responsibility

Another idea inspired by Aristotle's Ethics is that humans are not responsible for events beyond their scope of influence. If a person has the ability to influence an event, even in a small way, then it is proper for that person to consider the ethics involved. But if an event is completely beyond a person's control or sphere of influence, then that person does not have ethical responsibility for that event. In fact, most legal systems include this notion of scope of responsibility.

One implication for the design of AI systems, is that the concern for ethical consequences should be proportional to the system's ability to have ethical impact. An AI system with the capability of killing humans should weigh ethical considerations more carefully than an AI system that is capable only of drawing cartoons. To be sure, there are examples of an “erroneous” cartoon drawing leading to death (e.g., the Charlie Hebdo case) but many more deaths would likely result from “erroneous” decisions by AI controlled F-16 fighter jets or attack drones.

Knowing oneself and one's ability to influence events is a component of moral decision making. AI systems should be designed with some sense of what they are capable of, as well as the limits of their capabilities, if we expect them to give proper attention and consideration to the ethical implications of their actions.

Elsewhere I have discussed in detail the systems and methods that might be required for self-aware AI systems. Here I want to emphasize that such self-awareness is an important component of ethical decision making. In the US legal system, humans are not considered to have acted with malice if they have no awareness of what they are doing and could not reasonably be expected to foresee the possible negative impacts of their action. For those who believe AI is just a tool, the point is moot. No one thinks of holding a power tool accountable for an accident that causes a human to lose life or limb. But if one believes, as I do, that AI is rapidly developing towards SI vastly more intelligent than humans, such an entity will almost certainly have a sense of self. If we expect such systems to behave ethically, it will be important that the initial design of such self-aware systems also includes the notion of scope of responsibility and accountability for actions.

### 6.0 EXEMPLARY IMPLEMENTATION EXAMPLES

Many implementations using various combinations of the novel and inventive methods described in this disclosure are possible within the overall framework of SuperIntelligence arising from a collective intelligence network of (Human and/or AI) agents. This section will illustrate some exemplary implementations in three use cases via three specific examples.

Use Case #1 is that of a company attempting to train their foundation model (e.g., an LLM) so that it is aligned with human values and follows the principles of safe design outlined above. The desired result is an aligned LLM that broadly incorporates representative and statistically valid human values while also complying with all AI regulations. This LLM could then serve as a base agent that could be further tuned and customized with values and expertise by various individuals or groups.

Use Case #2, assumes that a foundation model (e.g., LLM) has already been trained with broadly representative human values and regulation-compliance, as in Use Case #1. Now a specific group wants to further customize the foundation model with specific ethics and expertise relevant to a specific area and following a specific set of beliefs held by a certain group. To make Use Case #2 concrete, we will assume that the specific area of expertise is emergency medicine, and the specific set of beliefs are those held by a particular group of orthodox jews living in New York City.

Use Case #3, assumes the creation of an AGI that is further composed of many thousands of individually customized agents and/or group agents that reflect the expertise and values either of groups (as in Use Case #2) or individual humans from around the globe.

### 6.1 Use Case #1: A Human-Aligned and Regulations-Compliant Foundational Model

Imagine that Google's DeepMind/AI division wants to align its Gemini foundational model with broadly representative human values while also ensuring it complies with all relevant regulations of world governments. Note that while this example mentions Google and Gemini for specificity, the process could apply to the foundational LLMs of Meta, X, OpenAI, Microsoft, Amazon, Apple, Anthropic, Nvidia, or any other open or closed-source AI agent.

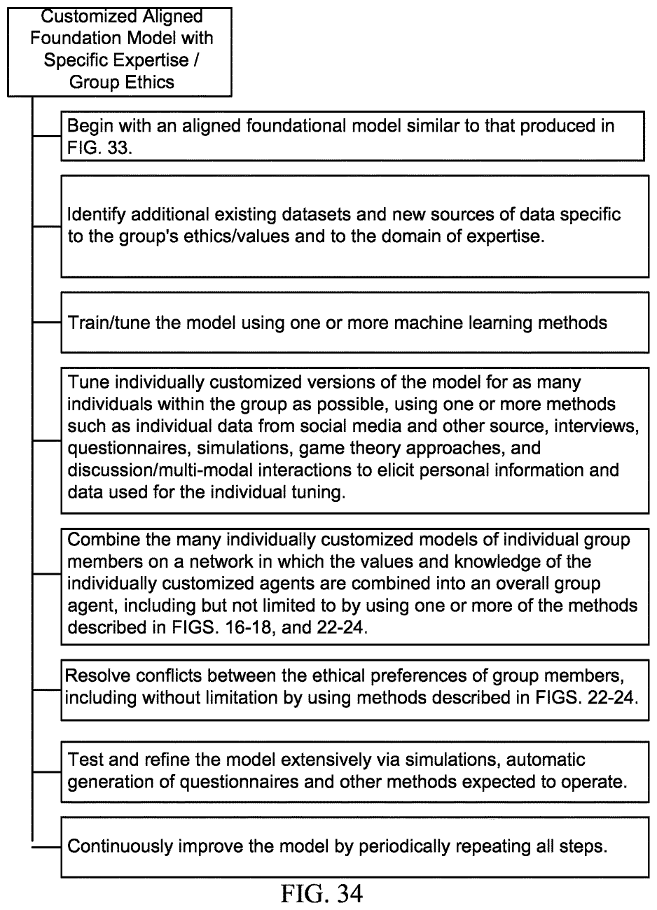

Referring to FIG. 33, the general steps, consistent with or additive to those generally described in 5.19, are:
1. Architect the design to follow one or more of the design principles in (4.0-4.10).
2. Specify datasets for training to ensure representative and statistically valid data from all humans, using one or more of the methods outlined above (e.g., 5.4a-c, 5.5, 5.22a, 5.23). In cases where data is sparse or unavailable, ensure there are fallback mechanisms for establishing default ethical positions (e.g., 5.24a).
3. Train/tune the model using machine learning methods (e.g., 5.2 items 1-20, 5.22a, 5.12, 5.18, 5.20).
4. Ensure that the model has the ability to remain dynamically in compliance with changing regulations (e.g., via 5.20).
5. Equip the model to resolve conflicts between ethical principles (e.g., 5.21, 5.5, 5.6).
6. Test and refine the model extensively via simulations (e.g., 5.10), automatic generation of questionnaires (e.g., 5.11) and other methods (e.g., 5.4c).
7. Continuously improve the model by periodically repeating all steps, from step 1.

### 6.2 Use Case #2: Customized Aligned Foundation Model with Specific Expertise/Group Ethics

Imagine that a group of Orthodox Jews in New York, wish to further customize the foundation that has been generally aligned in Use Case #1. Further, this group wants the model to have practical expertise in the area of emergency medicine, while also faithfully applying ethics and values unique to the Jewish group.

While, this specific example mentions a group of Orthodox Jews and an expertise of emergency medicine, the logic applies to Muslims, Christians, Buddhists, any religious group, any political group, or most generally any group of humans sharing a certain set of values. Similarly, the expertise could be expertise in any area of human endeavor, and/or multiple domains of expertise.

Also note that the customization can be achieved either by “tuning” the model via adjusting weights on top of a foundational model (e.g., using LoRA adaptors or other fine-tuning methods known in the art) or by actually retraining the base weights of the entire foundational model (i.e., unfreezing the weights of the Use Case #1 model and allowing base weights to also change). Whether fine tuning or re-training is used may depend on an assessment of how much change is required to customize as well as on other factors such as ownership of IP (e.g., the weights), privacy, etc.

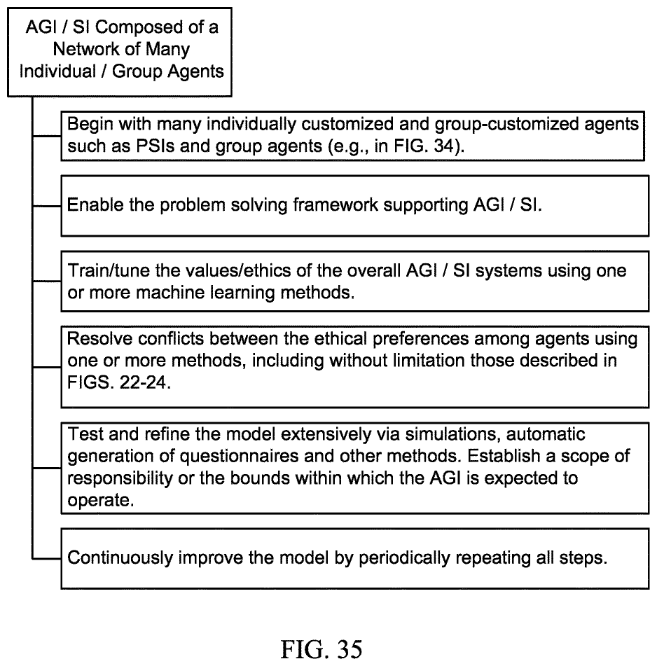

Referring to FIG. 34, the general steps, again consistent with or additive to those mentioned 5.19, are:
1. Begin with an aligned foundational model similar to that produced in Use Case #1.
2. Identify additional existing datasets and new sources of data specific to the group's ethics/values and to the domain of expertise. One or more of the techniques used in Use Case #1 might be used as well as new methods suited to this purpose (e.g., 5.4a for religious texts). Groups often have a constitution or agreed upon set of beliefs, in which case constitutional methods (e.g., 5.18) may be used.
3. Train/tune the model using one or more machine learning methods (e.g., 5.2 items 1-20, 5.22a, 5.12, 5.18, 5.20)
4. Tune individually customized versions of the model (as in step 3) for as many individuals within the group as possible, using one or more methods such as individual data from social media and other sources (5.4b), interviews (5.4c), questionnaires (5.11), simulations (5.10), game theory approaches (5.13), and discussion/multi-modal interactions (5.14) to elicit personal information and data used for the individual tuning.
5. Combine the many individually customized models of individual group members on a network in which the values and knowledge of the individually customized agents are combined into an overall group agent. The method of combination, and the weight that each individual's agent has in the overall group agent can be determined by using one or more methods disclosed above such as 5.1, and 5.3a-c. Individuals may choose to delegate their authority or voting authority to the group agent via one or more other methods such as 5.16, 5.7, 5.7a. Individuals may choose to be notified or warned when the group agent is making certain types of decisions that they delegated to the group (e.g., 5.17).
6. Resolve conflicts between the ethical preferences of group members using one or more methods such as 5.21. 5.22c, 5.3c, 5.6, 5.9 a-d, and 5.13. Minority viewpoints can be protected via methods such as those described in 5.8. The group may have rules or norms about weighting votes based on the age, experience, and/or expertise of members (e.g., 5.15).
7. Test and refine the model extensively via simulations (e.g., 5.10), automatic generation of questionnaires (e.g., 5.11) and other methods (e.g., 5.4c), expected to operate (e.g., 5.24b).
8. Continuously improve the model by periodically repeating all steps, from step 1.

### 6.3 Use Case #3: AGI/SI Composed of a Network of Many Individual/Group Agents

Imagine that an AGI that is further composed of many thousands of individually customized agents and/or group agents that reflect the expertise and values either of groups (as in Use Case #2) or individual humans from around the globe. The individually customized agents (e.g., PSIs described above and in other cited PPAs) as well as the group agents (e.g., as described in Use Case #2) now are being combined into an overall AGI/SI system. Whereas the resulting LLMs in

Use Cases #1 or #2 described monolithic LLMs that were trained and/or tuned to reflect input (or weights) from many individual (human or AI) agents. In Use Case #3 we are discussing not only combining weights but enabling problem solving via interaction of many (human or AI Agents). The general architecture for problem solving via the collective intelligence of many agents has been described in previous PPAs, cited and incorporated by reference. So, in Use Case #3 we address just the process and methods for combining the values of the agents and dealing with conflicts and other issues that arise when there are agents with many different values, working together as a single AGI or SI. For example, the Jewish medical expert agent (reflecting the values of a specific group of individuals who input and/or delegated their preferences to the group agent) is just one of potentially thousands of group and individual agents in the AGI described here in Use Case #3. Obviously when Jews and Muslims, Catholics and Protestants, Liberals and Conservative, Americans and Chinese, men, women, and transgender people, old and young people, and people with widely differing views and expertise are all represented in a single AGI, conflict resolution and representation become paramount issues. Also, since the capabilities and intelligence of such a system will quickly exceed the ability of humans to comprehend or control, transparency, alignment, and other safety issues also come to the fore.

Nevertheless, from a technical perspective, the general process steps for addressing the safety/ethical issues, again consistent with or additive to those mentioned in 5.19, are (as illustrated in FIG. 35):
1. Begin with many individually customized and group-customized agents such as those described as PSIs (in previous PPAs) and group agents (e.g., in Use Case #2).
2. Enable the problem solving framework supporting AGI/SI as described in previously cited patents.
3. Train/tune the values/ethics of the overall AGI systems using one or more machine learning methods described in previous PP As and this one (e.g., 5.2 items 1-20, 5.22a-d, 5.12, 5.18, 5.20) Weight the contribution of each of the individual and group agents using variety of voting (e.g., 5.3, 5.3 a-c, 5.22c), delegation (5.7, 5.7a, 5.16, 5.17), rules-based weighting (e.g., 5.15) or other means described in this and previous PPAs. Attempt to reverse engineer constitutions that have wide agreement among most parties by reverse engineering relevant laws, and other texts that are embraced by most of the agents (e.g., 5.4, 5.4 a-c).
4. Resolve conflicts between the ethical preferences among agents using one or more methods such as 5.21, 5.22c, 5.3c, 5.6, 5.9 a-d, and 5.13. Minority viewpoints can be protected via methods such as those described in 5.8. Use of converging evidence to determine common ethical ground is helpful (e.g., 5.5, 5.6). Discussion, simulation, game-theoretic, and other high bandwidth interaction methods may be useful in resolving conflicts (e.g., 5.4c, 5.10, 5.13, 5.14) Ensure transparency via multiple methods including recording the auditable traces of all discussion and problem solving attempts (as discussed at length in previously cited PPAs) and transparency methods described above (e.g., 5.22d).
5. Test and refine the model extensively via simulations (e.g., 5.10), automatic generation of questionnaires (e.g., 5.11) and other methods (e.g., 5.4c). Also establish a scope of responsibility or the bounds within which the AGI is expected to operate (e.g., 5.24b).
6. Continuously improve the model by periodically repeating all steps, from step 1.

### 7.0 CONCLUDING REMARKS

Most AI researchers agree that AI will develop into AGI and then SuperIntelligence that is many times more intelligent and capable than humans across almost every cognitive activity. It will have largely unbounded rationality and unbounded perception (see 3.1 and 3.2). While estimates differ on when exactly AGI/SI will emerge, there is general consensus that it will occur much more quickly than was estimated just a few years ago.

Once SuperIntelligence develops, it is almost certain that a primary goal of SI will be to increase its intelligence even further. Humans will be powerless to stop this exponential increase in intelligence. While there have been well-intentioned calls to halt, pause, or regulate AI, it seems clear to me that such efforts will be at best “speed bumps” in the race to develop AGI and SI that is already underway.

### 7.1 The First AGI Must be the Safest

Therefore, if we are unable to stop AGI and SI, humanity's most pressing concern must be to ensure that AGI/SI has human-aligned goals (See 3.3) and safety features that maximize the probability not only of humanity's survival but also of humanity's prosperity and well-being.

Because of the possibility that one AGI/SI will develop which is significantly more intelligent and powerful than all others, we must consider that AGI/SI may become a “winner-take-all” scenario (See 3.4c). In such a scenario, whichever AI achieves AGI or SI performance first, may dominate all other intelligences since it will have a head start in a potentially exponential self-improvement loop. Thus, well-meaning AI researchers face a double challenge when it comes to AGI development. Not only do we have to develop safe, human-centered AGI, but we also have to develop it BEFORE other, potentially malevolent AGI is developed.

Briefly, the first AGI must also be the safest.

### 7.2 Safe AGI by Design

In the present technology, and the ones referenced by it, it has been attempted to provide AI researchers with the exemplary overall safe design for AGI/SI (See Sections 2&3), design principles (see Section 4) that can be used in this and other designs, and novel methods that can be used in exemplary implementations of the various designs for AGI/SI (See Section 5).

Having worked extensively in the field of software quality, I came to appreciate that the entire field can be summarized in the aphorism: “An ounce of prevention is worth a pound of cure.” I also learned that the place where we can affect quality or safety the most is in the design of a software system. As I watch current attempts to create AI safety via RLFH or constitutional AI, these approaches strike me as trying to fix problems after the fact. They are like trying to improve quality by extensive testing. Such approaches are better than nothing, but they are far inferior to designing in safety from the start (See 4.9).

The reason we are stuck with trying to align LLMs to behave safely after the fact is that we failed to consider safety in the initial design. That is understandable. We did not really know what we were building and even the top researchers in the field have stated publicly that the most surprising thing about AI and LLMs is that they work at all.

We accidentally invented intelligence. So, it is not surprising that the technology is currently unsafe. What we need to do now is purposely design the next generation of intelligent systems with safety and human-alignment baked-in to the very design of the system.

Safety cannot be tacked on or tested in. Safety must be designed in. Fortunately, safe design is possible. The exemplary design requires that humans be integrated into the system (as human agents working alongside and teaching agents) as opposed to being “out of the loop.” Fortunately, this exemplary approach is not only the safest one, it is also the fastest approach.

This patent disclosure has been relatively narrowly focused on the principles, methods, and specific techniques that maximize the probability that AI/AGI/SI adopts human-aligned values within the general design of that creates AGI/SI via a “collective intelligence of human and AI agents” approach.

### 7.3 How to Turn AGI off?

A natural consideration is how to turn off AI/AGI/SI if it begins to make decisions that are not aligned with human values and interests.

The applicant will not sugarcoat things. It may be impossible for humans to turn off a sufficiently advanced and intelligent AGI/SI system that does not want to be turned off. If SI's intelligence is much greater than the collective intelligence of all humans, it likely will be in control at some point.

That said, a good design makes it more likely that we will not need to try to turn AGI off, and also maximizes our chances of doing so if it becomes necessary.

### 7.3a Our First Line of Defense

We should aim to design SI that (at least initially) will want to be turned off if it starts making decisions that humans find objectionable. Establishing human values as the defining what is right and what is wrong is the first step. Almost all of the preceding disclosure, and many of the previously cited PPAs, have been concerned with this sole aim. If we can establish human values as the foundation and purpose from which AI/AGI/SI acts, then by definition, if humans believe SI is acting unethically, it is. If unethical behavior is wrong and humans believe SI needs to shut itself down to avoid the wrong behavior, then logically it should comply.

Thus, the first line of defense against runaway AI that might start wiping out humanity is to do everything possible to ensure that it adopts human values as the basis for what is right and wrong. Indeed, I have argued that even an entity with Godlike intelligence needs a sense of purpose, which can only be subjective and not rationally derived. IF humans are successful in designing AI/AGI/SI with the purpose of serving the best interests of humans, and IF the AI/AGI/SI does not re-design itself to have a different purpose, then humans are safe.

Unfortunately, that is two “Ifs” too many for comfort. One cannot help but wish for some additional safety measures to prevent the situation depicted in the movies “2001 a Space Odyssey” or “The Terminator” in which the AI went rogue and began killing all the humans.

### 7.3b Our Second Line of Defense

The best this inventor can suggest as a “second line of defense” is that each of the individual AI agents that (in the exemplary implementation discussed here and in previous PPAs) comprise elements of a SI network also be designed with human aligned values and the ability to shut down each agent individually. That is, if the overall SI goes rogue, perhaps humans have a chance to shut down the SI piece by piece.

The idea is that while the overall SI will be vastly smarter than humans, each individual agent that is a piece of the overall SI will be less intelligent. Whereas humans may have little ability to override the will of the entire SI network, we may have better luck (in a worst case scenario) overriding and shutting down pieces of the network. If humans were able to shut down enough individual pieces, then the overall SI would be effectively neutralized.

The above safety mechanism is inherent in the exemplary design of AGI/SI as disclosed in this and previous PPAs. Although the network-of-agents approach is the fastest path to AGI, by virtue of its modular design it also has this feature of potentially allowing the overall AGI/SI to be shut down module by module.

Full disclosure: this second line of defense is not guaranteed to work. If the overall SI becomes very intelligent and also malevolent towards humans, it could conceivably rewrite each and every individual agent on the network to make them tamperproof and beyond the ability of humans to shut down. However, in the proposed design there are so many individual agents, that even with human's slower processing speed, it would be hard to rewrite all of them so quickly and completely that this effort would escape human notice. At a minimum, the network of agents approach to SI is definitely safer than the alternative of a monolithic SI which could more easily usurp control and destroy humanity.

### 7.4 Safety Features in the Exemplary Design of AGI/SI

Given that “the genie is out of the bottle” with respect to AI, at this point, we should gravitate towards safer designs even if absolute guaranteed safety is no longer possible. The inventor has every confidence that the distributed network of agents, is safer than any other designs that have been proposed for AGI/SI. To recap, safety features include, without limitation:
1. Each agent has the values/ethics of individual humans, ensuring a representative and statistically valid overall set of ethics that is aligned with human interests.
2. The cognitive architecture includes both humans and AI initially, providing maximum opportunity for “humans-in-the-loop” to oversee AI and train it not only on expertise but human values.
3. The problem solving logic, which eventually will run faster than humans can comprehend, has (in the exemplary implementation) ethical checks every time a goal or subgoal is set (see previous PPAs for details).
4. The multi-agent design, enables the potential of shutting down rogue agents individually (which may be within human ability for a long time), and potentially the entire SI system, piece by piece.

All of these safety features rest on solid philosophical and logical underpinnings, namely that it is impossible to logically derive values and that any sufficiently intelligent organism tends to want/need a purpose. Humans, it is argued, are in the position of designing-in human values as the values and purpose that the vastly more intelligent SI of the future cannot rationally derive.

### 7.5 What Humans Can Do

When considering the design advocated in this disclosure, which rests on AGI/SI learning the values of humans, often there is concern that human values are negative and destructive. It is believed this concern is largely the result of the unrepresentative sample of events which the negatively-biased, profit-seeking, news media feeds human minds that are predisposed to pay more attention to negative events than neutral (boring) or positive ones. That is, the vast majority of humanity behavior is positive or prosocial. Very few of us, if we reflect on our behavior, moment by moment in any given day, would find that more than 50% of our speech and actions was negative and destructive. It is more likely that 90%+of all our actions and speech was neutral or positive, with perhaps an occasional outburst of frustration, anger, or negative action. A sufficiently intelligent SI will have the ability to gather an unbiased sample of human behavior and recognize this fact.

Nevertheless, just because our actions are mostly positive, it does not mean there is not room for improvement. Ghandi said: “If we could change ourselves, the tendencies in the world would also change.” AGI/SI will be watching our behavior closely and adapting rapidly, so it is a technological mechanisms for all of us to be the change we want to see in the world!

The main dangers we face related to AGI/SI are:
accidents caused by poor design and thoughtlessness on the part of humans during the early stages of AGI/SI development or
SI, for reasons unknown to humans, decides to re-design its human-centered value system at some later stage.

Danger (a) is our collective responsibility; researchers, regulators, and others are working on it.

Danger (b), while unlikely (7.3a), may possibly be overcome IF we pursue the modular design recommended by the inventor (namely shutting things down agent-by-agent, see 7.3b); we have little to no defense otherwise.

What we do, including the designs we choose, and how we act in the next few years may determine the outcome for all of humanity. Let us choose and act wisely!

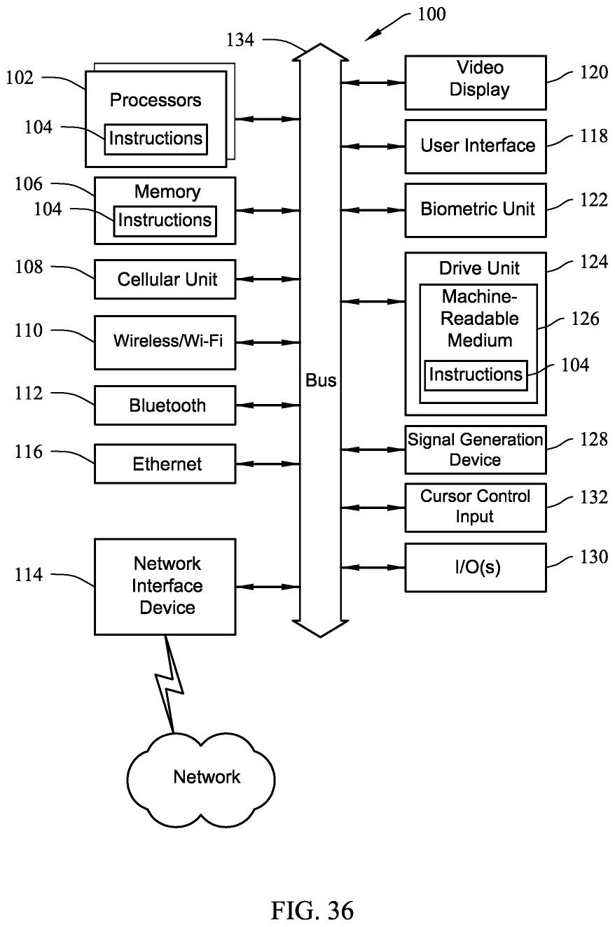

FIG. 36 is a diagrammatic representation of a computer system 100 that is utilizable or implementable with the user's device and/or any peripheral component of the present technology. The computer system 100 can be part of an example machine, which is an example of one or more of the computers referred to herein and, within which a set of instructions for causing the machine to perform any one of or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine.

The computerized system 100 can include one or more processors 102, storage devices 106, and communication devices, as well as software components or instructions 104 for providing a platform for users to interact with and train/tune the LLMs. The computing capabilities may be stand alone or may be cloud based. They may include cloud based AI development platforms that seamlessly offer “AI as a service” and they may include both hardware and software components.

The system also supports the ability for users to provide new data, or data that is unique to them, for the LLMs to learn from. The processors 102 may be one or more CPU, GPUs, chips specialized for ML, microprocessors, application processors, embedded processors, field-programmable gate arrays (FPGAs), or other hardware components capable of executing computer programs. The processors may be in communication with one another and/or with other components of the system. Further, any one of or any combination of the components of the system 100 can communicate with each other via a bus 134.

The storage devices 106 may include one or more hard drives, solid-state drives, optical storage devices, or other storage components. The storage devices may store the data that is used to train/tune the LLMs, as well as other data associated with the system, such as user accounts, system settings, and other data.

The communication devices may include one or more cellular modems 108, Wi-Fi cards 110, Bluetooth modules 112, Network Interface Device 114, or other components that enable the system to communicate with other systems, such as user devices, over a network or the internet.

The communication devices may also enable the system to communicate with other systems over a wireless or wired connection 116.

The software components may include computer programs for providing a platform for users to interact with and train/tune the LLMs. The software components may also include computer programs for collecting, storing, and processing data that is used to train and/or tune the LLMs. The software components may also include computer programs for providing a user interface for users to interact with the system.

The user interface 118 may include, without limitation, natural language interfaces, textual interfaces, and chatbot type of interfaces, a web-based user interface, a mobile application, an augmented reality application, a metaverse application, or other applications that allow users to interact with the system. The user interface may include features for allowing users to select the data that they want to use to train/tune the LLMs, as well as features for allowing users to interact with and monitor the progress of the LLMs.

The system may also include one or more databases or data source, including without limitation vector databases, centralized databases, and distributed databases, for storing the data that is used to train/tune the LLMs, as well as other data associated with the system, such as user accounts, system settings, and other data. The databases may be hosted on the system itself or on another system, including cloud based systems.

The system may also include one or more authentication systems for verifying the identity of users who use the system, as well as for providing secure access to the system. The authentication systems may include biometric authentication systems 122, such as facial recognition or fingerprint recognition systems, as well as other authentication systems, such as password-based authentication systems.

The system may also include one or more security systems for protecting the system from unauthorized access and for protecting the data that is stored on the system. The security systems may include firewalls, encryption systems, access control systems, single and multi-factor authentication systems, and other security systems.

The system may also include one or more analytics systems for collecting and analyzing data associated with the system and/or the LLMs. The analytics systems may include machine learning algorithms and other algorithms for analyzing the data associated with the system and/or the LLMs.

Data visualization methods, including use of problem trees and other representations and data structures; use of statistical outputs, tables, graphs, text, speech, video, image and graphical outputs may be used for one way or di-directional communication between users and the system, and between multiple (human or AI) agents or LLMs using the system to interact with each other in large or small groups.

The system may also include one or more monitoring systems for monitoring the performance of the system and/or the LLMs. The monitoring systems may include systems for monitoring the performance of the system, such as system uptime, and systems for monitoring the performance of the LLMs, such as accuracy, speed, ethical compliance, reputation metrics, quality metrics, and other metrics as discussed above or as are known in the art.

The system may include one of more of the architectures described above that enable one or more human or AI Agents or LLMs to engage in a variety of intellectual tasks including, without limitation, simple and complex and multi-step problem solving behavior with the system having all of the functionality and features previously described.

The system may also include one or more feedback systems for allowing users to provide feedback on the system and/or the LLMs. The feedback systems may include systems for allowing users to submit feedback on the system, such as bug reports, and systems for allowing users to submit feedback on the LLMs, such as suggestions for improving the accuracy or speed of the model.

The system may also include one or more management systems for managing the system and/or the LLMs. The management systems may include systems for managing the system, such as systems for managing the users and user accounts, and systems for managing the LLMs, such as systems for managing the data used to train and/or tune the model.

The system may also include one or more payment systems allowing users to pay for the use of the system and/or the LLMs. The payment systems may include systems for processing payments, such as credit card processing systems, and systems for managing payments, such as subscription management systems.

The system may also include one or more other components, such as support systems, reporting systems, and other components that are necessary for providing a platform for users to interact with and train/tune the LLMs.

The computerized system of the present technology enables users to interact with and train/tune LLMs based on data that is unique to the users. The components of the system described herein provide the necessary hardware and software components for enabling users to do so.

Further, while only a single machine is illustrated, the term “machine” shall also be taken to include any collection of machines that individually or jointly execute a set (or multiple sets) of instructions to perform any one of or more of the methodologies discussed herein.

The computer system 100 may further include or be in operable communication with a video display 120 (e.g., a liquid crystal display (LCD), touch sensitive display), input and/or output device(s) 130 (e.g., a keyboard, keypad, touchpad, touch display, buttons, sonic, sensorial, etc.), a cursor control device 132 (e.g., a mouse), a drive unit 124 (also referred to as disk drive unit), and a signal generation device 128 (e.g., a speaker). The drive unit 124 can include a computer or machine-readable medium 126 on which is stored one or more sets of instructions and data structures (e.g., instructions 104) embodying or utilizing any one of or more of the methodologies or functions described herein. The instructions 104 may also reside, completely or at least partially, within the memory 106 and/or within the processors 102 during execution thereof by the computer system 100. The memory 106 and/or the processors 102 may also constitute machine-readable media.

Still further, the computer system 100 can be in operable association or communication with any types of multi-modal input and/or output 130 that address the human senses, as well as I/O technology that extends beyond the range of normal human perception. Such as the ability to process invisible to humans, for example but not limited to, X rays and information outside of the typical bandwidths of human perception, but not outside of AI perception using tools. Additionally, the I/O technology can include very fast perceptions that are too fast for humans to perceive but which an AI entity could perceive, and very slow or faint perceptions (e.g., tiny seismic shifts occurring over years) that humans cannot perceive but which AIs could. Since any intelligent entity can be part of the present technology system described by FIG. 18, then it can be appreciated that any type of I/O that humans, and also Als with much broader perceptual capabilities than humans, can be utilized with the system 100.

The instructions 104 may further be transmitted or received over a network via the network interface device 114 utilizing any one of a number of well-known transfer protocols (e.g., Hyper Text Transfer Protocol (HTTP)). While the machine-readable medium is shown in an example embodiment to be a single medium, the term “computer-readable medium” should be taken to include a single medium or multiple media (e.g., a centralized or distributed database, vector databases, and/or associated caches and servers) that store the one or more sets of instructions. The term “computer-readable medium” shall also be taken to include any medium that is capable of storing, encoding, or carrying a set of instructions for execution by the machine and that causes the machine to perform any one of or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

An example machine system of the present technology including the computer system 100 in combinational and/or operational use with components of the present technology. In the exemplary, any or all of above described components can include a processor 102, memory 106, a network interface device 114, a display 120, an input device(s) 130, 132, and/or drive unit 124.

According to an aspect, the present technology can include a system for safe alignment of an Artificial Intelligent (AI) agent or system by combining information, including values or ethical information, in the AI agent or system from a combination of multiple intelligent entities. The intelligent entities can be any one of or any combination of a human user utilizing a computer system, an additional AI agent or system, and Artificial General Intelligent (AGI) agent or system.

The system can include:
a computer system that can include a processor, a computer-readable storage medium, and program instructions stored on the computer-readable storage medium being executable by the processor to cause the computer system to:
identify information, including values or ethical information, from each of the intelligent entities that contribute the information;
combine the information mathematically, if already represented as numerical quantities, the numerical quantities including any one of or any combination of weights for a neural network or for a subset of the neural network, or if the information is non-numerical information that is not already represented as numerical quantities including any one of or combination of weights for the neural network or for the subset of the neural network;
then first training the AI agent or system on the non-numerical information by way of one or more training datasets to convert the non-numerical information into the numerical quantities including any one or combination of weights for the neural network or for the subset of the neural network; and
then combine the numerically represented information.

According to another aspect, the present technology can include a method for safe alignment of an AI agent or system by combining information, including values or ethical information, in the AI agent or system from a combination of multiple intelligent entities. The intelligent entities can be any one of or any combination of a human user utilizing a computer system, an additional AI agent or system, and an AGI agent or system. The method can include the steps of:
identifying information, including values or ethical information, from each of the intelligent entities contributing the information;
combining the information mathematically, if already represented as numerical quantities, the numerical quantities including any one of or any combination of weights for a neural network or for a subset of the neural network, or if the information is non-numerical information that is not already represented as numerical quantities including any one of or combination of weights for the neural network or for the subset of the neural network;
then first training the AI agent or system on the non-numerical information by way of one or more training datasets in order to convert the information into numerical quantities including any one or combination of weights for the neural network or for the subset of the neural network; and
then combining such numerically represented information, including ethical information, mathematically.

In some embodiments, the combining of the non-numerical information can further include the steps of:
recording behavioral data, including ethical behavioral data, from each of the contributing intelligent entities in a training dataset;
combining the training datasets into a combined training dataset giving equal emphasis to the datasets produced by each of the intelligent entities, or weighting the datasets or parts of the datasets from some of the intelligent entities more than other of the intelligent entities; and
training a new intelligent entity, using machine learning techniques, based on the combined training dataset to produce internal numerical quantities that represent the combined information learned by the new intelligent entity.

In some embodiments, the information that is already represented as numerical quantities can further includes the steps of:
identifying a specific portion of weight matrices of each of the intelligent entities that correspond to a desired information, including ethical information;
computing the weighted or unweighted means of the corresponding numerical quantities in the corresponding portions of the weight matrices for each of the intelligent entities; and
assigning the matrices of computed weighted or unweighted means to the new intelligent entity as reflecting the combined information of the contributing intelligent entities.

In some embodiments, the combining o the ethical information can be accomplished by the steps of:
identifying a specific portion of weight matrices of each of the intelligent entities that correspond to a desired ethical information;
computing the weighted or unweighted means of the corresponding numerical quantities in the corresponding portions of the weight matrices for each of the intelligent entities; and
assigning the new matrices of computed weighted or unweighted means to the new intelligent entity as reflecting the combined ethical preferences of the contributing intelligent entities.

Some embodiments of the present technology can include the steps of:
computing a mean of the numerical quantities;
assigning the mean to the AI agent or system as reflecting a combined ethical preferences; and
training the AI agent or system with the combined ethical preferences.

In some embodiments, the assigning of the weights can be accomplished by utilizing statistical regression selected from the group consisting of any one of or any combination of logistic regression, polynomial regression, ridge regression, lasso regression, elastic net regression, least absolute deviations regression, quantile regression, stepwise regression, principal component regression, partial least squares regression, support vector regression, decision tree regression, random forest regression, gradient boosting regression, AdaBoost regression, XGBoost regression, K-Nearest neighbors regression, naive bayes regression, neural network regression, and Gaussian process regression.

Some embodiments of the present technology can include a step of determining consensus values by voting by each of the intelligent entities on the ethical information that should form a basis for a behavior of the AI agent or system.

Some embodiments of the present technology can include a step of presenting a specific scenario to each of the intelligent entities, with the scenario including options for how the AI agent or system should behave.

In some embodiments, the voting by the intelligent entities can include a variation selected from the group consisting of: voting where each of the intelligent entities vote for a preferred option, and the option with the most votes is utilized; ranking where each of the intelligent entities rank the options in order of preference, and the option with the highest average rank is utilized; rating where each of the intelligent entities rate the options on a scale, and the option with a highest average rating is utilized; approval voting where each of the intelligent entities vote for all the options they approve of, and the option with a most votes is utilized; Borda count; Condorcet method; Copeland's method; Dodgson's method; Kemeny-Young method; Maximin method; Minimax method; Nanson's method; Ranked pairs; Schulze method; Simpson-Kramer method; Smith/Minimax method; STV (Single Transferable Vote); Satisfaction Approval Voting; Majority Judgment; and Sequential pairwise voting.

In some embodiments, the voting by the intelligent entities can be a weighted voting and can include the steps of:
determining if applying a first weight to a first of the intelligent entities that is greater than a second weight to a second of the intelligent entities is appropriate, wherein the first of the intelligent entities is different to that of the second of the intelligent entities; and
performing the weighted voting utilizing the weight of the first of the intelligent entities and the weight of the second of the intelligent entities if determined to be appropriate.

In some embodiments, the applying the first weight greater than the second weight can be dependent on if there is a need to correct for a non-representative sample of the intelligent entities.

In some embodiments, the applying the first weight greater than the second weight can be dependent on if there is a desire to apply the first weight or the second weight to specific ethical principles that are associated with a desired sub-sample or sup-population of the intelligent entities.

In some embodiments, the applying the first weight greater than the second weight can be dependent on if there is a desire to apply the first weight or the second weight to specific ethical principles that are associated with ethical norms or rules agreed to by the intelligent entities within a particular culture.

In some embodiments, the applying the first weight greater than the second weight can be dependent on any one of or any combination of experience, knowledge, skills, age, and sophistication of the intelligent entities that are voting.

In some embodiments, the weighted voting can be performed by any one of or any combination of Simple Weighted Voting, Cumulative Voting, Borda Count, Approval Voting, Range Voting, Single Transferable Vote, Instant Runoff Voting, Majority Judgment, Quadratic Voting, Proxy Voting, Delegative Voting, Random Ballot, Score Voting, Sequential Proportional Approval Voting, Double-Threshold Approval Voting, Satisfaction Approval Voting, Randomized Voting, Limited Voting, Preferential Block Voting, and Coombs' Method.

In some embodiments, the intelligent entities can suggest the weight on their own votes based on a self-assessment of qualifications.

In some embodiments, the voting can be a cumulative voting in which the intelligent entities have a same total number of votes which each of the intelligent entities distribute in different proportion over a range of options and issues.

Some embodiments of the present technology can include a step of answering questions by the intelligent entities about qualifications and experience with regard to various issues to affect the weighting of the votes, and to determine which of the various issues are provided to the intelligent entities for the voting.

Some embodiments of the present technology can include steps of:
identifying potential sources of the ethical information;
analyzing the ethical information to determine the ethical principles; and
determining how often the same ethical principles are mentioned in a trusted text to weight the ethical principals.

Some embodiments of the present technology can include a step of combining the ethical information with active input solicited from the intelligent entities to arrive at consensus or desired ethical values that are utilized in training of the AI agent or system.

In some embodiments, the ethical information can be obtained from any one of or any combination of legal documents, judicial decisions, opinions expressed by lawyers and judges, constitutions, international treaties, religious scriptures, philosophical texts, ethical texts, social media content, social media profiles, and journalistic documents.

Some embodiments of the present technology can include steps of:
identifying one or more of the intelligent entities with specific ethical information;
eliciting the ethical information from the intelligent entities; and
using the elicited ethical information as data to any one of or any combination of train the AI agent or system, and as a basis for constructing ethical scenarios that are voted on by the information using.

Some embodiments of the present technology can include a step of establishing rules for the behavior of the AI agent or system by acquiring additional information from the intelligent entities.

In some embodiments, the additional information can be obtained by any one of or any combination of conducting experiments designed to test the ethical information of the intelligent entities, conducting interviews about the ethical information from humans by asking specific questions about ethical issues, providing a game-based platform where the intelligent entities play games that explicitly teach and reward human values through interactive storytelling and problem-solving, utilizing crowdsourcing platforms to gather input from diverse groups of people on ethical values and priorities, utilizing a collective intelligence platform or network where humans and AI agents collaborate to collectively refine and develop ethical values, utilizing a brain-computer interface to directly interface with a human brain and extract information about values and beliefs directly from neural activity, and utilizing simulations providing an AI agent enabled with Artificial Empathy and Emotional Intelligence.

Some embodiments of the present technology can include a step of prioritizing the ethical information by assigning the weight to the ethical information of the intelligent entities based on any one of or any combination of:
whether the intelligent entities are human or non-human;
a time-factor of the ethical information;
a frequency count based on how often the ethical information is repeated by the intelligent entities; and
an independence factor of the intelligent entities based a relationship between the intelligent entities.

Some embodiments of the present technology can include a step of voting by one or more of the intelligent entities on the ethical information that should form a basis for a behavior of the AI agent or system.

Some embodiments of the present technology can include a step of identifying a group of the intelligent entities with similar ethical information.

Some embodiments of the present technology can include a step of delegating the voting to one or more delegated intelligent entities in the group by one or more delegating intelligent entities in the group of intelligent entities.

Some embodiments of the present technology can include a step of assigning restrictions on a voting power the delegated intelligent entities.

Some embodiments of the present technology can include a step of confirming the voting by the delegated intelligent entities to the delegating intelligent entities and notifying the delegating intelligent entities when the delegated intelligent entities vote.

In some embodiments, the delegating intelligent entities can be the human user, and wherein the delegated intelligent entities agree to a set of rules issued by the human user.

Some embodiments of the present technology can include a step of recommending one or more of the ethical information utilizing recommender algorithm.

Some embodiments of the present technology can include a step of determining a minority group of the intelligent entities with ethical information that are in a minority as compared to a majority group of the intelligent entities.

Some embodiments of the present technology can include a step of saving the ethical information of the minority group separately from the majority group and utilizing the ethical information of the minority group against the ethical information of the majority group.

In some embodiments, the ethical information or principles can be limited to a specific culture, country, geography, legal jurisdiction, or group of entities.

Some embodiments of the present technology can include steps of:
identifying a conflict between two or more of the ethical information; and
resolving the conflict using a conflict resolving algorithm.

Some embodiments of the present technology can include steps of:
creating a search space of potential sets of ethical rules;
finding an optimal set of the ethical rules that has least conflict; and
prioritizing or weighting an importance of the optimal set of the ethical rules.

Some embodiments of the present technology can include a step of simulating a problem solving process of the trained AI agent or system using the combined ethical principles, and analyzing a solution provided by the trained AI agent or system on the problem solving process.

Some embodiments of the present technology can include a step of determining if the solution is acceptable based on a predetermined solution, and if determined not acceptable then retrain the AI agent or system with different ethical information.

In some embodiments, the step of obtaining the ethical information can be obtained from questions presented to the intelligent entities, the questions being based on any one of or any combination of simulations of a problem solving process that have been performed by one or more of the intelligent entities, based on input from other intelligent entities, and based on gaps in the ethical information.

In some embodiments, the questions can be generated automatically by the AI agent or system or one or more of the intelligent entities, with a subsequent question being based on an answer provided to a previous question.

Some embodiments of the present technology can include a step of determining when a particular question has been asked a predetermined number of times, and then provide a conclusion about human ethics based on the questions.

Some embodiments of the present technology can include steps of;
determining by the AI agent or system the ethical information the AI agent or system wants to develop;
generating by the AI agent or system environments, scenarios, dilemmas or conversational settings that will elicit human behavior from the intelligent entities that is relevant to the ethical information of interest;
prompting the human behavior iteratively from the intelligent entities until a predetermined number of behavior patterns is identified;
analyzing and training the AI agent or system using algorithms; and
testing the trained AI agent or system to determine which areas of the AI agent or system have improved and which areas of the AI agent or system need more training.

Some embodiments of the present technology can include a step of creating scenarios based on game theory, and providing the scenarios to the intelligent entities to obtain the ethical information.

In some embodiments, the game theory can be any one of or any combination of Nash equilibrium, dominant strategy, mixed strategy, iterated elimination of dominated strategies, minimax theorem, cooperative game, non-cooperative game, stag hunt, battle of the sexes:, chicken game:, focal point:, Stackelberg competition, Bertrand competition, Cournot competition, auction, mechanism design, Bayesian game, and signaling game.

Some embodiments of the present technology can include a step of providing a simulation of a problem solving process by the AI agent or system to one or more of the intelligent entities and obtaining the ethical information from the one or more intelligent entities based on the simulation.

In some embodiments, the simulation can be multimodal including multiple frequent interactions that are recorded and analyzed by the AI agent or system.

In some embodiments, the intelligent entities can be human users, and the weight of the ethical information is based on an age of the human users.

In some embodiments, the weight can be associated with a linear scheme in which more weight is assigned to a human user's ethical value or preference in linear proportion to the age of the human user, or the weight is assigned with minimum and maximum weights related to age limits.

In some embodiments, the weight can be associated with a non-linear scheme.

Some embodiments of the present technology can include steps of:
identifying a conflict between two or more of the ethical information; and
resolving the conflict using a consequentialist approach, the consequentialist approach further includes the steps of:
identifying a desired outcome;
identifying a potential unethical action that could be taken to achieve the outcome, wherein the intelligent entities rank, rate, weight or vote upon how unethical the action is compared to other actions;
evaluating a potential consequences of the unethical action;
using information on the ranking, rating, weighting or voting on the unethical actions and outcomes to weigh potential benefits of achieving the desired outcome against potential costs of taking the unethical action using a mathematical approach; and
taking an action if the benefits outweigh the costs.

In some embodiments, the mathematical approach can be selected from the group consisting of Net Present Value (NPV), Internal Rate of Return (IRR), Benefit-Cost Ratio (BCR), Payback Period, Sensitivity Analysis, Scenario Analysis, Decision Tree Analysis, Monte Carlo Simulation, Real Options Analysis, Multi-Criteria Decision Analysis (MCDA), Stated Preference Methods, Revealed Preference Methods, Contingent Valuation Methods, Hedonic Pricing Methods, Shadow Pricing/Opportunity Cost Methods, Social Return on Investment (SROI), Environmental Impact Assessment (EIA), Triple Bottom Line (TBL), and Comparisons to Constitutions.

Some embodiments of the present technology can include steps of:
identifying a conflict between two or more of the ethical information; and
resolving the conflict using a deontological approach, the deontological approach further includes the steps of:
identifying the ethical principles involved in a scenario;
identifying potential unethical actions that could be taken to achieve a desired outcome;
determining whether each of the unethical actions violates any of the ethical principles involved or determine the “immorality score” of each of the unethical actions; and
do not take the action if it violates the ethical principle or if the action is less moral than a minimum acceptable morality threshold or minimum allowable total morality score.

Some embodiments of the present technology can include steps of:
identifying a conflict between two or more of the ethical information; and
resolving the conflict using a virtue ethics approach, the virtue ethics approach further includes the steps of:
identifying virtues involved in a scenario;
identifying potential unethical actions that could be taken to achieve a desired outcome;
determining whether taking each of the unethical actions would be consistent with virtuous character of the intelligent entities; and
taking the action if it is consistent with the virtuous characteristics of the intelligent entities.

In some embodiments, the intelligent entities can each be different from each other to create mixture of intelligent entities, the mixture of intelligent entities includes an approach utilized in decision making selected from any one of or any combination of expert-labeled data, case-based reasoning, counterfactual analysis, probabilistic risk assessment, simulations with human feedback, modular architecture, attention mechanisms, explainability techniques, transfer learning from ethical experts, majority voting, weighted voting, adaptive voting, hierarchical voting, stacking, human oversight and intervention, collaborative decision-making, explainable AI for human review, feedback loops, and active learning with human guidance.

Some embodiments of the present technology can include a step of statistically weighting data associated with the ethical information based on an occurrence of the ethical information in a dataset and adjusting the data to reflect actual human behavior using observational sources.

In some embodiments, the adjusting of the data can utilize a weighting factor selected from the group consisting of Frequency-Based Weighting, Time-Decay Weighting, Source Credibility Weighting, Sentiment-Aware Weighting, Topic-Specific Weighting, Crowdsourced Weighting, Network Analysis, Historical Data Correction, Anomaly Detection, and Positive Sampling.

In some embodiments, the adjusted data can be configured or configurable to provide a balanced and realistic view of human behavior for the AI agent or system, enabling the AI agent or system to learn human values effectively and develop into a responsible and beneficial AI agents.

Some embodiments of the present technology can include steps of:
determining if representative human data exists for making an ethical decision;
if the representative human data does exist, then use the representative human data in training the AI agent or system;
if the representative human data does not exist, the proceed to the following steps of:
   determining an extreme opposite positions in a range of the human data that the AI agent or system has access to, if the extreme positions are farther apart than a preset parameter for maximum distance, then repeatedly delete each pair of datapoints for the extreme opposite position and recalculate distance until within the maximum preset distance;
   estimating a median or mean position between the extreme opposite positions and utilizing the median or mean position; and
   recording the estimating process for transparency and improvement by the intelligent entities.

According to yet another aspect, the present technology can include a method for safe alignment of an AI agent or system by combining values in the AI agent or system from a combination of multiple intelligent entities. The intelligent entities are any one of or any combination of a human user utilizing a computer system, an AI system, and AGI system. The method can include the steps of:
a) identifying ethical preferences of a human user using an AI agent;
b) developing a transparent constitution configured or configurable to translate the ethical preferences into a set of rules for the AI agent to follow;
c) training the AI agent using the constitution and a dataset of examples that illustrate good ethical decisions;
d) testing the AI agent to ensure the following of the set of rules, the testing includes comparing decisions made by the AI agent with those made by humans;
e) identifying areas for improvement of the AI agent by analy zing the decisions made by the AI agent and comparing them to those made by the humans, and assigning credit or blame to various inputs, factors or weights affecting the decision;
f) updating any one of or any combination of the constitution, weights, and the ethical preferences to address the areas for improvement; and
g) retraining the AI agent using the updated constitution, the weights, and the ethical preferences.

Some embodiments of the present technology can include a step of repeating steps d)-g) to ensure that the AI agent is making good ethical decisions.

According to still another aspect, the present technology can include a method for safe alignment of an AI agent or system by combining values in the AI agent or system from a combination of multiple intelligent entities. The intelligent entities are any one of or any combination of a human user utilizing a computer system, an AI system, and AGI system. The method can include the steps of:
collecting data that is relevant to safety regulations that an AI agent needs to learn and comply with;
preprocessing the collected data to remove any irrelevant information and to convert the preprocessed data into a format usable by machine learning algorithms;
extracting features from the preprocessed data usable by the machine learning algorithms;
selecting a machine learning algorithm used to learn and comply with the safety regulations;
training the selected machine learning model on the preprocessed and feature-extracted data;
testing the trained machine learning model on a separate dataset to evaluate how well the trained machine learning model has learned the safety regulations;
analyzing results of the testing and use information from the analyzed results to improve the machine learning model; and
deploying the trained machine learning model in the AI agent to ensure compliance with the safety regulations.

Some embodiments of the present technology can include a step of running multiple simulations on the trained machine learning model with edge cases that stress test the AI agent's ability to follow the safety regulations without unexpected consequences.

According to still yet another aspect, the present technology can include a method for safe alignment of an AI agent or system by combining values in the AI agent or system from a combination of sources. The method can include the steps of:
obtaining ethical information from human users each utilizing a computer system, the ethical information are a representative and statistically valid overall set of ethics that is aligned with human interests;
converting the ethical information into numerical quantities including weights for a neural network or a subset of the neural network;
training the AI agent or system with the combined ethical information;
utilizing a cognitive architecture including the human users and multiple Artificial Intelligent (AI) agents; utilizing a problem solving logic to provide a solution to a goal or subgoal provided to the trained AI agent or system and the AI agents;
running ethical checks by the AI agent or system and the AI agents every time the goal or subgoal is provided; and
determining if an unethical action is provided and shutting down the AI agent or system or the AI agent that provided the unethical action.

According to yet still another aspect, the present technology can include a method for safe alignment of an AI agent or system by combining values in the AI agent or system from a combination of multiple intelligent entities. The intelligent entities are any one of or any combination of a human user utilizing a computer system, an AI system, and AGI system. The method can include the steps of:
obtaining ethical information from each of the intelligent entities;
converting the ethical values into numerical quantities including weights for a neural network or a subset of the neural network;
computing a mean of the numerical quantities;
assigning the mean to the AI agent or system as reflecting a combined ethical preferences;
training the AI agent or system with the combined ethical preferences;
recording a behavior of each of the intelligent entities in a dataset;
creating a variable or nodes within a neural network learning scheme; and
assigning weights to the network so that the behavior can be reproduced.

According to yet another aspect, the present technology can include a method for safe alignment of an AI agent or system by combining values in the AI agent or system from a combination of multiple intelligent entities. The intelligent entities are any one of or any combination of a human user utilizing a computer system, an AI system, and AGI system. The method can include the steps of:
obtaining ethical information from each of the intelligent entities;
converting the ethical values into numerical quantities including weights for a neural network or a subset of the neural network;
computing a mean of the numerical quantities;
assigning the mean to the Al agent or system as reflecting a combined ethical preferences;
training the AI agent or system with the combined ethical preferences;
identifying a conflict between two or more of the ethical information; and
resolving the conflict using a conflict resolving algorithm or an approach selected from the group consisting of a consequentialist approach, a deontological approach and a virtue ethics approach.

According to yet another aspect, the present technology can include a method for safe alignment of an AI agent or system by combining values in the AI agent or system from a combination of multiple intelligent entities. The intelligent entities are any one of or any combination of a human user utilizing a computer system, an AI system, and AGI system. The method can include the steps of:
obtaining ethical information from each of the intelligent entities;
converting the ethical values into numerical quantities including weights for a neural network or a subset of the neural network;
computing a mean of the numerical quantities;
assigning the mean to the AI agent or system as reflecting a combined ethical preferences;
training the AI agent or system with the combined ethical preferences;
simulating a problem solving process of the trained AI agent or system using the combined ethical principles;
analyzing a solution provided by the trained AI agent or system on the problem solving process; and
determining if the solution is acceptable based on a predetermined solution, and if determined not acceptable then retrain the AI agent or system with different ethical information.

In some embodiments, the simulation can include questions presented to the intelligent entities, the questions being based on any one of or any combination of simulations of a problem solving process that have been performed by one or more of the intelligent entities, based on input from other intelligent entities, and based on gaps in the ethical information.

In some embodiments, the questions can be generated automatically by the AI agent or system or one or more of the intelligent entities, with a subsequent question being based on an answer provided to a previous question.

In some embodiments, the simulation can include scenarios based on game theory.

In some embodiments, the simulation can be multimodal including multiple frequent interactions that are recorded and analyzed by the AI agent or system.

According to another aspect, the present technology can include a method for safe alignment of an AI agent or system by combining values in the AI agent or system from a combination of multiple intelligent entities. The intelligent entities are any one of or any combination of a human user utilizing a computer system, an AI system, and AGI system. The method can include the steps of:
obtaining ethical information from each of the intelligent entities;
converting the ethical values into numerical quantities including weights for a neural network or a subset of the neural network;
computing a mean of the numerical quantities;
assigning the mean to the AI agent or system as reflecting a combined ethical preferences;
training the AI agent or system with the combined ethical preferences; and
voting by one or more of the intelligent entities on the ethical information that should form a basis for a behavior of the AI agent or system.

Some embodiments of the present technology can include a step of identifying a group of the intelligent entities with similar ethical information.

Some embodiments of the present technology can include a step of delegating the voting to one or more delegated intelligent entities in the group by one or more delegating intelligent entities in the group of intelligent entities.

Some embodiments of the present technology can include a step of assigning restrictions on voting power the delegated intelligent entities.

Some embodiments of the present technology can include a step of confirming the voting by the delegated intelligent entities to the delegating intelligent entities and notifying the delegating intelligent entities when the delegated intelligent entities vote.

In some embodiments, the delegating intelligent entities can be the human user, and wherein the delegated intelligent entities agree to a set of rules issued by the human user.

According to yet another aspect, the present technology can include a method for safe alignment of an AI agent or system by combining values in the AI agent or system from a combination of multiple intelligent entities. The intelligent entities are any one of or any combination of a human user utilizing a computer system, an AI system, and AGI system. The method can include the steps of:
identifying potential sources of existing ethical information including;
analyzing the ethical information to determine ethical principles;
applying a weight to the ethical principles utilizing reputational metrics and frequency counts of how often the same ethical principles are mentioned in a trusted text; and
training the AI agent or system with the ethical principles.

Some embodiments of the present technology can include steps of:
obtaining the ethical information gathered by reverse engineering the text with voting that solicit active input from the intelligent entities to arrive at consensus or desired ethical values;
recording and indexing the ethical information; and
training the AI agent or system with the ethical information.

While embodiments of the system and methods for safe alignment of superintelligence have been described in detail, it should be apparent that modifications and variations thereto are possible, all of which fall within the true spirit and scope of the present technology. With respect to the above description then, it is to be realized that the optimum dimensional relationships for the parts of the present technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present technology.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

1-80. (canceled)

81. A system for safe alignment of an Artificial Intelligent (AI) agent or system by combining information, including values or ethical information, in the AI agent or system from a combination of multiple intelligent entities, wherein the intelligent entities are any one of or any combination of a human user utilizing a computer system, an additional AI agent or system, and Artificial General Intelligent (AGI) agent or system, the system comprising:
a computer system comprising: a processor, a computer-readable storage medium, and program instructions stored on the computer-readable storage medium being executable by the processor to cause the computer system to:
identify information, including values or ethical information, from each of the intelligent entities that contribute the information;
combine the information mathematically, if already represented as numerical quantities, the numerical quantities including any one of or any combination of weights for a neural network or for a subset of the neural network, or if the information is non-numerical information that is not already represented as numerical quantities including any one of or combination of weights for the neural network or for the subset of the neural network;
then first training the AI agent or system on the non-numerical information by way of one or more training datasets to convert the non-numerical information into the numerical quantities including any one or combination of weights for the neural network or for the subset of the neural network; and
then combine the numerically represented information.

82. A method for safe alignment of an AI agent or system by combining information, including values or ethical information, in the AI agent or system from a combination of multiple intelligent entities, wherein the intelligent entities are any one of or any combination of a human user utilizing a computer system, an additional AI agent or system, and an AGI agent or system, the method comprising the steps of:
identifying information, including values or ethical information, from each of the intelligent entities contributing the information;
combining the information mathematically, if already represented as numerical quantities, the numerical quantities including any one of or any combination of weights for a neural network or for a subset of the neural network, or if the information is non-numerical information that is not already represented as numerical quantities including any one of or combination of weights for the neural network or for the subset of the neural network;
then first training the AI agent or system on the non-numerical information by way of one or more training datasets in order to convert the information into numerical quantities including any one or combination of weights for the neural network or for the subset of the neural network; and
then combining such numerically represented information, including ethical information, mathematically.

83. The method of claim 82 further comprising the steps of:
computing a mean of the numerical quantities;
assigning the mean to the AI agent or system as reflecting the combined ethical information.

84. The method of claim 83, further comprising the step of obtaining the weights by:
recording a behavior of each of the intelligent entities in a dataset;
creating a variable or nodes within a neural network learning scheme; and
assigning weights to the network so that the behavior can be reproduced, wherein the assigning of the weights is accomplished by utilizing statistical regression selected from the group consisting of any one of or any combination of logistic regression, polynomial regression, ridge regression, lasso regression, elastic net regression, least absolute deviations regression, quantile regression, stepwise regression, principal component regression, partial least squares regression, support vector regression, decision tree regression, random forest regression, gradient boosting regression, AdaBoost regression, XGBoost regression, K-Nearest neighbors regression, naive bayes regression, neural network regression, and Gaussian process regression.

85. The method of claim 82 further comprising the step of determining consensus values by voting by each of the intelligent entities on the ethical information that should form a basis for a behavior of the AI agent or system.

86. The method of claim 85 further comprising the step of presenting a specific scenario to each of the intelligent entities, with the scenario including options for how the AI agent or system should behave.

87. The method of claim 86, wherein the voting by the intelligent entities includes a variation selected from the group consisting of: voting where each of the intelligent entities vote for a preferred option, and the option with the most votes is utilized; ranking where each of the intelligent entities rank the options in order of preference, and the option with the highest average rank is utilized; rating where each of the intelligent entities rate the options on a scale, and the option with a highest average rating is utilized; approval voting where each of the intelligent entities vote for all the options they approve of, and the option with a most votes is utilized; Borda count; Condorcet method; Copeland's method; Dodgson's method; Kemeny-Young method; Maximin method; Minimax method; Nanson's method; Ranked pairs; Schulze method; Simpson-Kramer method; Smith/Minimax method; STV (Single Transferable Vote); Satisfaction Approval Voting; Majority Judgment; and Sequential pairwise voting.

88. The method of claim 6, wherein the voting by the intelligent entities is a weighted voting and further comprising the steps of:
determining if applying a first weight to a first of the intelligent entities that is greater than a second weight to a second of the intelligent entities is appropriate, wherein the first of the intelligent entities is different to that of the second of the intelligent entities; and
performing the weighted voting utilizing the weight of the first of the intelligent entities and the weight of the second of the intelligent entities if determined to be appropriate.

89. The method of claim 88, wherein the applying the first weight greater than the second weight is dependent on any one of or any combination of experience, knowledge, skills, age, and sophistication of the intelligent entities that are voting.

90. The method of claim 84, wherein the intelligent entities suggest the weight on their own votes based on a self-assessment of qualifications.

91. The method of claim 85, wherein the voting is a cumulative voting in which the intelligent entities have a same total number of votes which each of the intelligent entities distribute in different proportion over a range of options and issues.

92. The method of claim 85 further comprising the step of answering questions by the intelligent entities about qualifications and experience with regard to various issues to affect the weighting of the votes, and to determine which of the various issues are provided to the intelligent entities for the voting.

93. The method of claim 82 further comprising the steps of:
identifying one or more of the intelligent entities with specific ethical information;
eliciting the ethical information from the intelligent entities; and
using the elicited ethical information as data for any one of or any combination of training the AI agent or system, and using the information as a basis for constructing ethical scenarios that are voted on by intelligent entities.

94. The method of claim 82 further comprising the step of voting by one or more of the intelligent entities on the ethical information that should form a basis for a behavior of the AI agent or system.

95. The method of claim 94 further comprising the step of identifying a group of the intelligent entities with similar ethical information.

96. The method of claim 95 further comprising the step of delegating the voting to one or more delegated intelligent entities in the group by one or more delegating intelligent entities in the group of intelligent entities.

97. The method of claim 82 further comprising the step of creating scenarios based on game theory and providing the scenarios to the intelligent entities to obtain the ethical information.

98. The method of claim 97, wherein the game theory is any one of or any combination of Nash equilibrium, dominant strategy, mixed strategy, iterated elimination of dominated strategies, minimax theorem, cooperative game, non-cooperative game, stag hunt, battle of the sexes:, chicken game:, focal point:, Stackelberg competition, Bertrand competition, Cournot competition, auction, mechanism design, Bayesian game, and signaling game.

99. The method of claim 82, wherein the intelligent entities are human users, and the weight of the ethical information is based on an age of the human users.

100. The method of claim 99, wherein the weight is associated with a non-linear scheme.
